(19) United States
(12) Patent Application Publication
(10) Pub. No.: US 2014/0145550 A1
(43) Pub. Date: May 29, 2014

(54) ELECTROACTIVE POLYMER ENERGY CONVERTER

(71) Applicants: Maria Jenninger, (US); Ludwig Jenninger, (US)

(72) Inventors: Roger N. Hitchcock, San Leandro, CA (US); Silmon James Biggs, Los Gatos, CA (US); Werner Jenninger, Koln (DE)

(21) Appl. No.: 14/003,105

(22) PCT Filed: Mar. 9, 2012
(86) PCT No.: PCT/US2012/028406

§ 371 Date: Sep. 4, 2013

Related U.S. Application Data
(60) Provisional application No. 61/450,764, filed on Mar. 9, 2011.
(60) Provisional application No. 61/450,756, filed on Mar. 9, 2011.
(60) Provisional application No. 61/450,762, filed on Mar. 9, 2011.
(60) Provisional application No. 61/450,758, filed on Mar. 9, 2011.
(60) Provisional application No. 61/490,418, filed on May 26, 2011.
(60) Provisional application No. 61/545,295, filed on Oct. 10, 2011.

(51) Int. Cl. H02N 11/00

(52) U.S. Cl. CPC H02N 11/002
USPC 310/300

(57) ABSTRACT

An energy conversion apparatus configured to convert energy from a mechanical energy source into electrical energy is provided. The energy conversion apparatus includes a transducer comprising a dielectric elastomer module made of stretchable electroactive polymer material. The dielectric elastomer module comprising at least one dielectric elastomer film layer is disposed between at least first and second electrodes. A transmission coupling mechanism is configured to couple the mechanical energy source and is operatively attached to the transducer to cyclically strain and relax the transducer in response to the mechanical energy acting on the transmission coupling mechanism. A conditioning circuit is coupled to the at least first and second electrodes and configured to apply an electric charge to the dielectric elastomer film when the dielectric elastomer film is in a strained state, to disconnect from the dielectric elastomer film when the dielectric elastomer film transitions from the strained state to a relaxed state, and to remove electrical charge from the dielectric elastomer film when the dielectric elastomer film reaches a relaxed state.

### CROSS REFERENCE TO RELATED APPLICATION

This application claims the benefit, under 35 USC §119(e), of U.S. provisional patent application Nos. 61/450,756, filed Mar. 9, 2011, entitled “SIMPLIFIED EPAM ENERGY HARVESTING CIRCUIT WITH OVERVOLTAGE PROTECTION”; 61/450,758, filed Mar. 9, 2011, entitled “EPAM GENERATOR ARRAYS TO IMPROVE MECHANICAL-TO-ELECTRICAL CONVERSION”; 61/450,762, filed Mar. 9, 2011, entitled “HIGH EFFICIENCY ENERGY TRANSFER CIRCUIT FOR EPAM GENERATORS”; 61/450,764, filed Mar. 9, 2011, entitled “EPAM ENERGY HARVESTING CONTROL UTILIZING MICROCONTROLLER ELECTRONICS”; 61/490,418, filed May 26, 2011, entitled “DIELECTRIC ELASTOMER GENERATORS”; and 61/545,295, filed Oct. 10, 2011, entitled “COMPOSITE ELECTRODES COMPRISED OF A TEXTURED, RIGID, INSULATOR COVERED WITH THIN, SELF-HEALING CONDUCTOR LAYERS, AND DIELECTRIC ELASTOMER TRANSDUCERS INCORPORATING SUCH ELECTRODES,” the entire disclosure of each of which is hereby incorporated by reference.

### FIELD OF THE INVENTION

In various embodiments, the present disclosure relates generally to energy conversion devices. In one aspect, the present disclosure relates to devices configured to convert mechanical energy to electrical energy. In particular, the present disclosure relates to electroactive polymer arrays configured in a multi-phase arrangement to convert mechanical energy to electrical energy in an efficient manner. More particularly, the present disclosure relates to energy transfer and energy harvesting circuits and techniques for electroactive polymer arrays configured to convert mechanical energy to electrical energy.

### BACKGROUND OF THE INVENTION

SRI International of Menlo Park, Calif. (SRI) has been working on using electroactive polymers for power generation for approximately ten years and has published a significant number of papers and patents on the subject of power generation using electroactive polymers. Examples of power generation topologies from SRI include laboratory tests of single electroactive polymer sheets, a heel-strike generator, small water wheels driving a generator, and a sixty foot wave tank driving a boogie board generator. To date, however, the power levels generated have been modest (less than 50 watts) and a significant amount of the effort by SRI appears to have been directed to either their heel-strike generator or a buoy generator for generating power from ocean waves to power navigational buoys.

In general, electroactive polymer energy conversion devices such as generators, for example roll generators, require a high level of reactive mechanical power to produce electrical power. A single electroactive polymer energy generator element may convert only 15% of the mechanical power into electrical power. SRI is reported to have developed two-phase systems that improve this conversion up to approximately 30%. Such systems, however, cannot adequately obtain overall system efficiency of greater than 80%.

In addition, electroactive polymers generally require high voltage electronics to produce electricity. For some applications, simplicity is important but not at the expense of reliability. Simple, high-voltage electrical circuits are generally required to provide functionality and protection. A basic electroactive polymer generator circuit consists of a low voltage priming supply, a connection diode, an electroactive polymer generator, a second connection diode, and a high voltage collector supply. Such a circuit, however, is not effective at capturing as much energy per cycle as may be required by an electroactive polymer generator according to this disclosure and requires a relatively higher voltage priming supply.

Furthermore, electroactive polymer energy harvesting generators may have a high electric resistance. This typically is due to the additional electrode requirement of mechanical compliance. The electrode must retain its conductivity while under cyclic strain. Therefore, an electrode tradeoff must be made between conductivity and compliance when designing and electrode. Highly conductive electrodes, silver for example, are very stiff and do not allow much mechanical movement. Less conductive electrodes, such as preprinted conductive inks for example, are compliant and allow mechanical movement, but are resistive and result in electrical losses when trying to charge or discharge an electroactive polymer generator. Simplified electroactive polymer generator electronics may be employed to minimize electrode losses by operating at low electrode currents. Such simplified electroactive polymer circuits, though designed for high electrode resistances, do not optimize the full mechanical-to-electrical conversion capabilities and result in much lower specific energy densities compared to optimized converter electronics, typically 0.04-0.06 J per gram for simple electronics versus 0.4-0.6 J per gram for complex electronics.

Moreover, to maximize energy densities in electroactive polymer type generators, complex control electronics are necessary. Complex control can improve the energy density of electroactive polymer generators over an order of magnitude. Currently, however, there are no published examples of complex electronics control for electroactive polymer generators.

Wave and wind energy are renewable resources capable of delivering thousands of megawatt-hours of electricity every year. Harvesting even a small percentage of this energy can provide a significant source of power. New concepts, such as, for example, utilizing electroactive polymer based generators may help solve a number of these challenges.

The present disclosure provides improved energy converters employing electroactive polymers. The present disclosure provides various embodiments of improved electroactive polymer based energy converters in terms of target costs, efficiencies, reliabilities, and overall performance vis-à-vis conventional technologies.

### SUMMARY OF THE INVENTION

In one embodiment, the present disclosure provides an electroactive polymer based energy conversion device. In one embodiment, an energy conversion apparatus is configured to convert energy from a mechanical energy source into electrical energy. The energy conversion apparatus comprises a transducer comprising a dielectric elastomer module made of stretchable electroactive polymer material. The dielectric elastomer module comprises at least one dielectric elastomer film layer disposed between at least first and second electrodes. A transmission coupling mechanism configured to couple the mechanical energy source is operatively attached to the transducer to cyclically strain and relax the transducer in response to the mechanical energy acting on the transmission coupling mechanism. A conditioning circuit is coupled to the at least first and second electrodes and configured to apply an electric charge to the dielectric elastomer film when the dielectric elastomer film is in a strained state, to disconnect from the dielectric elastomer film when the dielectric elastomer film transitions from the strained state to a relaxed state, and to remove electrical charge from the dielectric elastomer film when the dielectric elastomer film reaches a relaxed state.

### BRIEF DESCRIPTION OF THE FIGURES

FIG. 1 is a block diagram of an energy conversion device that may be used for harvesting electricity from a mechanical energy source;

FIG. 2 illustrates a cycle for converting energy using an energy conversion device including an electroactive polymer film of some type;

FIG. 3A illustrates a top perspective view of a transducer portion in accordance with one embodiment;

FIG. 3B illustrates a top perspective view of the transducer portion including deflection in response to a change in electric field;

FIGS. 4A-4F illustrate one cycle of an electroactive polymer generator for converting mechanical energy using an energy conversion device including an electroactive polymer film, e.g., a dielectric elastomer film;

FIG. 5 is a graphical representation of measurements of dielectric constants for various silicone dielectric elastomer materials;

FIG. 6 is a graphical representation of dielectric constant versus electric field. The vertical axis corresponds to dielectric constant (∈) and the horizontal axis corresponds to electric field E(V/μm);

FIG. 7 is a graphical representation of an Ogden model fit to a silicone elastomer (SSF4930) for about 100 elastomers have been calibrated;

FIG. 8 illustrates one embodiment of a simple power generation circuit;

FIGS. 9A and 9B illustrate a defined coordinate system of an electroactive polymer generator;

FIG. 10 is a graphical representation of energy versus stretch ratio of a constant charge cycle in an electroactive polymer generator;

FIG. 11 is a graphical representation 1100 of pure-shear mode generator stroke-force relation and curve fit;

FIG. 12 illustrates a PSPICE model for mechanical nonlinear pure-shear electroactive polymer generator;

FIG. 13 is a graphical representation of the PSSPICE modeling results of displacement versus force;

FIG. 14 is a coupled PSPICE model of a nonlinear capacitor coupled to a nonlinear spring model;

FIG. 15 is a graphical representation of energy harvesting simulation;

FIG. 16 is a graphical representation of an energy harvesting cycle ideal versus non-ideal (leakage current);

FIG. 17 is a graphical representation of recovered electrical energy for ideal and non-ideal cycle;

FIG. 18 is a block diagram of one embodiment of electroactive polymer generator energy harvesting control system utilizing microcontroller electronics;

FIG. 19 is a block diagram of one embodiment of a high efficiency energy transfer circuit for an electroactive polymer generator;

FIGS. 20 and 21 are perspective views one embodiment of a six-phase electroactive polymer generator;

FIG. 22 is a side view of the generator shown in FIGS. 20-21;

FIG. 23 is a perspective view of the six-phase electroactive polymer generator shown in FIGS. 20-22 with most of the DEG modules removed;

FIGS. 24 and 25 are end views of the six-phase electroactive polymer generator shown in FIG. 23;

FIG. 26 is a side view of the six-phase electroactive polymer generator shown in FIG. 23;

FIG. 27 illustrates one embodiment of the DEG module shown in FIGS. 20-26;

FIG. 28 illustrates one embodiment of the stacked elastomer film component portion of the DEG module shown in FIG. 27;

FIG. 29 is a front view of a stacked elastomer film component;

FIG. 30 is a perspective view of the stacked elastomer film component with a front plate removed;

FIG. 31 is a detailed end view of the stacked elastomer film component shown in FIG. 30;

FIG. 32 is a sectional perspective view of the stacked elastomer film component;

FIG. 33 is a detailed view of the sectional perspective view of the stacked elastomer film component shown in FIG. 32;

FIGS. 34-37 illustrate detail views of the top hanger plate shown in FIGS. 20-24 and 26, according to one embodiment;

FIGS. 38-40 illustrate on embodiment of a shaft for use with the six-phase electroactive polymer generator described in connection with FIGS. 20-26;

FIGS. 41-48 illustrate the principle of balanced reactive torque in a multi-phase dielectric elastomer generator;

FIG. 49 illustrates a radial dielectric elastomer generator with eight phases attached to a central cam;

FIG. 50 is a diagram an approximation of each phase as a linear spring attached to a point orbiting the central axis;

FIG. 51 is a graphical representation of the passive torque calculated using equation (51) where r=0.5; Iₒ=1; and k=1;

FIG. 52 is a graphical representation of torque from each of six phases;

FIG. 53 is a graphical representation of net passive torque from systems with one (biggest) to six (smallest) phases;

FIG. 54 is a graphical representation of ripple torque from a six phase system;

FIG. 55 is a graphical representation of the ratio of maximum ripple torque of systems with n-phases to systems with one-phase;

FIG. 56 is a diagram of an electroactive polymer film comprising a plurality of electrodes formed over a dielectric film;

FIG. 57 is a diagram of an electroactive polymer film comprising a plurality of electrodes formed over a dielectric film;

FIG. 58 is a diagram of an electrode that has developed a crack; and

FIG. 59 is a diagram of an electrode that has developed a crack.

### DETAILED DESCRIPTION OF THE INVENTION

Before explaining the embodiments of electroactive polymer based energy conversion devices and electroactive polymer based arrays configured to convert mechanical energy to electrical energy, it should be noted that the disclosed embodiments are not limited in application or use to the details of construction and arrangement of parts illustrated in the accompanying drawings and description. The disclosed embodiments may be implemented or incorporated in other embodiments, variations and modifications, and may be practiced or carried out in various ways. Further, unless otherwise indicated, the terms and expressions employed herein have been chosen for the purpose of describing the embodiments for illustrative purposes and for the convenience of the reader and are not intended for the purposes of limiting any of the embodiments to the particular ones disclosed. Further, it should be understood that any one or more of the disclosed embodiments, expressions of embodiments, and examples can be combined with any one or more of the other disclosed embodiments, expressions of embodiments, and examples, without limitation. Thus, the combination of an element disclosed in one embodiment and an element disclosed in another embodiment is considered to be within the scope of the present disclosure and appended claims.

In various embodiments, the present disclosure provides electroactive polymer based energy conversion devices that may be used to convert between electrical energy and mechanical energy in a bi-directional manner. It will be appreciated that the terms “electroactive polymer,” “dielectric elastomer,” and/or “elastomeric dielectric element,” may be used interchangeably throughout the present disclosure. In one embodiment, the present disclosure provides generators with one or more transducers that employ electroactive polymer films configured to convert mechanical energy to electrical energy. In another embodiment, the present disclosure provides arrays of transducers employing electroactive polymer films configured in a multi-phase arrangement to convert mechanical energy to electrical energy in an efficient manner. Still in other embodiments, the present disclosure provides energy transfer and energy harvesting circuits and techniques for transducers employing electroactive polymer film arrays configured to convert mechanical energy to electrical energy. These and other specific embodiments are illustrated and described hereinbelow.

The present disclosure provides various embodiments of generators with one or more transducers that employ electroactive polymer films to convert mechanical energy to electrical energy and electrical circuit techniques for more efficiently converting the mechanical energy into electrical energy. In one embodiment, a generator module comprises electroactive polymer transducers comprising integrated dielectric elastomer elements, available from Artificial Muscle, Inc. (AMI) of Sunnyvale, Calif. Such generators may be referred to herein as electroactive polymer generator modules. Such electroactive polymer generator modules have characteristics suitable for implementing energy conversion techniques, including, for example, mechanical-to-electrical energy conversion. Such electroactive polymer generator modules comprise a stretchable resilient material with a dielectric elastomer film sandwiched between two electrode layers. The application of a mechanical force to strain (stretch) an electroactive polymer generator module changes the capacitance of the dielectric elastomer film between the electrodes. A seed charge applied to the strained film rises to a higher film voltage which can be harvested when the electroactive polymer generator module relaxes. The electroactive polymer generator modules are suitable for direct drive applications, are highly scalable, reliable, and efficient.

In addition to providing various embodiments of electroactive polymer generators, in various aspects, the present disclosure also provides conditioning electronics logic and circuits and techniques that may be employed in conjunction with electroactive polymer generator modules to increase the efficiency of the generator. Each of these techniques will be described separately hereinbelow.

The generators may comprise one or more transmission mechanisms that couple to a source of mechanical energy and convert a portion of the mechanical energy to drive the one or more transducer portions of the generator. The transducers convert the mechanical energy to electrical energy in conjunction with conditioning electronics electrically coupled to the generator. Common sources of mechanical energy include, for example, water at rest or in motion, tides, waves, wind, solar, geothermal, among others.

The fundamental mechanism for generating electrical power from mechanical power utilizing electroactive polymers is the change in capacitance that the dielectric elastomer undergoes while cyclically stretching and contracting in response to the mechanical power. To be a significant electrical power generator an electroactive polymer generator should undergo at least a 3× to 4× capacitance change from a relaxed contracted state to a stretched state. Factors that contribute to the performance, efficiency, and reliability of a suitable electroactive polymer generator include dielectric materials, electrodes, mechanical configuration, electronics, and energy density and efficiency.

### Electroactive Polymer Energy Conversion Device

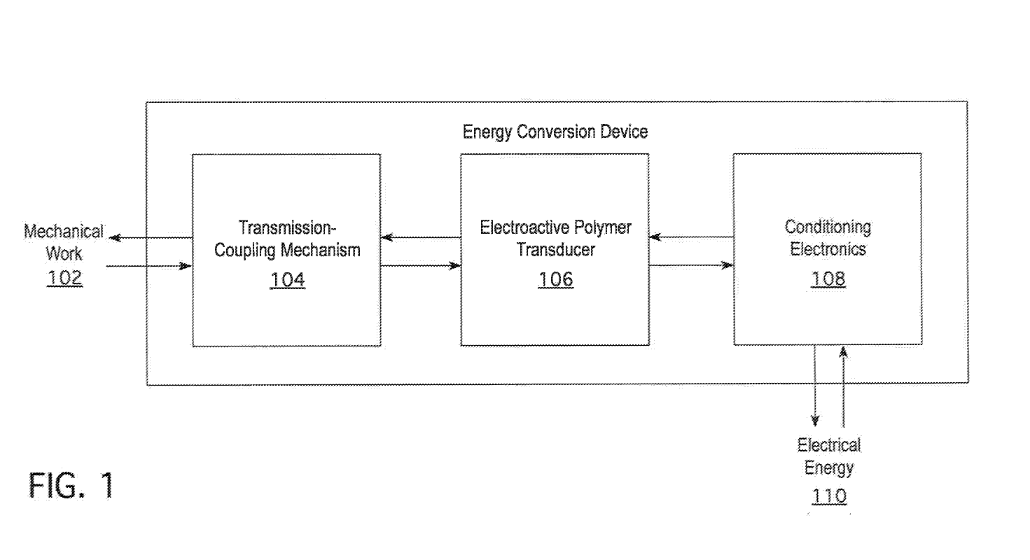

FIG. 1 is a block diagram of an energy conversion device 100 (generator 100) that may be used for harvesting electricity from a mechanical energy source 102. The mechanical energy source 102 may be input into the generator 100 in some manner via one or more transmission coupling mechanisms 104. Then, the mechanical energy may be converted to electrical energy by one or more transducers employing an electroactive polymer 106 in conjunction with conditioning electronics 108. Also, a portion of the mechanical energy may be used to perform additional mechanical work. The conditioning electronics 108 may transfer harvested electrical energy 110 to an electrical energy output. In some embodiments, the generator 100 may be operated in reverse to perform mechanical work upon the application of electrical power to the electroactive polymer transducers 106.

The mechanical energy used to generate electricity may be provided from a number of sources. For instance, the mechanical energy source 102 may be harvested from environmental sources such as water at rest or in motion, tides, waves, wind, solar, geothermal, among other sources. The environmental energy source may be transferred to the transducers 106 by a working fluid such water or air to generate mechanical work or energy. The mechanical energy may be harvested using the one or more electroactive polymer transducers 106 of the present disclosure to convert into electricity 110. A choice of the working fluid as well as other components of the generator 100 may depend on one or more operational and design parameters of the generator 100 such as operational environment of the generator (e.g., commercial, residential, land, marine, portable, non-portable, etc.), size of the generator, cost requirements, durability requirements, efficiency requirements, temperature of the power source and power output requirements.

In one embodiment, the mechanical energy to drive the generator 100 may be derived from water at rest or in motion, as in a hydroelectric plant that taps into mechanical energy and converts it into electrical energy. The primary components of such a mechanical energy source 102 would include a dam, a reservoir, a penstock, a transmission coupling mechanism 104, one or more electroactive polymer transducers 106, conditioning electronics 108, a transformer, and pipelines. A dam is a system that efficiently harnesses the mechanical energy, both potential and kinetic, of water. It can be built over a body of water, such as a river, with a natural elevation. The mechanical energy also may be derived from moving water such as that used to mill grain.

In another embodiment, the mechanical energy to drive the generator 100 may be derived from tides. The tides of the ocean produce two different types of energies, including thermal energy, or from the heat of the sun, and mechanical energy, by the motion of the waves and tides. The mechanical energy is exploited from the movement of the tides. The components of a tidal mechanical energy source 102 would include a mechanism to capture the mechanical energy, a transmission coupling mechanism 104, one or more electroactive polymer transducers 106, and conditioning electronics 108 to convert the mechanical energy into electricity. This may be done by using buoys, energy barrages, and water mills, for example.

In another embodiment, the mechanical energy to drive the generator 100 may be derived from windmills and wind turbines. Windmills and wind turbines use renewable wind energy to produce mechanical energy. A windmill works on the principle of converting kinetic energy, generated by the rotation of its blades, into rotational mechanical energy. A transmission coupling mechanism 104 couples the rotational mechanical energy to the one or more electroactive polymer transducers 106 and conditioning electronics 108 to convert the mechanical energy into electricity. Windmills are commonly installed in mountainous and coastal areas, where the wind speeds range from 5 to 15.5 miles per hour. The generator 100 according to the present disclosure harnesses the power of the wind to produce electricity using the one or more electroactive polymer transducers 106 and conditioning electronics 108. There are two types of wind turbines, including vertical axis wind turbines and horizontal axis wind turbines.

It will be appreciated that the above description of examples of mechanical energy sources is not exhaustive and other sources such as thermal energy sources may be employed to drive the one or more electroactive polymer transducers 106 and conditioning electronics 108 to generate electricity. Thermal energy can be generated from a variety of heat sources such as solar energy, geothermal energy, internal combustion, external combustion, or waste heat. The thermal energy can be converted to mechanical energy such that it can be used to drive the one or more transducers 106 located in the generator 100.

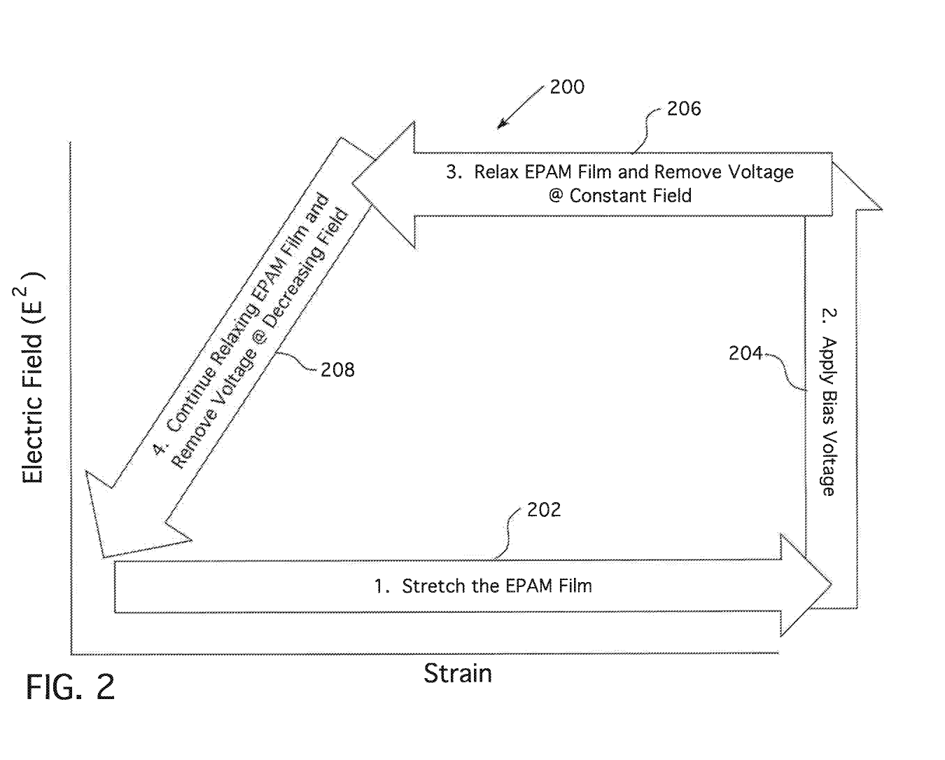

FIG. 2 illustrates a cycle 200 for converting energy using an energy conversion device including an electroactive polymer film of some type. The vertical axis depicts Electric Field, proportional to E² and the horizontal axis depicts strain. When the energy conversion device is operated as a mechanical-to-electric generator, mechanical energy is converted to electricity. In general, the mechanical energy source is used to deflect or stretch the electroactive polymer film in some manner. An energy conversion device of the present disclosure also may be used to perform mechanical work. In this case, electrical energy may be used to deflect an electroactive polymer film. Mechanical work performed by the electroactive polymer film in the deflection process may be used to apply a mechanical process. To generate electrical energy over an extended time period or to perform thermal work, the electroactive polymer film may be stretched and relaxed over many cycles.

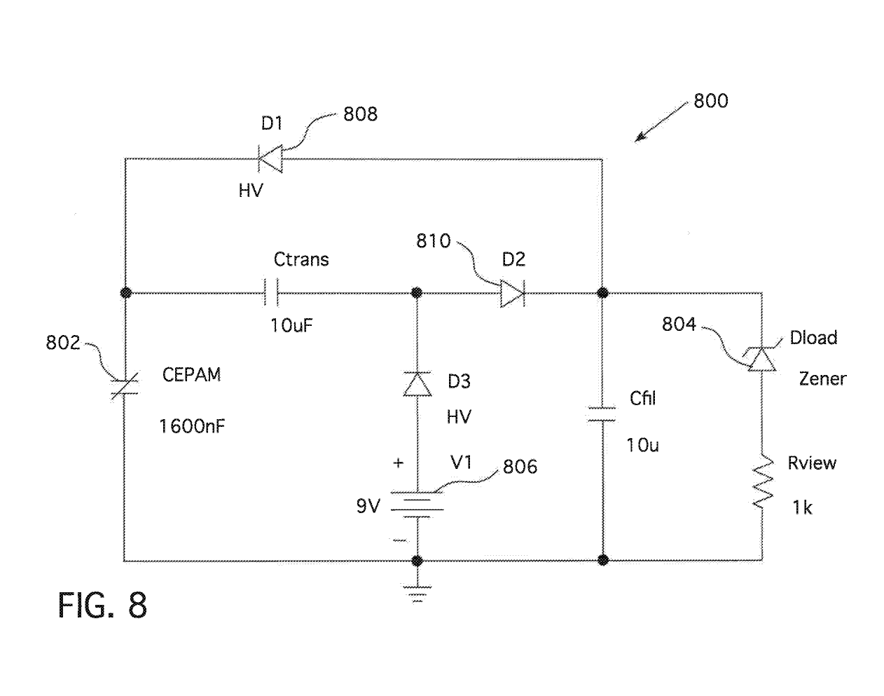

In FIG. 2, one cycle 200 of an electroactive polymer film stretching and relaxing to convert mechanical energy to electrical energy is shown. The cycle is for illustrative purposes only. Many different types of cycles may be employed by energy conversion devices of the present disclosure and the energy conversion devices are not limited to the cycle shown in FIG. 2. In 202, the electroactive polymer film is stretched with zero electric field pressure on the polymer. This stretching may result from a mechanical force applied to the film generated from an external energy source input into the energy conversion device. For example, a mechanical process may be used to deflect the electroactive film. In 204, the electric field pressure on the polymer film is increased to some maximum value. Conditioning electronics necessary to perform this function are described with reference to FIGS. 8, 18, and 19. In this example, the maximum value of the electric field pressure is just below the electrical breakdown strength of the electroactive polymer. The breakdown strength may change with time at a rate that may depend on but is not limited to: 1) an environment in which an energy conversion device is used, 2) an operational history of the energy conversion device, and a type of polymer used in the energy conversion device.

In 206, the electroactive polymer relaxes while the electric field pressure is maintained near its maximum value. The relaxation process may correspond to elastic restoring properties of the electroactive polymer allowing the electroactive film to relax. As the electroactive polymer relaxes, the voltage of the charge on the electroactive polymer film is increased. The increase in charge's electrical energy, as indicated by its higher voltage, on the electroactive polymer film is harvested to generated electrical energy. In 208, the electroactive polymer film fully relaxes as the electric field pressure is reduced to zero and the cycle may be repeated. For instance, the cycle may be initiated when a rotational mechanical force and cam mechanism is used to stretch and relax the electroactive polymer film.

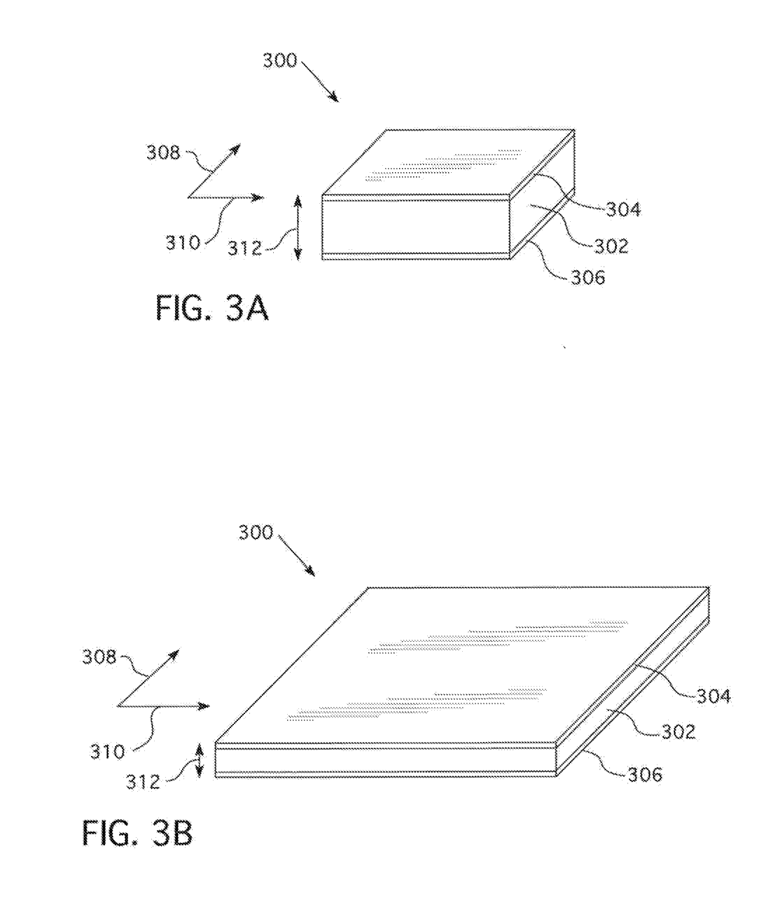

The transformation between electrical and mechanical energy in devices of the present disclosure is based on energy conversion of one or more active areas of an electroactive polymer, such as for example, an electroactive polymer dielectric elastomer. Electroactive polymers deflect when actuated by electrical energy. To help illustrate the performance of an electroactive polymer in converting electrical energy to mechanical energy, FIG. 3A illustrates a top perspective view of a transducer portion 300 in accordance with one embodiment. The transducer portion 300 comprises an electroactive polymer 302 for converting between electrical energy and mechanical energy. In one embodiment, an electroactive polymer refers to a polymer that acts as an insulating dielectric between two electrodes and may deflect upon application of a voltage difference between the two electrodes. Top and bottom electrodes 304 and 306 are attached to the electroactive polymer 302 on its top and bottom surfaces, respectively, to provide a voltage difference across a portion of the polymer 302. The polymer 302 deflects with a change in electric field provided by the top and bottom electrodes 304 and 306. Deflection of the transducer portion 300 in response to a change in electric field provided by the electrodes 304 and 306 is referred to as actuation. As the polymer 302 changes in size, the deflection may be used to produce mechanical work.

FIG. 3B illustrates a top perspective view of the transducer portion 300 including deflection in response to a change in electric field. In general, deflection refers to any displacement, expansion, contraction, torsion, linear or area strain, or any other deformation of a portion of the polymer 302. The change in electric field corresponding to the voltage difference applied to or by the electrodes 304 and 306 produces mechanical pressure within the polymer 302. In this case, the unlike electrical charges produced by the electrodes 304 and 306 attract each other and provide a compressive force between the electrodes 304 and 306 and an expansion force on the polymer 302 in the planar directions 308, 310, causing the polymer 302 to compress between the electrodes 304, 306 in the and stretch in the planar directions 308, 310.

In some cases, the electrodes 304 and 306 cover a limited portion of the polymer 302 relative to the total area of the polymer. This may be done to prevent electrical breakdown around the edge of the polymer 302 or to achieve customized deflections for one or more portions of the polymer. As the term is used herein, an active area is defined as a portion of a transducer comprising the polymer material 302 and at least two electrodes. When the active area is used to convert electrical energy to mechanical energy, the active area includes a portion of the polymer 302 having sufficient electrostatic force to enable deflection of the portion. When the active area is used to convert mechanical energy to electrical energy, the active area includes a portion of the polymer 302 having sufficient deflection to enable a change in electrostatic energy. As will be described below, a polymer of the present invention may have multiple active areas. In some cases, polymer 302 material outside an active area may act as an external spring force on the active area during deflection. More specifically, polymer material outside the active area may resist active area deflection by its contraction or expansion. Removal of the voltage difference and the induced charge causes the reverse effects.

The electrodes 304 and 306 are compliant and change shape with the polymer 302. The configuration of the polymer 302 and the electrodes 304 and 306 provides for increasing the polymer 302 response with deflection. More specifically, as the transducer portion 300 deflects, compression of the polymer 302 brings the opposite charges of electrodes 304 and 306 closer and the stretching of the polymer 302 separates similar charges in each electrode. In one embodiment, one of the electrodes 304 and 306 is ground.

In general, the transducer portion 300 continues to deflect until mechanical forces balance the electrostatic forces driving the deflection. The mechanical forces include elastic restoring forces of the polymer 302 material, the compliance of electrodes 304 and 306 and any external resistance provided by a device and/or load coupled to the transducer portion 300. The deflection of the transducer portion 300 as a result of the applied voltage may also depend on a number of other factors such as the polymer 302 dielectric constant and the size of polymer 302.

Electroactive polymers in accordance with the present disclosure are capable of deflection in any direction. After application of the voltage between electrodes 304 and 306, the polymer 302 expands (stretches) in both of the planar directions 308 and 310. In some cases, the polymer 302 is incompressible, e.g. has a substantially constant volume under stress. For an incompressible polymer 302, the polymer 302 decreases in thickness as a result of the expansion in the planar directions 308 and 310. It should be noted that the present invention is not limited to incompressible polymers and deflection of the polymer 302 may not conform to such a simple relationship.

Application of a relatively large voltage difference between the electrodes 304 and 306 on the transducer portion 300 shown in FIG. 3A will cause the transducer portion 300 to change to a thinner, larger area shape as shown in FIG. 3B. In this manner, the transducer portion 300 converts electrical energy to mechanical energy. The transducer portion 300 also may be used to convert mechanical energy to electrical energy in a bi-directional manner.

FIGS. 3A and 3B may be used to show one manner in which the transducer portion 300 converts mechanical energy to electrical energy. For example, if the transducer portion 300 is mechanically stretched by external forces to a thinner, larger area shape such as that shown in FIG. 3B, and a relatively small voltage difference (less than that necessary to actuate the film to the configuration in FIG. 3B) is applied between the electrodes 304, 306, the transducer portion 300 will contract in area between the electrodes to a shape such as in FIG. 3A when the external forces are removed. Stretching the transducer refers to deflecting the transducer 300 from its original resting position—typically to result in a larger net area between the electrodes, e.g., in the plane defined by the directions 308, 310 between the electrodes. The resting position refers to the position of the transducer portion 300 having no external electrical or mechanical input and may comprise any pre-strain in the polymer. Once the transducer portion 300 is stretched, the relatively small voltage difference is provided such that the resulting electrostatic forces are insufficient to balance the elastic restoring forces of the stretch. The transducer portion 300 therefore contracts, and it becomes thicker and has a smaller planar area in the plane defined by the directions 308, 310 (orthogonal to the thickness between electrodes in the direction 312). When the polymer 302 becomes thicker, it separates electrodes 304, 306 and their corresponding unlike charges, thus raising the electrical energy and voltage of the charge. Further, when the electrodes 304, 306 contract to a smaller area, like charges within each electrode compress, also raising the electrical energy and voltage of the charge. Thus, with different charges on the electrodes 304, 306, contraction from a shape such as that shown in FIG. 3B to one such as that shown in FIG. 3A raises the electrical energy of the charge. That is, mechanical deflection is being turned into electrical energy and the transducer portion 300 is acting as a generator.

In some cases, the transducer portion 300 may be described electrically as a variable capacitor. The capacitance decreases for the shape change going from that shown in FIG. 3B to that shown in FIG. 3A. Typically, the voltage difference between the electrodes 304, 306 will be raised by contraction. This is normally the case, for example, if additional charge is not added or subtracted from the electrodes 304, 306 during the contraction process. The increase in electrical energy, U, may be illustrated by the formula U=0.5 Q²/C, where Q is the amount of positive charge on the positive electrode and C is the variable capacitance which relates to the intrinsic dielectric properties of the polymer 302 and its geometry. If Q is fixed and C decreases, then the electrical energy U increases. The increase in electrical energy and voltage can be recovered or used in a suitable device or electronic circuit in electrical communication with the electrodes 304, 306. In addition, the transducer portion 300 may be mechanically coupled to a mechanical input that deflects the polymer and provides mechanical energy.

The transducer portion 300 will convert mechanical energy to electrical energy when it contracts. Some or all of the charge and energy can be removed when the transducer portion 300 is fully contracted in the plane defined by the directions 308, 310. Alternatively, some or all of the charge and energy can be removed during contraction. If the electric field pressure in the polymer 302 increases and reaches balance with the mechanical elastic restoring forces and external load during contraction, the contraction will stop before full contraction, and no further elastic mechanical energy will be converted to electrical energy. Removing some of the charge and stored electrical energy reduces the electrical field pressure, thereby allowing contraction to continue. Thus, removing some of the charge may further convert mechanical energy to electrical energy. The exact electrical behavior of the transducer portion 300 when operating as a generator depends on any electrical and mechanical loading as well as the intrinsic properties of the polymer 302 and electrodes 304, 306.

In one embodiment, the electroactive polymer 302 may be pre-strained. Pre-strain of a polymer may be described, in one or more directions, as the change in dimension in a direction after pre-straining relative to the dimension in that direction before pre-straining. The pre-strain may comprise elastic deformation of the polymer 302 and be formed, for example, by stretching the polymer in tension and fixing one or more of the edges while stretched. For many polymers, pre-strain improves conversion between electrical and mechanical energy. The improved mechanical response enables greater mechanical work for an electroactive polymer, e.g., larger deflections and actuation pressures. In one embodiment, pre-strain improves the dielectric strength of the polymer 302. In another embodiment, the pre-strain is elastic. After actuation, an elastically pre-strained polymer could, in principle, be unfixed and return to its original state. The pre-strain may be imposed at the boundaries using a rigid frame or may also be implemented locally for a portion of the polymer.

In one embodiment, pre-strain may be applied uniformly over a portion of the polymer 302 to produce an isotropic pre-strained polymer. By way of example, an acrylic elastomeric polymer may be stretched by 200 to 400 percent in both planar directions. In another embodiment, pre-strain is applied unequally in different directions for a portion of polymer 302 to produce an anisotropic pre-strained polymer. For example, a silicone film may be stretched by 0 to 10% in one planar direction and 10 to 100% in the other planar direction. In this case, the polymer 302 may deflect greater in one direction than another when actuated. While not wishing to be bound by theory, the present inventors speculate that pre-straining a polymer in one direction may increase the stiffness of the polymer in the pre-strain direction. Correspondingly, the polymer is relatively stiffer in the high pre-strain direction and more compliant in the low pre-strain direction and, upon actuation, more deflection occurs in the low pre-strain direction. In one embodiment, the deflection in the direction 308 of the transducer portion 300 can be enhanced by exploiting large pre-strain in the perpendicular direction 310. For example, an acrylic elastomeric polymer used as the transducer portion 300 may be stretched by 300 percent in the direction 308 and by 500 percent in the perpendicular direction 310. The quantity of pre-strain for a polymer may be based on the polymer material and the desired performance of the polymer in an application.

Anisotropic pre-strain also may improve the performance of the transducer 300 to convert mechanical energy to electrical energy in a generator mode. In addition to increasing the dielectric breakdown strength of the polymer and allowing more charge to be placed on the polymer, high pre-strain may improve mechanical to electrical coupling in the low pre-strain direction. That is, more of the mechanical input into the low pre-strain direction can be converted to electrical output, thus raising the efficiency of the generator.

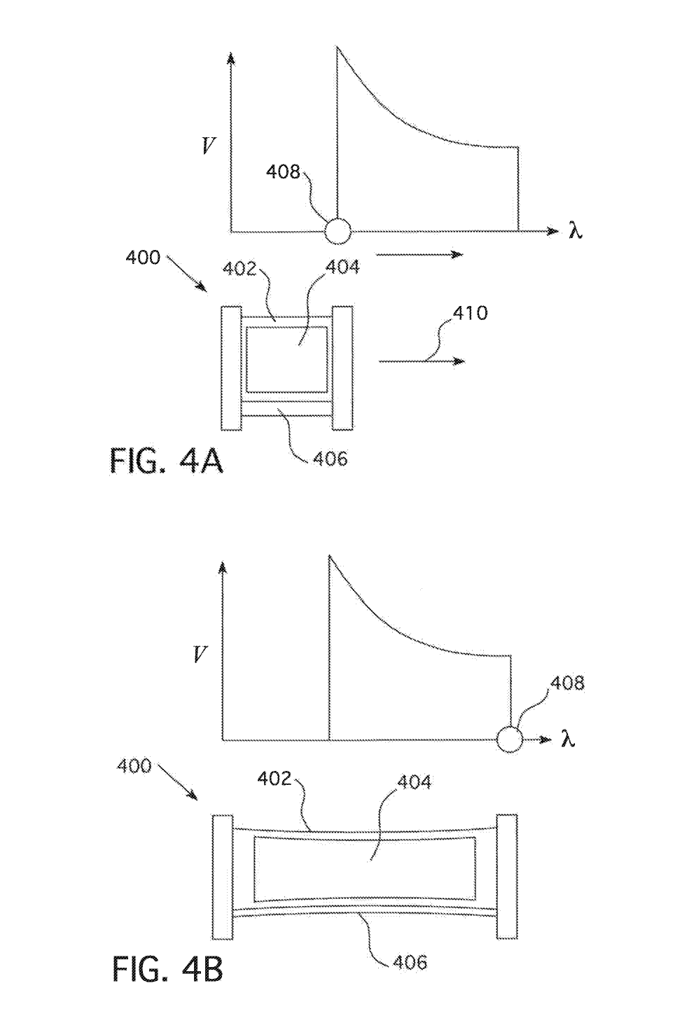

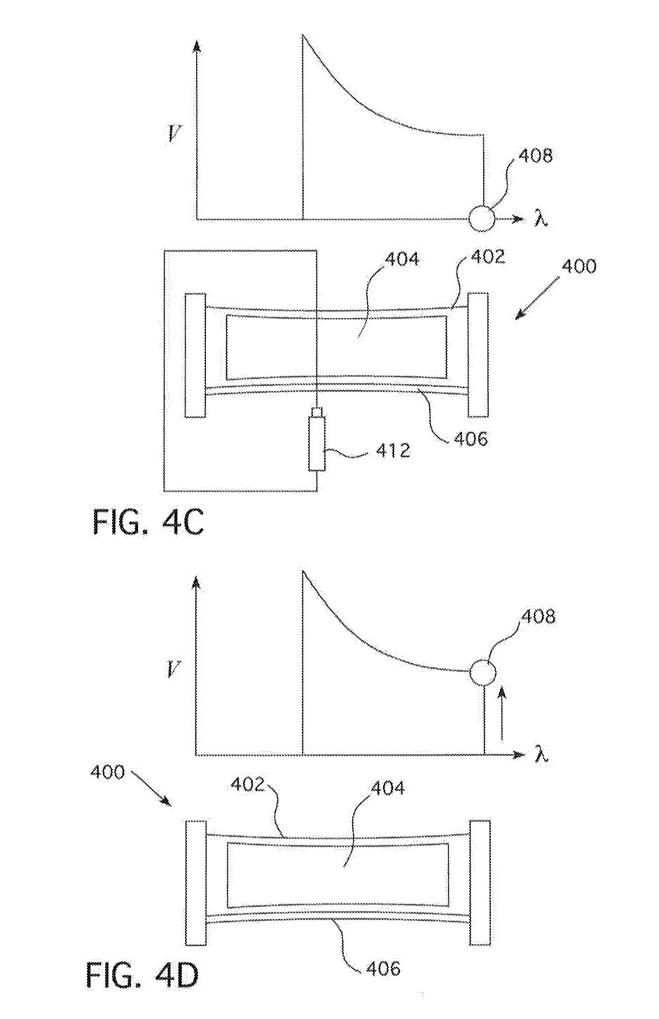

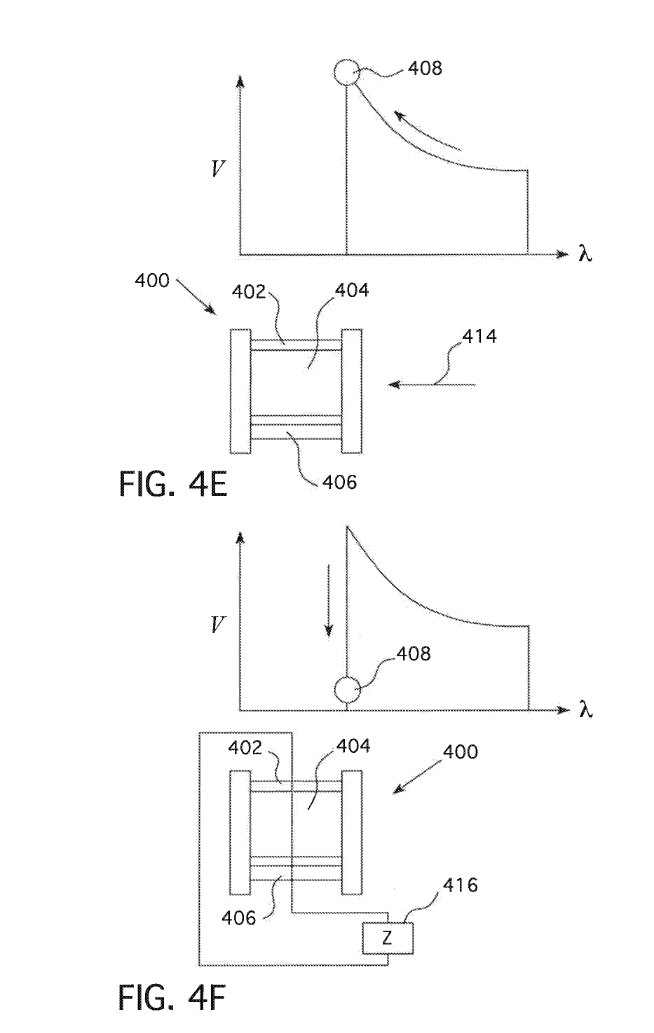

FIGS. 4A-4F illustrate one cycle of an electroactive polymer generator 400 for converting mechanical energy using an energy conversion device including an electroactive polymer film 402, e.g., a dielectric elastomer film. A graphical representation accompanies the illustrative cycle, where the vertical axis corresponds to Electric Field (Voltage) and the horizontal axis corresponds Strain Ratio (λ) to illustrate the mechanical to electrical power conversion cycle. Stretchable electrodes 404, 406 are formed on the electroactive polymer film 402. When the dielectric elastomer film 402 is relaxed, the electric charge 408 stored by the electroactive polymer film 402 is at a first level. The electroactive polymer film 402 and the stretchable electrodes 404, 406 are then stretched in the direction 410 by any suitable mechanical work. The electric charge 408 remains at the first level. As shown in FIG. 4B, the electroactive polymer generator 400 is in a stretched state. The electroactive polymer film 402 and the stretchable electrodes 404, 406 change capacitance when stretched. In one aspect, in the stretched state, the stretchable electrodes 404, 406 are closer together and raise the capacitance. When the electroactive polymer film 402 and the stretchable electrodes 404, 406 are in a stretched state, as shown in FIG. 4C, the electrodes 404, 406 are coupled to an energy source 412, e.g., a direct current (DC) battery, and a bias voltage is applied to the electroactive polymer film 402 to raise the charge 408 to a higher voltage. As shown in FIG. 4D, the energy source is removed and the electroactive polymer film 402 remains charged at the higher voltage. As shown in FIG. 4E, as the electroactive polymer film 402 and the stretchable electrodes 404, 406 are relaxed in the direction 414, the electroactive polymer film 402 and the stretchable electrodes 404, 406 shrink and separate. Accordingly, the capacitance of the electroactive polymer film 402 is lowered and the voltage is raised to a higher level. As shown in FIG. 4F, when the electroactive polymer film 402 and the stretchable electrodes 404, 406 are back is a relaxed state, the electrodes 404, 406 are coupled to a load 416 and the stored voltage (or charge) is delivered to the load 416, thus discharging the electroactive polymer film 402. The cycles repeat in accordance with the mechanical work applied at the input of the electroactive polymer generator 400.

With reference now to FIGS. 4A-4F, whether the electroactive polymer film 402 is being used as an actuator or an electroactive polymer generator 400, the basic structure of the electroactive polymer film 402 is high dielectric elastomeric film patterned on each side with stretchable electrodes 404, 406. In actuator mode, when a voltage is applied to the electroactive polymer 402, the polymer compresses in thickness and expands in area by the effect of the electrostatic forces from the unlike charges on the two electrodes 404, 406. Generator mode is basically the reverse of the actuator mode. Application of mechanical energy 410 to the electroactive polymer film 402 to stretch it causes compression in thickness and expansion of the surface area. At this point, a voltage 412 is applied to the electroactive polymer film 402. The applied electrical energy 412 is stored on the polymer 402 as electric charge 408. When the mechanical energy decreases 414, the elastic recovery force of the electroactive polymer film 402 acts to restore the original thickness and to decrease the area. This mechanical change increases the voltage potential between the two electrodes 404, 406 layers, resulting in an increase of electrostatic energy.

The analytical equations to describe the electroactive polymer generator 400 mode are described below. These equations can be understood by noting that an electroactive polymer film 402 based generator 400, e.g. an Electroactive Polymer Artificial Muscle (EPAM™) generator, is basically a capacitor whose capacitance varies as the electroactive polymer film 402 stretches and contracts. The capacitance of an electroactive polymer film 402 is:

C=∈₀∈A/t=∈₀∈b/r′ (1)

where ∈₀ is the dielectric permittivity of free space, ∈ is the dielectric constant of the electroactive polymer film 402, A is the active polymer area (coated on each side by the electrodes 404, 406), and t and b are the thickness and the volume of the polymer, respectively. The second equality in Equation (1) can be written because the volume of elastomer is essentially constant, i.e., At=b=constant.

The energy generated in one cycle of stretching and contraction is:

E=0.5C₁V_{b}²(C₁/C₂−1) (2)

where C₁ and C₂ are the total capacitances of the dielectric elastomer films in the stretched and contracted states, respectively, and V_{b} is the bias voltage applied in the stretched state. The amount of energy that a given mass of electroactive polymer film 402 can generate is ultimately determined by its maximum strain and dielectric breakdown strength.

### Energy Density of the Electroactive Polymer Generator

An energy density of 0.4 joules per gram (per actuation cycle) has been demonstrated for an electroactive polymer generator 400 with an acrylic based electroactive polymer film 402 material. Achieving the energy density of 0.4 joules per gram requires the use of conditioning electronics to optimize the complete generation cycle of an electroactive polymer power generator 400. In one embodiment, microcontroller based electronics and logic may be employed. At power levels greater than 100 watts, conditioning electronics circuits enable the advantages of the electroactive polymer generator 400 to be exploited.

Unlike electromagnetic generators, electroactive polymer generators 400 scale linearly with power. For example, to create a generator ten times more powerful at least ten times more material is required. This is not the case with electromagnetic generators. Electromagnetic generators have two important advantages as they scale up in power. First, their weight and volume do not scale linearly. The mass of a 10 kilowatt generator will only be approximately three times the mass of a 1 kilowatt generator. As indicated, by the time the electroactive polymer generator 400 is on the order of 100 kilowatts, the power density has improved by an order of magnitude, making it very competitive at higher powers. Secondly, as electromagnetic generators increase in power, their efficiencies improve. Many high power generators have efficiencies exceeding 97%.

Electroactive polymer generators 400 provide advantages over electromagnetic generators when the following criteria are met:

Electroactive polymer generators 400 provide advantages when forces are high and velocities are low. Mechanical power equals force multiplied by velocity. Electromagnetic generators are well suited for high velocity mechanical power (especially rotational). Rotational speeds of 1800 RPM (30 rotations per second) are typically used for standard utility power (60 hertz in the US, 50 hertz in Europe and other places). For a typical 3 horsepower (2238 watts) electromagnetic generator, the rotor surface speed would be approximately 15-20 meters per second. In comparison, a one meter high ocean wave at 0.3 hertz only achieves a maximum speed of 0.9 meters per second but can generate very high forces. Wind power is also typically slow. Many wind turbines rotate at about 30 RPM and require gear boxes to increase this by a factor of 50 (to achieve 1500 rpm) to connect to the electromagnetic generator. Suitable electroactive polymer generators 400 may be directly coupled to the main shaft of a wind turbine to produce electrical power.

In addition, electroactive polymer generators 400 provide an advantage when connected to a regulated high voltage DC electrical grid in the range of 2-10 kVDC. Because of the way electroactive polymer generators 400 generate electrical power they are well suited for high voltage DC systems. Rotational electromagnetic generators typically generate at voltages less than 600 volts and produce alternating current waveforms. To convert this to high voltage DC either a transformer/rectifier set must be used or some other type of high power inverter electronics. Electroactive polymer generators 400 can be directly connected to a high voltage dc grid with a minimum of electronics. The corollary side of this is that electroactive polymer generators 400 require conversion electronics to convert the high voltage DC power into low voltage power suited for most low power electronics type applications.

Furthermore, electroactive polymer generators 400 that are self-starting provide an advantage at remote locations when standard utility power is not available. Competing technologies for this criterion are solar power, wind power with electromagnetic generators and hydro-power with electromagnetic generators. Two of these (wind and solar) share an even further complexity in that these sources of power are not predictable. Therefore, either the system must be self-starting or a sufficient amount of electrical storage (typically batteries) must be included to handle periods of unavailability.

In the general case of power generation, reliability is one of the most important aspects. Electromagnetic power generation has been utilized for over 100 years. During that time, electromagnetic generators have demonstrated reliability exceeding 30 years of useful life. In addition, electromagnetic generators have been built in power ranges from milliwatts to megawatts.

For wind power applications, an electroactive polymer generator 400 must be able to handle environmental conditions associated with the application. Temperature and humidity requirements vary by location (for example: the wind generators located at the Altamont Pass in Central California experience less variation in temperature then those located in Denmark). Basic protection from the elements is assumed and will be in the form of rain protected enclosures, however, additional precautions will be required for electroactive polymer generators 400 and the associated electronics due to the nature of high voltage DC. Many high voltage electronic systems require periodic maintenance to remove accumulated dust attracted to high voltage parts. Either a sealed enclosure is necessary or some other measures must be made to prevent the buildup of unwanted particles (high voltage dc conductors basically act as electrostatic precipitators and collect dust and other airborne particles).

### Elasticity and Electric Field Interaction of Dielectric Elastomers

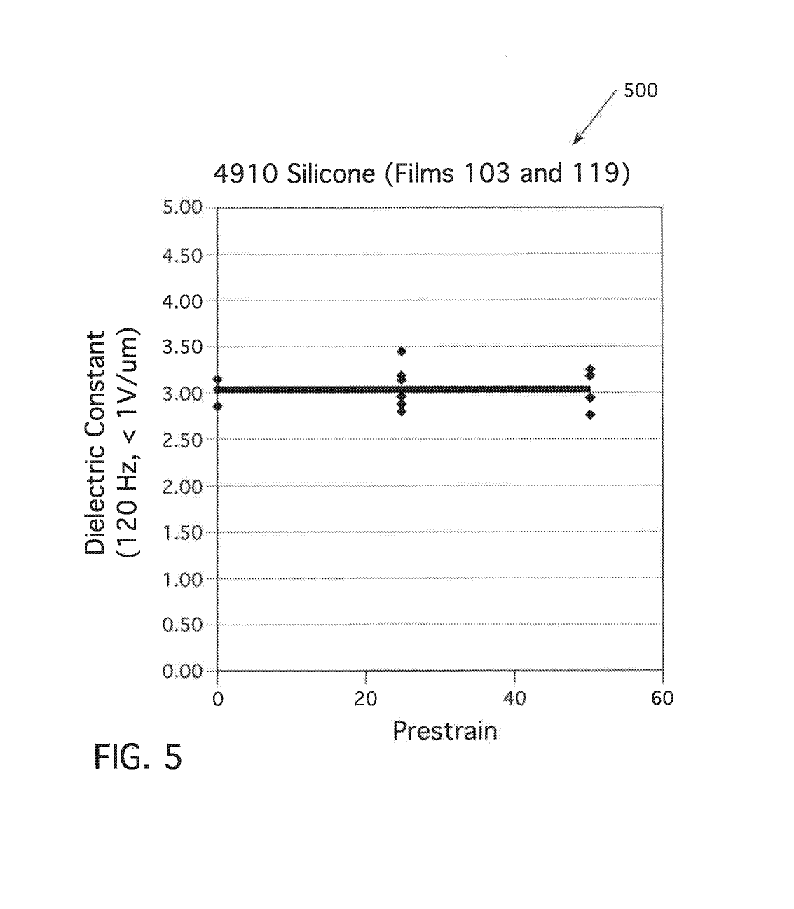

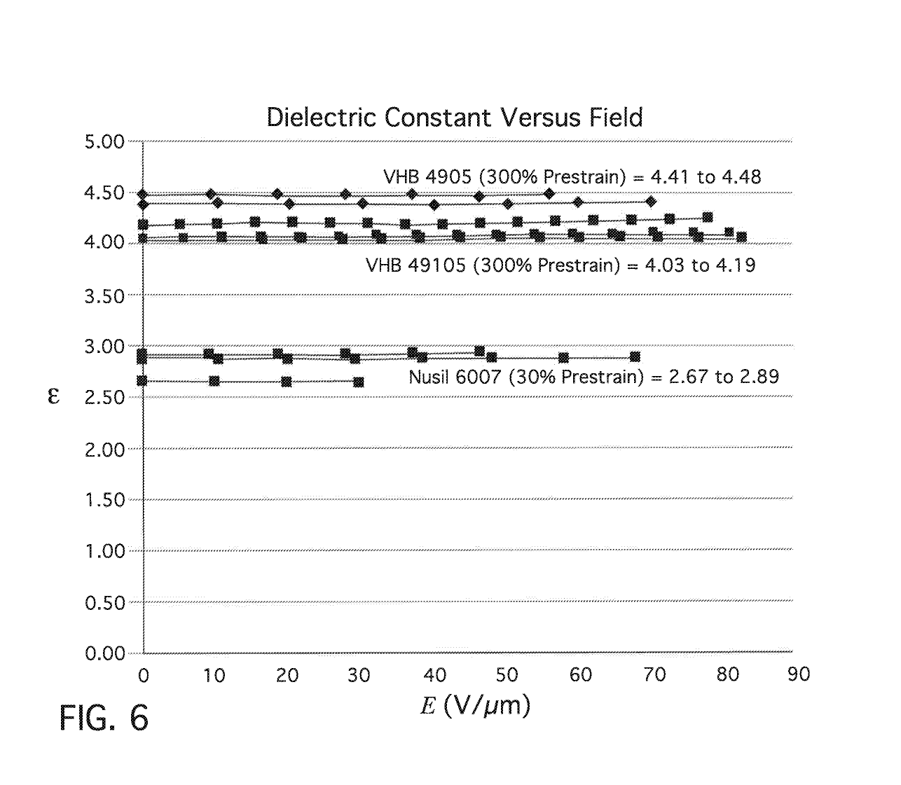

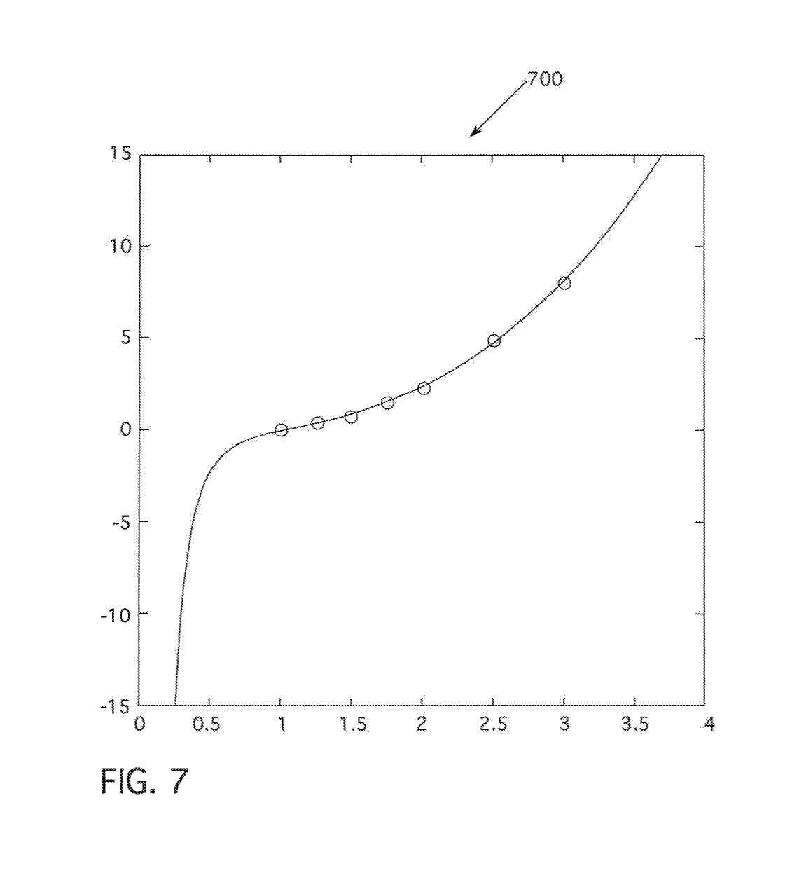

FIG. 5 is a graphical representation 500 of measurements of dielectric constants for various silicone dielectric elastomer materials. The vertical axis corresponds to Dielectric Constant (120 Hz, <1 V/μm) and the horizontal axis corresponds to Pre-strain. As shown in FIG. 5, there is no evidence that the dielectric constant of 4910 silicone (films 103 and 119) remains substantially constant with varying strain. Although not shown, the results are similar for acrylic. FIG. 6 is a graphical representation 600 of dielectric constant versus electric field. The vertical axis corresponds to dielectric constant (∈) and the horizontal axis corresponds to electric field ∈(V/μm). As shown in FIG. 6, measurements of dielectric constants at 500 Hz in silicone and acrylic materials VHB 4905, VHB 4910, and NUSIL 6007 are substantially constant with varying electric field despite the application of strong DC electric fields. As such, during operation the electrostatic stresses applied to the elastomer will be close to the theoretical value σ=∈ᵣ∈₀E².

Other dielectric elastomers may or may not have variations of relative permittivity when subjected to large mechanical strains and high electric fields. The restoring stresses the dielectrics offer when stretched are slightly more complicated to model. Pre-strain, (sometimes anisotropic), is used to thin the dielectrics during manufacture. Because the elastomers strain-harden in response to large strains, nonlinear constitutive laws are required. An Ogden model provides a reasonable approximation of stresses in directions 1, 2, and 3 as the material is deformed in directions 1, 2, and 3. FIG. 7 is a graphical representation 700 of an Ogden model fit to a silicone elastomer.

### Dielectric and Electrode Materials

In general, there are two basic material components of electroactive polymers to consider in energy harvesting applications. This section will provide a review of electroactive polymer elastomeric dielectrics and electrode materials and the state of those material technologies for use in electroactive polymer generators. Energy generated via electroactive polymer is influenced by the elastic and dielectric properties of a given material: dielectric constant, material elongation, volume resistivity and dielectric breakdown strength (DBS) are important properties. Material sensitivities to temperature and humidity are also important to consider. The energy generation cycles are enhanced by materials which show advantages in any of these characteristics. Four elastomeric materials used as electroactive polymer dielectrics are described below: acrylates, silicones, urethanes, and butyl rubbers. Other materials such as hydrocarbon rubbers, fluoroelastomers, and styrenic copolymers may also be used.

There is much work and knowledge relating to the field of electroactive polymers on VHB™ acrylics. They are known to have higher dielectric constant values (typically 4-4.5), large elongation ranges (up to 400% biaxial elongation) and dielectric breakdown strengths of 120 V/micron. However, these materials have limited temperature ranges and long term stability issues. Acrylic VHB™ materials are hydrophilic and highly sensitive to effects of humidity. Higher humidity environments decrease the volume resistivity of these materials, with a working range up to 35% relative humidity at room temperature. These attributes limit the use of these materials to lab scale prototype demonstrations for electroactive polymer based energy generators.

Silicone elastomers as electroactive polymer dielectrics provide temperature stability (−40 to 85 C) and long term reliability (>30 MM Cycles). To date, these elastomers have shown limited elongation ranges of up to 100%, and lower dielectric constants in the range of 2.8-3.1. Lower modulus (1-10 Shore A) silicones have limited dielectric breakdown strength values below 100 V/um. Higher modulus silicones have been shown to achieve >150 V/um dielectric breakdown strength values. Silicone elastomers have been shown to operate as electroactive polymer dielectrics in 85 C, 85% RH conditions. Silicone is innately hydrophobic, with a typical volume resistivity of 10¹⁵ ohm-meters; however, it is not a barrier to humidity which limits its long term reliability as an electroactive polymer dielectric in high humidity environments. Silicone's reliability and environmental stability offer advantages for its use as an electroactive polymer generator dielectric. Improvements to silicone's dielectric constant, dielectric breakdown strength and elongation would enhance its performance in these applications.

Polyurethane materials have had limited development as electroactive polymer dielectrics. Some promise has been shown in the relative dielectric constant of urethane materials up to 200. These materials, to date, have shown an elongation challenge which would prevent sufficient capacitance change for electroactive polymer power generation.

Butyl rubbers have also been considered for use as electroactive polymer dielectrics for insensitivity to humidity. They have dielectric constants in the range of 2.8 to 3.0. With limited testing, these materials have shown an elongation challenge similar to urethanes, and have been shown to provide suitable volume resistivity.

Electroactive polymer electrode materials are based on ink formulations which are solvated for different printing processes. These printed electrodes consist of carbon blacks, silver nanoparticles and solid binders. These formulas have been adapted for processing options such as spraying, screen printing, pad printing and flexographic printing. The large surface areas of electroactive polymer required for high power electroactive polymer generators can be created by spraying and flexographic printing. Inks for electroactive polymer actuators have been formulated which offer exceptional environmental stability in the temperature range of −40 C to 85 C up to 85% RH (theoretically −80 C up to 190 C). The carbon/silver printable inks have surface resistivity values in the range of 10 to 100 kOhm/sq/mil. The surface resistivity increases with area strain, typically doubling with an area strain of 50%.

In general, energy generation cycles of electroactive polymer generators provide better performance at higher voltages. Electroactive polymer capacitors with printed electrodes will no longer hold voltage after one electrical breakdown. This requires that the systems be run with a sufficient voltage breakdown margin to ensure long term reliability, limiting the energy generation performance.

Currently, printed electroactive polymer electrodes cannot achieve the low resistance values required for electroactive polymer generators. The efficiency of these systems is dominated by the highly resistive electrode deposit. The resistivity of the electrode is no longer the limiting factor for capacitors made with sputtered silver/carbon bus electrodes. The system inefficiency is only dependent upon the charge dissipation in the dielectric when using highly conductive sputtered silver/carbon bus electrodes. For use as electroactive polymer electrodes, silver/carbon bus electrodes must be rendered compliant, for example, through texturing such as corrugation or through patterning such as herring-bone or fish-net structures.

Sputtered silver/carbon bus electrodes are also fault tolerant. Devices created with this electrode can continue operation after developing electrical breakdowns, creating opportunity to run at higher voltages for increased device performance. These electrodes can survive limited cycling before fatigue limits device performance. With current progress the electrode can survive to >5 Million cycles.

Challenges for sputtered silver/carbon bus electrodes include temperature and humidity sensitivity which is, at this point, unknown. Roll-to-roll vacuum metallization also is required to process large electroactive polymer film areas required for high power electroactive polymer generators.

Carbon based printed electrodes fall short for electroactive polymer generators. These electrodes have a combination of high equivalent series resistance (ESR), higher equivalent series resistance with increased device strain, and large voltage breakdown margin requirements (decreased operating voltages). Sputtered silver/carbon bus electrodes provide negligible resistance and better performance with higher operating voltages. These electrodes currently have reliability and manufacturing challenges and unknown environmental sensitivities.

Having described various materials suitable for electroactive polymer energy conversion devices, TABLES 1 and 2 below provide a specification for one embodiment of an electroactive polymer film (TABLE 1) and electrode (TABLE 2) suitable for electroactive polymer energy conversion devices as described herein.

TABLE 1

| | |
|---|---|
| εrel | ≧3, stable over frequencies of interest (0.1 to 10 Hz) |
| DBS | ≧100 V/um, Eoper ≧70 V/um |
| iₗₑₐₖ | <160 uA/m2 at Eoper |
| Strain | 120% or greater planar tension under 1 Hz cyclic |
| Stability | 0.3-0.5 MPa shear modulus (0.9-1.5 MPa Young's |
| | modulus) if neo-hookean stress-strain holds |
| Fault tolerance | Toughness and tear resistance sufficient to withstand |
| | electrical faults |
| Creep | Predictable steady state |

TABLE 2

| | |
|---|---|
| Sheet | <1000 ohms per square in the relaxed state. |
| Resistance | |
| Added Stiffness | Less than 20% of specific converter configuration |
| Added | Less than 4% of specific converter configuration |
| Hysteresis | |
| Strain | Follows strain squared law (or less). |
| Stability | Stable over 1 million strain cycles in laboratory |
| | environment |
| Film | Does not adversely affect film properties |
| Compatibility | |
| Self-Healing | Self-heals when subjected to defined dielectric failure |
| | conditions |

It will be appreciated that a plurality of composite materials can be used to implement the electroactive active polymer transducers. For the composite material to be used as mechanical-to-electrical energy transducers, the composite material must move, and in order to move, the soft but incompressible dielectric layers must have somewhere to go. Accordingly, such composite materials should comprise at least the following three types of materials: (1) Hard—rigid structural layers that carry loads and match the stiffness of the electrical and mechanical elements to which the transducer interfaces; (2) Soft—low modulus, incompressible dielectric elastomer layers that can be deformed by mechanical loads coming from outside the composite material and by internal electric fields applied to control the composite; and (3) Compressible—regions of gas, liquid, or expanded or porous materials (e.g. foams or aerogels), for example, into which the dielectric elastomer may bulge. These and other composite materials may be found in U.S. Provisional Patent Application Ser. No. 61/545,295, filed Oct. 10, 2011, entitled “COMPOSITE ELECTRODES COMPRISED OF A TEXTURED, RIGID, INSULATOR COVERED WITH THIN, SELF-HEALING CONDUCTOR LAYERS, AND DIELECTRIC ELASTOMER TRANSDUCERS INCORPORATING SUCH ELECTRODES,” the disclosure of which is incorporated herein by reference in its entirety.

It will be appreciated that in one embodiment, the electrodes according to the present disclosure may include a reinforcement feature to prevent propagation of cracks in the electrodes. Accordingly, the present disclosure turns now briefly to FIGS. 57-59 for a description of various reinforcement features that may be suitable to prevent propagation of cracks in the electrodes.

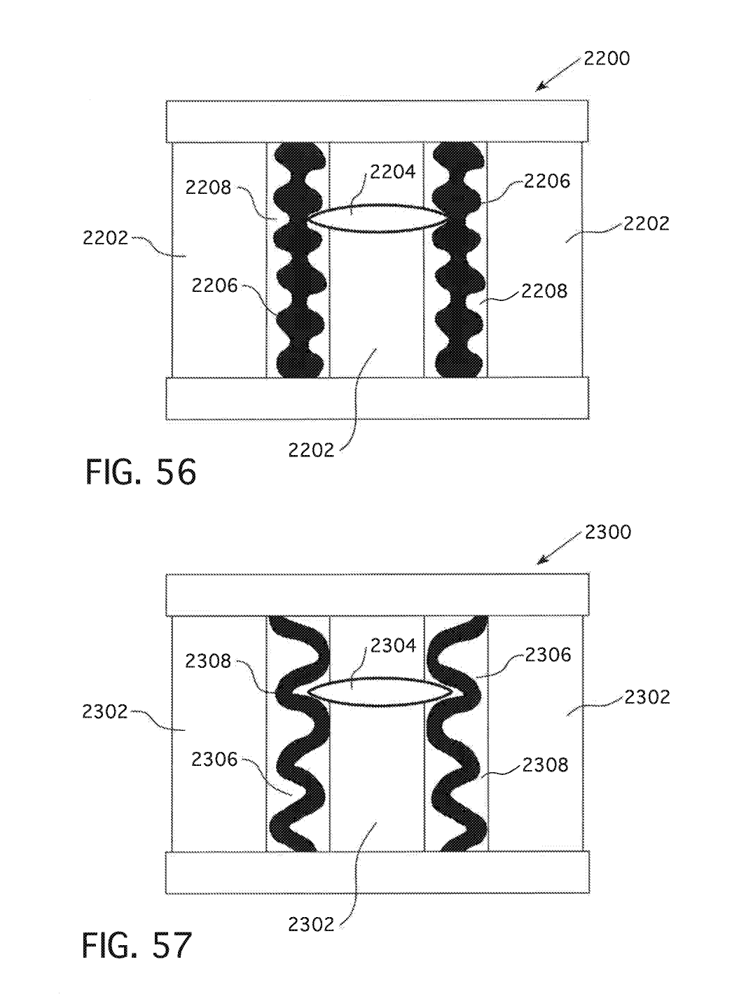

FIG. 56 is a diagram of an electroactive polymer film 2200 comprising a plurality of electrodes 2202 formed over a dielectric film 2208. As shown in FIG. 56, one of the electrodes developed a crack 2204. To stop the crack 2204 from propagating, energy traps in the form of a scalloped reinforcing beads 2206 are formed between the electrodes 2202 to prevent the crack 2204 from migrating to adjacent electrodes 2202.

Similarly, FIG. 57 is a diagram of an electroactive polymer film 2300 comprising a plurality of electrodes 2302 formed over a dielectric film 2308. As shown in FIG. 57, one of the electrodes developed a crack 2304. To stop the crack 2304 from propagating, energy traps in the form of a serpentine reinforcing beads 2306 are formed between the electrodes 2302 to prevent the crack 2304 from migrating to adjacent electrodes 2202.

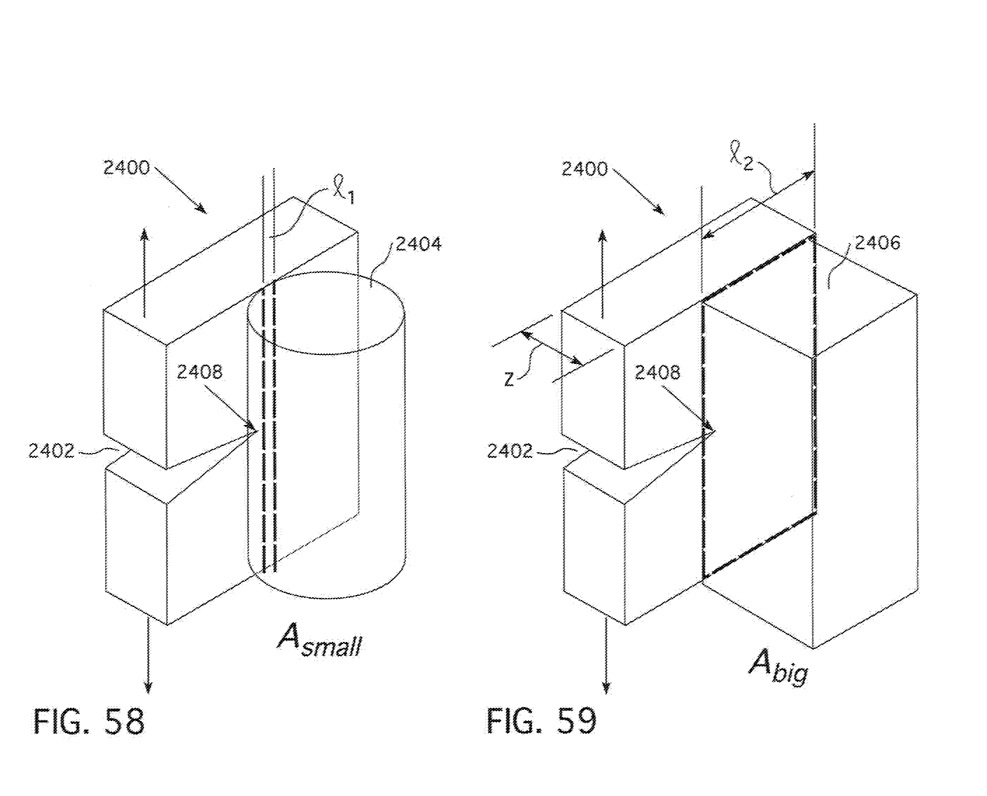

Another possible technique to prevent the propagation of cracks that form in an electroactive polymer film is to attach a calendered composite to the electrode at the trailing edge of the crack to increase the interfacial area and prevent the crack from propagating. FIG. 58 is a diagram of an electrode 2400 that has developed a crack 2402. A calendered composite 2404 in the form of a cylinder is attached to the electrode 2400 at the trailing edge 2408 of the crack 2402. Although the calendered composite 2404 in the form of a cylinder can be effective to prevent crack propagation, it provides only a small Aₛₘₐₗₗ contact area with the electrode 2400.

FIG. 59 is a diagram of an electrode 2400 that has developed a crack 2402. A calendered composite 2406 in the form of a rectangular tube is attached to the electrode 2400 at the trailing edge 2408 of the crack 2402. The calendered composite 2404 in the form of a rectangular tube 2406 provides a larger A_{big} contact area with the electrode 2400.

Textiles may also be laminated to a portion of the dielectric film to provide tear resistance and mechanical reinforcement. Conductive textiles may additionally provide bus or charge distribution capabilities.

### Electroactive Polymer Material Properties

Five key material properties have been identified for electroactive polymer generators for use in wave energy conversion. These key properties are 1) the elastomeric properties of the dielectric material and electrode and useful strain range; 2) the dielectric constant of the material; 3) the dielectric breakdown voltage of the material and the working voltage; 4) the dielectric resistivity of the material; and 5) the resistivity of the electrodes. In addition to these key parameters, other factors including lifetime, fatigue, water tolerance and tear strength (plus many more) also determine the suitability of a particular electroactive polymer system. Each of these key properties will be discussed in a little more detail in the following paragraphs.

The elastomeric properties of the dielectric material include a defined Young's modulus. However, hyper-elastic materials are typically not defined by a Young's modulus but by parameters fit to stress-strain curve data. Additionally, a hyper-elastic model is usually chosen (e.g., Neo-Hookean, Mooney-Rivlen, or Ogden) and parameters are reported consistent with the chosen model. Regardless of the way a material's elastic properties are defined, if a material is too “soft,” the chance of electromechanical instability during generator operation (and potential self-destruction) is high. Likewise, if a material is too “stiff,” the required mechanical forces to adequately strain the material for effective generator operation could become excessively large and not be of practical value. Preferably, the dielectric material should have a modulus less than about 100 MPa; less than about 10 MPa is more preferable. An evaluation of this is presented hereinbelow. The electrode contribution to the stiffness in general should be a small percentage of the overall stiffness.

The next property is the dielectric constant of the electroactive polymer film material. The dielectric constant is a property relative to the permittivity of a vacuum (which has historically been chosen as 1). Because an electroactive polymer generator works by converting mechanical elastic strain energy into electrostatic electrical energy, the dielectric constant of an electroactive polymer material gives some indication of how much better a material stores electrostatic energy over air (or a vacuum). It is also an indicator of how well the material will work as a mechanical to electrical energy converter. The dielectric breakdown strength of a material (which is not specific to electroactive polymers but applies to many dielectrics used in other industries) refers to a short term voltage test in which representative samples are subjected to a rising voltage waveform and the value of voltage at the time the sample fails is recorded. A destructive test standard is usually performed on representative samples. A dielectric withstand voltage test would typically be required for non-destructive testing and would be at a value somewhat below the dielectric breakdown strength and above the normal working voltage.

The dielectric resistivity of a material is one way of defining how well a dielectric material will store electrical charge and hence electrostatic energy. Just as it is not useful to have a flashlight battery that only can be stored for one hour, it is not useful to have a wave energy converter generator that consumes all the electrical energy it produces. If the dielectric resistivity of a particular material is too low, it would no longer be suitable (or practical) as an electroactive generator.

Electrode resistivity, and more specifically electrode resistance, directly relate to the losses during charging and discharging of an electroactive polymer generator. The charge and discharge rates are application specific. The actual resistivity values will depend on the electrode geometries and the number of external connections.

### Elastomeric Property Evaluation

Electromechanical instability condition of the electroactive polymer arises from a soft dielectric material under low pre-strain conditions in which a high electric field could cause the film to become unstable and “pinch” in small locations leading to self-destruction of the film. A boundary condition to consider for suitable electroactive polymer generator operation is electromechanical instability. Other boundary conditions also determine practical energy conversion cycles. Maximum operating strain will establish one boundary and electrical breakdown will establish another.

### Dielectric Constant and Breakdown Strength Evaluation

The dielectric constant of an ideal material for an electroactive polymer material is preferably relatively stable over the frequency range of 1 mHz to 1 kHz. Significantly nonlinear materials will pose both an analytical challenge and an operational challenge.

### Dielectric Resistivity Evaluation

Historically, many dielectric materials have been characterized for the conduction of electricity through the material. In general, an ideal dielectric has zero conductivity and does not allow electrical charge to pass through. In practice, however, the non-ideal dielectric material does pass charge and to quantify this property, the volume resistivity of the material is measured and reported. It is assumed that this property is isotropic, homogenous and linear. In the regime of electroactive polymer generators and actuators, this property is not linear with respect to electric field, temperature, humidity and other influences (i.e., electrode type and application, etc.). Recent experiments by the present inventors have shown the non-linear behavior of silicone dielectric films in haptic actuators to vary considerably. This variation is not a problem for electroactive polymer actuators used, for example, in haptic applications, but could pose a considerable problem for energy harvesting as it represents a system loss and may affect overall system performance.

### Electrode Resistivity Evaluation

An ideal electrode would have infinite electrical conductivity, infinite mechanical compliance and add no additional mass or cost to the electroactive polymer generator. Actual electrodes are none of the above. From a performance consideration, the electrode conductivity and the electrode compliance are two properties that should be of interest for evaluating generator performance. The electrode conductivity will determine the losses associated with transferring electrical charge into and out of the generator. Electrode compliance (and damping) will determine additional constraints and/or losses when cycling the electroactive polymer generator. The high voltage capacitor industry typically uses either metal foils or deposited metal electrodes for low loss capacitors. In the case of the high voltage capacitor, electrode compliance is not an issue (movement is undesirable). In the case of the electroactive polymer generator, compliant electrodes are mandatory and flat metal electrodes will generally not work. A textured or corrugated metal electrode structure that is compliant in one or more directions can be used. Patterned structures which have gaps that can open when the electrode is stretched can also be used. These types of textured or patterned metal electrode systems may be advantageous in electroactive polymer generators because they can be low-loss and compliant and may also be self-clearing or fault-tolerant in the event of an electrical fault that could develop a short circuit between electrodes. Other types of electrode systems include conductive inks and greases. Though these electrode systems are compliant, they typically are significantly less conductive than a textured or patterned metal electrode system, making them less desirable in electroactive polymer generators. Electrode systems that include combinations of high conductivity and low conductivity materials may be used advantageously in this application. For example, areas of lower conductivity inks may be connected or overlaid with a metal network pattern. The lower conductivity inks provide charge distribution throughout the active areas while the higher conductivity metal network pattern improves current carrying capacity for the electroactive polymer generator system.

The dielectric elastomer is the fundamental material for converting mechanical energy into electrical energy. In general, high dielectric constants and high dielectric breakdown strengths are desirable material properties for use in electroactive polymer generators. In addition to these properties, suitable modulus, low electrical conductivity and stability over environmental conditions are also desirable. A qualitative review of some example materials based on the present inventors' experience is presented in Table 3. As shown in the table, polyurethanes have the potential to be an exceptional electroactive polymer generator material provided some of the challenges associated with it can be solved.

TABLE 3

| Property | Acrylics | Silicones | Polyurethanes | Preference |
|---|---|---|---|---|
| Dielectric | 4-5 | 2.7-3.3 | 4-12 | Higher |
| Constant | | | | |
| DBS | >100 V/m | >100 V/m | >100 V/m | Higher |
| Modulus | 1-2 MPa | 0.5-2 MPa | 1-10 MPa | 1-10 MPa |
| Viscoelastic | Poor | Good | | Low Losses |
| Losses at 1 Hz | | | | Mechanical |
| Maximum | 200% | 200% | | 200%-400% |
| Usable Strain | | | | |
| Temperature | Poor | Good | | −20° C. to |
| Stability | | | | 65° C. |
| Leakage | Poor-Good | Good | | Very Low |
| Current | | | | |

### Electronics for Electroactive Polymer Generators

It is to be appreciated that the embodiments described herein illustrate example implementations, and that the functional elements, logical blocks, program modules, and circuits elements may be implemented in various other ways which are consistent with the described embodiments. Furthermore, the operations performed by such functional elements, logical blocks, program modules, and circuits elements may be combined and/or separated for a given implementation and may be performed by a greater number or fewer number of components or program modules. As will be apparent to those of skill in the art upon reading the present disclosure, each of the individual embodiments described and illustrated herein has discrete components and features which may be readily separated from or combined with the features of any of the other several embodiments without departing from the scope of the present disclosure. Any recited method can be carried out in the order of events recited or in any other order which is logically possible.

Electronics for electroactive polymer generators range from fairly simple to fairly complex. To achieve optimal performance from an electroactive polymer generator requires sophisticated electronics; however, modest performance can be achieved using very simple circuit topologies. In addition, application specific details may drive the choice of electronics and their complexity. Applications can range from fixed stroke and fixed frequency in some cases to variable stroke and variable frequency in others. These parameters and other considerations will determine which type of electronics is best suited for a specific application.

Electronics for electroactive polymer power generators can be classified into two groups, control level electronics and power level electronics. Control level electronics are technically feasible and only need to be evaluated from a cost and power consumption point of view. Power level electronics are feasible but keeping the cost low and the efficiency high is a significant trade-off for achieving an optimized design.

FIG. 8 illustrates one embodiment of a simple power generation circuit 800. The advantage of the circuit 800 is its simplicity. Only a small starting voltage 806 (of approximately 9 volts) is necessary to get the generator started (provided mechanical power is being put in). No control level electronics are necessary to control the transfer of high voltage into and out of the electroactive generator 802 via respective high voltage diodes D1 (808) and D2 (810). A passive voltage regulation is achieved by the zener diode 804 on the output of the circuit 800. The circuit 800 is capable of producing high voltage DC power and will operate the electroactive polymer generator 802 at an energy density level around 0.04-0.06 joules per gram. The circuit 800 is suitable for generating modest powers and demonstrating that electroactive polymer generators 802 are technically feasible.

In one embodiment, the circuit 800 utilizes a charge transfer technique to maximize the energy transfer per mechanical cycle of the electroactive polymer generator 802, while still maintaining simplicity. The circuit 800 also enables self-priming with extremely low voltages 806 (9 volts, for example). The circuit 800 also enables both variable frequency and variable stroke operation. In various embodiments, the circuit 800 maximizes energy transfer per cycle with simplified electronics (i.e., electronics that do not require control sequences, operates both in variable frequency and variable stroke applications, and provides a simple overvoltage protection to generator element.

To achieve higher power levels and higher energy densities in electroactive polymer generators both the control level electronics and the power electronics require a much higher level of sophistication. These electronics will also be different depending on the type of generator application. Fixed stroke, narrow frequency applications (perhaps water mills) require the least sophistication of the electronics, while variable stroke, variable frequency applications will require the most sophistication. To address the most sophisticated case, the control level electronics have the ability to sense the instantaneous capacitance of each electroactive polymer generator and determine whether it is increasing or decreasing. The electronics decide whether to put charge on the electroactive polymer film, remove charge from the electroactive polymer film, or to simply do nothing.

This would be the case for wave power generation as an example. For times of light wave or no wave activity, the generator should be in a low power, non generating mode (typically called SLEEP mode in electronics). Once a threshold of wave activity is detected, the system should bring the generator online (WAKE UP) and start producing power. If the wave activity falls below a certain level, then the electroactive generator would shut down again waiting for the next period of wave activity. The specific decision making criteria will depend on each application, however a control level electronics of this sophistication will be useful in practically all generator applications (i.e., only a few control level designs should be necessary to cover a wide variety of generator applications).

The power level electronics will be driven by the maximum output power of the electroactive generator. Similar circuit topologies may be used at a wide range of power levels but the size and ratings of the components will have to change. Power ranges of electroactive polymer generators can go from 10 watts up to 100 kilowatts (or perhaps larger). As the power levels increase, the complexity of thermal management becomes an issue and needs to be seriously addressed (this is true for all methods of power generation).

### Hyperelastic Models

There are a significant number of hyper elastic models and methods to describe the elastic behavior of rubber-like materials. Though some are perhaps better than others (depending on the situation), in general, it is best to use the simplest model that can still provide a useful prediction and understanding of the basic behavior. The purpose of this description is to provide a basic math structure for three commonly used models. The three models discussed herein are Neo Hookean, Mooney and Ogden, although there exist approximately twenty different models. The Neo Hookean model is the simplest and only uses one fit parameter, Mooney uses two parameters (note: the Mooney-Rivlin model extends the Mooney model by using a polynomial series) and the Ogden model typically uses six, however its structure lends itself to an unlimited number (as does the Mooney-Rivlin polynomial series). For the specific case of mechanical to electrical energy conversion utilizing electro-active polymers we will restrict our analysis to incompressible hyper elastic materials (this also greatly simplifies the math). By doing so, the principle invariants reduce to the following:

I₁=λ₁²+λ₂²+λ₃² (3)

I₂=λ₁²·λ₂²+λ₂²·λ₃²+λ₃²·λ₁² (4)

I₃=λ₁²·λ₂²·λ₃² (5)

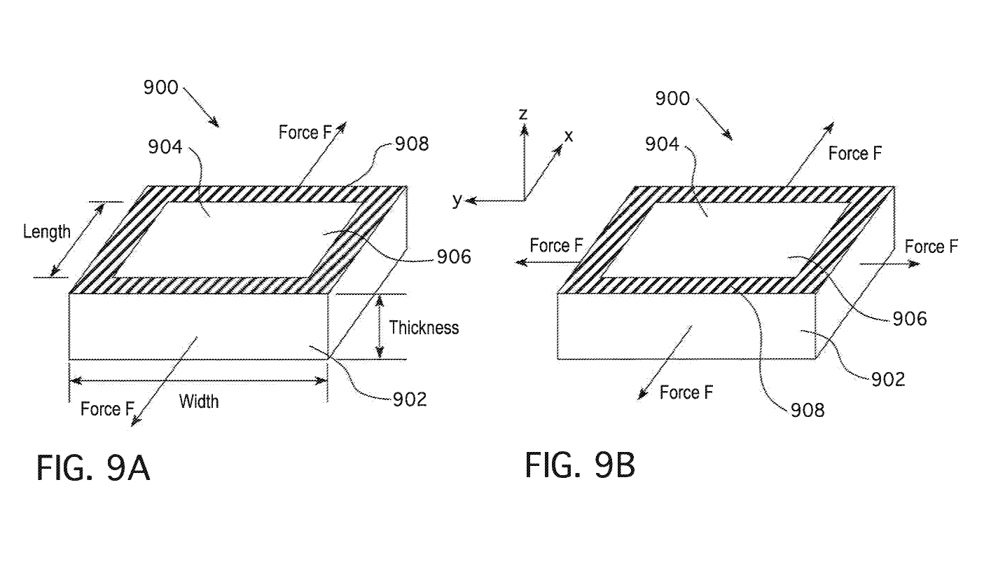

FIGS. 9A and 9B illustrate a defined coordinate system of an electroactive polymer generator. FIG. 9A shows a setup for uniaxial strain of an electroactive polymer generator 900. The electroactive polymer generator 900 comprises a dielectric elastomer 902 sandwiched between a top electrode 904 and a bottom electrode (not shown) and has a length, width, and thickness referenced to an x, y, z coordinate system. The electroactive polymer generator 900 has a predetermined electrode active area 906 and an inactive area 908 between the electrode 904 and the edge of dielectric elastomer 902 along the plane. FIG. 9B shows a setup for biaxial strain of the electroactive polymer generator 900.

It will be appreciated that where the principle stretch ratios are defined by λ₁, λ₂, and λ₃, these can be set to the three axes (x, y, z) when using a rectangular coordinate system. In the case of incompressible materials, I₃ is equal to 1 and therefore allows some useful substitutions into the other equations. There are a number of different ways to stretch elastic materials. In the simplest form, uniaxial extension as shown in FIG. 9A, as one axis is extended, the other two axes are allowed to freely contract, as shown in FIG. 9B. In equibiaxial extension, two axes are extended at equal rates and the third axis is allowed to freely contract (this is similar to the condition of inflating a balloon). In pure shear (or planar tension) one axis is extended, a second axis is restricted and the third axis is allowed to contract (this is probably the most typical case for energy harvesting). Another case is biaxial extension without forcing the two stretch axes to be equal.

In most practical cases of analyzing an energy converter, of interest is the elastic energy stored in the generator on an instantaneous basis. Therefore, mathematical expressions that provide the stored energy as a direct relationship to a spatial variable will be most useful. For the following models, the equations will be set up for the specific cases of planar tension first and then followed by equibiaxial extension. Additionally, an equibiaxial prestrain will be assumed, though this can be set to unity to analyze cases where no initial prestrain exist.

For the Ogden model the strain energy function is given by:

$$W = {\sum }_{i = 1}^{N} \frac{{μ}_{i}}{{α}_{i}} \cdot [ {λ}_{1}^{{α}_{1}} + {λ}_{2}^{{α}_{1}} + {λ}_{3}^{{a}_{1}} - 3 ]$$

Multiplying this by the volume of material gives the total energy stored in the electroactive polymer generator system (assuming uniform strain energy throughout the volume). Using a Cartesian coordinate system, one can write a general equation of the elastic stored energy in planar tension as a function of x(t):

$${W}_{ELASTIC} = \{ {x}_{0} \cdot {y}_{0} \cdot {z}_{0} \} \cdot {\sum }_{i = 1}^{N} \frac{{μ}_{i}}{{α}_{i}} \cdot [ {( \frac{x ( t ) + {x}_{ps}}{{x}_{0}} )}^{{α}_{1}} + {( \frac{{y}_{ps}}{{y}_{0}} )}^{{α}_{1}} + {( \frac{{x}_{0} - {y}_{0}}{{y}_{ps} \cdot ( x ( t ) + {x}_{ps} )} )}^{{α}_{1}} - 3 ] \qquad ( 7 )$$

where the third term is derived from the incompressibility criteria. For the Ogden model, typically six parameters are used. To use the expression for the Neo Hookean model, N is set to 1, and α₁ is set to 2. Then μ₁ is typically set to one third of the Young's modulus (which is the shear modulus for an incompressible material, sometimes referred to as G). For the Mooney model, N is set to 2, α₁ is set to 2 and α₂ is set to −2. The classic Mooney parameters C₁ and C₂ are used to calculate μ₁ and μ₂ by multiplying them by 2 and −2 respectively.

In many cases, data is presented from a first test condition. Care should be taken, however, because what is really desired is predicting behavior not in the first cycle, but in the thousandth cycle, the millionth cycle, and the billionth cycle, for example. In addition, understanding cyclic behavior over many cycles is important. Concerns of hysteresis, creep and other undesirable properties will be at the next step and it will be important early on to recognize these behaviors in materials long before they become a problem in an actual electroactive energy converter.

### Electrostatic Force and Pressure on Hyperelastic Dielectric Materials

It will be instructive to first derive the force on a parallel plate capacitor before moving on to the case of incompressible dielectrics. In the case of the parallel plate capacitor, when the two plates are oppositely charge there exists an attractive force between the plates due to the electric field between the plates. Coulomb's Law (and Gauss's Law) may be used to derive this force, but the present disclosure will use the conservation of energy in a parallel plate capacitor for this analysis.

In terms of the normal electric field Eₙ and dielectric constant ∈₀∈ᵣ, the force between two parallel conducting plates is given by:

$${F}_{n} = \frac{1}{2} \cdot {ɛ}_{0} \cdot {ɛ}_{r} \cdot {E}_{n}^{2} \cdot {A}_{n} \qquad ( 8 )$$

Because pressure is defined as force per unit area, the pressure a dielectric inside a parallel plate capacitor would experience is given by:

$$\frac{{F}_{n}}{{A}_{n}} = {P}_{n} = \frac{1}{2} \cdot {ɛ}_{0} \cdot {ɛ}_{r} \cdot {E}_{n}^{2} \qquad ( 9 )$$

In this case, the area of the capacitor does not change if the two plates are moved relative to each other. In the case of hyper elastic dielectrics, which require constant volume, if the plates move closer together, the area must increase (and vice versa), such that the force calculation is changed slightly. This results in a doubling of the force (and pressure) for the same electric field when comparing to the fixed area parallel plate capacitor analysis. In terms of electric field and dielectric constant, the force between two parallel, compliant conducting plates on a hyper elastic dielectric is given by:

Fₙ=∈₀·∈ᵣ·Eₙ²·Aₙ (10)

Since pressure is defined as force per unit area, the pressure a hyper elastic dielectric inside a parallel plate capacitor with compliant electrodes would experience is given by:

$$\frac{{F}_{n}}{{A}_{n}} = {P}_{n} = {ɛ}_{0} \cdot {ɛ}_{r} \cdot {E}_{n}^{2} \qquad ( 11 )$$

This is an important result of electroactive polymer devices as the factor of two improvement gives these devices an advantage over other technologies that rely on other mechanisms to convert electrical energy into mechanical energy and vice versa.

In the preceding analysis (and those that follow), the permittivity of a dielectric has been treated as a linear, isotropic and homogeneous property. If this were not the case, the analysis becomes more complicated.

### Resultant Forces Due to Electrostatic Force

In the case of both actuators and generators, it is important to determine the resultant tangential forces (or pressures) on a hyper elastic dielectric due to the normal electric force (or pressure). Again, the conservation of energy will be used to derive these relationships. Referring back to the hyper elastic cube shown in FIGS. 8A, 8B, the force in the x and y directions due to the applied electrical force in the z direction can be calculated. Using the equation for a parallel plate capacitor, an equation based on the three principal axis of the example can be derived as follows:

$$C ( x , y , z ) = \frac{{ɛ}_{0} \cdot {ɛ}_{y} \cdot x \cdot y}{z} \qquad ( 12 )$$

Using the incompressibility relationship of hyper elastic dielectrics (eq. 12) may be written in terms of x for the pure shear case:

$$\begin{matrix}z = \frac{{x}_{0} \cdot {y}_{0} \cdot {z}_{0}}{x \cdot y} & ( 13 ) \\ C ( x ) = \frac{{ɛ}_{0} \cdot {ɛ}_{y} \cdot {x}^{2} \cdot {y}^{2}}{{x}_{0} \cdot {y}_{0} \cdot {z}_{0}} & ( 14 )\end{matrix}$$

Differentiating C(x) with respect to x and substituting into the force equation gives the force in the x direction for an applied voltage (electric field in the z direction).

$$F ( x ) = \frac{1}{2} \cdot {V}^{2} \cdot \frac{\partial C ( x )}{\partial x} = {V}^{2} \cdot \frac{{ɛ}_{0} \cdot {ɛ}_{y} \cdot x \cdot {y}^{2}}{{x}_{0} \cdot {y}_{0} \cdot {z}_{0}} \qquad ( 15 )$$

This method of calculating resultant forces may be used to analyze many different types of actuator and generator geometries. In the following section, the electrical energy stored in the electric field and the mechanical energy stored in the elastic material will be brought together to develop the analysis of both the dielectric elastomer actuator and generator.

### Calculating the Equilibrium Position (The Fine Line Between Actuator and Generator)

Using the case of pure shear, an example of calculating equilibrium positions can be constructed. The equilibrium position is where the electrical force is balanced by the mechanical elastic force. This will also be the position of minimal system energy. Referring back to the Neo Hookean hyper elastic strain energy model (eq. 7), the specific case for planar tension (assuming no prestrain conditions) can be written as follows:

$${W}_{ELASTIC} ( x ) = \{ {x}_{0} \cdot {y}_{0} \cdot {z}_{0} \} \cdot \frac{{μ}_{1}}{{α}_{1}} \cdot [ {( \frac{x + {x}_{0}}{{x}_{0}} )}^{{α}_{1}} + {( \frac{{y}_{0}}{{y}_{0}} )}^{{α}_{1}} + {( \frac{{x}_{0} \cdot {y}_{0}}{{y}_{0} \cdot ( x + {x}_{0} )} )}^{{α}_{1}} - 3 ] \qquad ( 16 )$$

Differentiating the strain energy function with respect to x gives the force in the x direction. The simplified expression for force is given by:

$${F}_{ELASTIC} ( x ) = \{ {x}_{0} \cdot {y}_{0} \cdot {z}_{0} \} \cdot \frac{{μ}_{1}}{( x + {x}_{0} )} \cdot [ {( \frac{x + {x}_{0}}{{x}_{0}} )}^{{α}_{1}} - {( \frac{{x}_{0}}{( x + {x}_{0} )} )}^{{α}_{1}} ] \qquad ( 17 )$$

The elastic force wants to return the elastic material back to its original shape and the electrical force wants to squeeze the elastic material. The equilibrium point is when these two forces sum to zero is:

F_{ELASTIC}(x)+F_{ELECTRIC}(x,V)=0 (18)

Unfortunately, this relationship has no closed form solution when solving for x, it can however, be solved for V. Rearranging and solving for V provides:

$$V ( x ) = \pm \frac{{x}_{0} \cdot {z}_{0}}{{ɛ}_{0} \cdot {ɛ}_{y}} \cdot \sqrt{\frac{x \cdot {ɛ}_{0} \cdot {ɛ}_{r} \cdot {μ}_{1}}{( x + {x}_{0} )} \cdot [ {[ \frac{( x + {x}_{0} )}{{x}_{0}} ]}^{{α}_{1}} - {[ \frac{{x}_{0}}{( x + {x}_{0} )} ]}^{{α}_{1}} ]} \qquad ( 19 )$$

This is the required applied voltage for any desired static position of x. The dynamic case will be considered hereinbelow. This technique may be used to calculate the equilibrium position of any number of geometrical configurations. The choice of using voltage in the analysis instead of electric field, as is commonly done, provides a real world quantity rather than a purely theoretical one. When using a dielectric elastomer as a mechanical to electrical energy converter care must be taken to insure the operating space of the generator does not cross over into the actuator condition and result in loss of tension.

It may be instructive at this point to provide a typical analysis showing the maximum conversion of electrical energy into mechanical energy in a dielectric elastomer actuator.

This will be a simple theoretical analysis but it will allow a basic understanding of the electrical to mechanical conversion process. The mechanical to electrical conversion process will be presented in the following section.

A typical linear mechanical actuator may be characterized by blocked force and free stroke. If the actuator is linear, the maximum work output of the actuator is one fourth of the product of the blocked force and the free stroke.

### The Conservation of Charge Energy Conversion Model

As previously discussed in connection with FIGS. 3A-3B and 4A-4F, there are three mechanical to electrical energy conversion processes that are instructive to understanding the basics of electroactive polymer (dielectric elastomer) generators. These three cases all involve a simple four-step process. The first step starts with a relaxed dielectric elastomer and uses mechanical energy to stretch the elastomer to some stretched state. The second step is to add electrical charge to the electroactive polymer electrodes. The third step is to mechanically relax the elastomer thereby converting the mechanical elastic energy into electrostatic energy and the fourth step is to remove the electrical energy from the electroactive generator thus “harvesting” electrical energy from the mechanical to electrical conversion.

During the second and third steps, the designer can choose between constant charge, constant electric field or constant voltage. Each of these methods requires different control circuit topologies. One of the simpler topologies to implement is the constant charge method and its cycle will be described in detail below.

For this analysis, a fixed stroke and fixed frequency system will be considered. Although variable stroke and variable frequency systems are not described, such systems are within the scope of the present disclosure. In addition, some typical values of parameters will be used to demonstrate practical electroactive polymer generator cycles. For example, an electroactive polymer generator one meter by one meter and one hundred microns thick in the relaxed state will be considered in the analysis and fully compliant and conducting electrodes will be assumed. Using the following set of parameters (∈₀=8.854 pF/m, ∈ᵣ=5.0, μ₁=0.3 MPa, α₁=2, λₘₐₓ=2.0 and Vₘₐₓ=5 kV), a typical cycle may be constructed. The analysis will be presented in graphical form on energy versus stretch plane. This illustrative approach enables visualization of the concept of energy balance.

During the first portion of the cycle, the electroactive generator is stretched from 1 to λₘₐₓ, storing elastic energy in the electroactive polymer film. Next, an electrical charge (V_{seed}) is applied to the electroactive generator. Its voltage value depends on the maximum stretch as follows: V_{seed}=Vₘₐₓ/(λₘₐₓ)² (note: this value only applies to the shear mode analysis). As electrical energy is applied, it is added to the elastic energy stored in the electroactive polymer film. At this point, the electrical charge seed source is disconnected from the generator and no charge is allowed to enter or leave the generator electrodes (hence the constant charge cycle). The electroactive generator is then allowed to relax back to the equilibrium condition converting the elastic energy into electrical energy. Finally, the electrical energy is removed from the generator and the cycle would be repeated again.

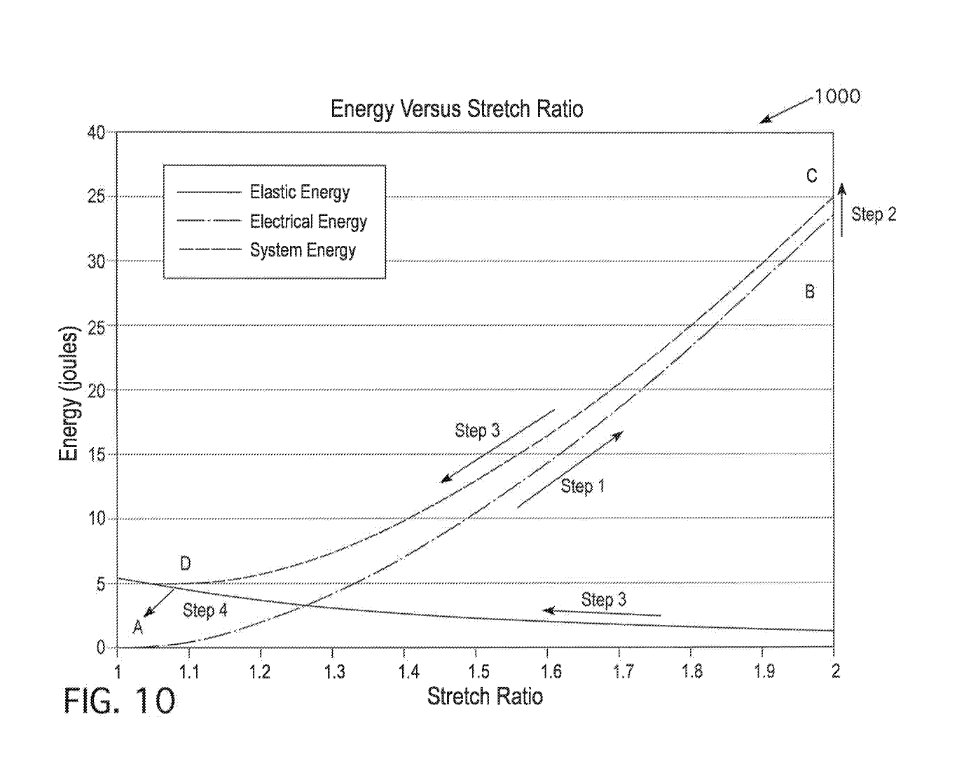

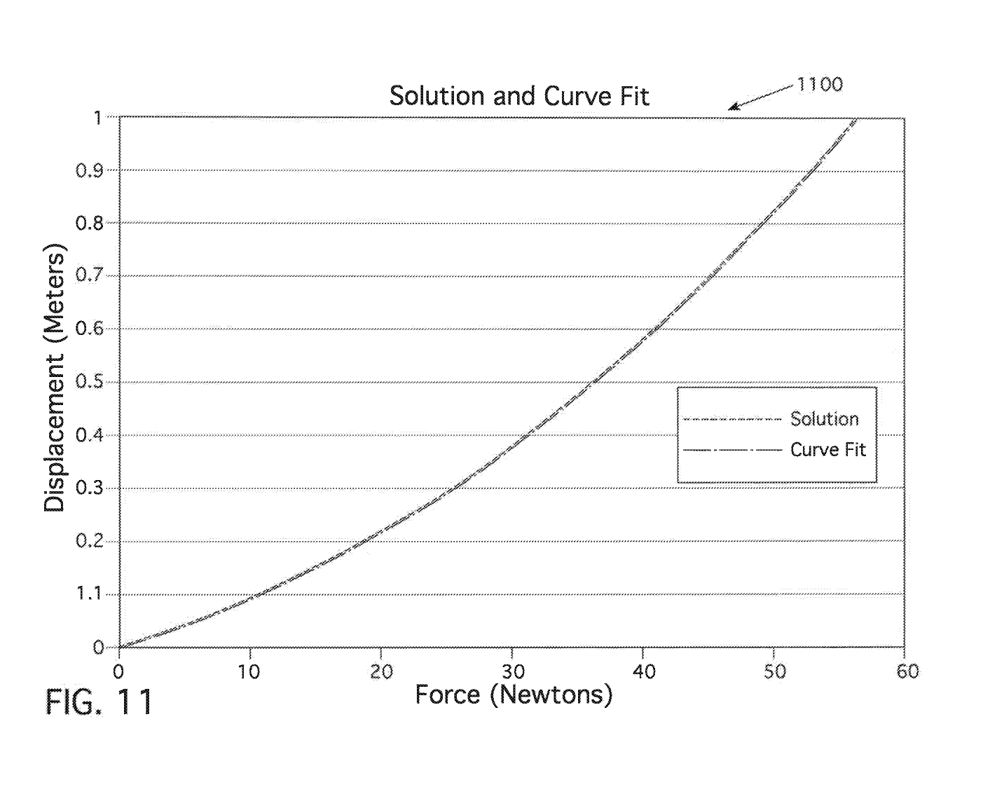

FIG. 10 is a graphical representation 1000 of energy versus stretch ratio of a constant charge cycle in an electroactive polymer generator. The vertical axis corresponds to Energy (Joules) and the horizontal axis corresponds to Stretch Ratio. The detailed description of the process is aided by the curves presented in FIG. 10. The elastic energy has already been presented in equation (17) (this is step 1 moving from point A to point B). An external mechanical source is used to stretch the elastic generator storing elastic energy in the dielectric elastomer film. An electrical charge is added based on the seed voltage defined in the previous paragraph (this is step 2 moving from point B to point C). At this point, the external mechanical source will start relaxing the dielectric elastomer to return it back to the relaxed position. If no electrical charge is applied on the generator then all of the energy the external mechanical source put into the generator would be returned back to the external mechanical source. With electrical charge on the generator, some of the elastic energy is converted into electrical energy and some is returned back to the external mechanical source. During step 3 the electroactive polymer generator will return back to the equilibrium position D (where the system energy reaches a minimum). The electrical energy may now be removed for an overall electrical energy gain in the system (step 4, point D to point A).

This basic constant charge cycle energy converter is the basis for the energy density calculation. This analysis has not included system losses and determines the energy per cycle under ideal conditions. Also, it should be noted that the large elastic energy that must be applied into the dielectric elastomer prior to adding any electrical seed energy should be considered carefully. In this example, the ratio of mechanical elastic energy to electrical energy is approximately 10:1 and has a significant system effect. If the modulus of the dielectric material is selected to be ten times greater, the ratio of elastic to electrical energy becomes 100 fold. This results in a very lopsided system and should be avoided. Such a large ratio presents significant cost, since mechanical structures (tethers, frames, etc.) must be built to handle this mechanical energy.

### Losses Due to Leakage Currents in the Dielectric

Referring back to the constant charge cycle described in reference to FIG. 10, it is assumed that no charge enters or leaves the electroactive polymer generator. If charge is allowed to move from one electrode to the other through the dielectric material, the constant charge cycle is no longer valid and the transfer of charge results in a significant energy loss. If this loss is too high, the electroactive polymer generator does not produce electrical energy and merely heats up the dielectric material. The undesired transfer of charge from one electrode to the other during a generation cycle is typically referred to as leakage current. The overall system sensitivity to leakage current depends on a number of different parameters. One of the more important parameters is cycle time and higher leakage current may be tolerated at higher mechanical frequencies.

### A PSPICE Based Nonlinear Electromechanical Energy Converter

The subjects of electro-mechanical system modeling and nonlinear component modeling are complex in themselves. For electroactive polymer generators, these two subjects are combined to produce an accurate system model using both linear systems modeling and electro-mechanical component modeling.

To properly model a basic electroactive polymer generator, a non-linear mechanical spring model and a non-linear capacitor model are needed. These models must also be coupled both electrical-to-mechanical and mechanical-to-electrical (i.e., full bidirectional coupling) to provide the necessary input and output variables in the model. For this section, the model of a pure-shear mode electroactive polymer generator is developed.

A linear mechanical spring may be modeled using the familiar Hooke's law and the relationship between force and stroke (in the time domain) is typically given by:

f(t)=k_{spring}·x(t)=k_{spring}·∫u(t)·dr (20)

Differentiating with respect to time, the velocity across a spring is given by:

$$u ( t ) = \frac{1}{{k}_{spring}} \cdot \frac{d f ( t )}{d t} = {C}_{m} ( t ) \cdot \frac{d f ( t )}{d t} \qquad ( 21 )$$

Where the compliance (Cₘ) is used instead of the spring constant. If the compliance is time varying, then equation (21) needs to be written to include both terms and using the chain rule:

$$u ( t ) = \frac{d}{d t} [ {C}_{m} ( t ) \cdot f ( t ) ] = f ( t ) \cdot \frac{d {C}_{m} ( t )}{d t} + {C}_{m} ( t ) \cdot \frac{d f ( t )}{d t} \qquad ( 22 )$$

In the case where the compliance is time invariant and strictly a function of force, equation (22) may be written as:

$$\begin{matrix}u ( f \cdot t ) = \frac{d }{d t} [ {C}_{m} ( f ) \cdot f ( t ) ] \\ = f ( t ) \cdot \frac{d {C}_{m} ( f )}{d f} \cdot \frac{d f ( t )}{d t} + {C}_{m} ( f ) \cdot \frac{d f ( t )}{d t}\end{matrix} \qquad ( 23 )$$

Using equation (17), a relation between force and displacement has already been derived for the pure-shear mode electroactive polymer generator. In this particular case, an analytical solution of displacement as a function of force does not exist. FIG. 11 is a graphical representation 1100 of pure-shear mode generator stroke-force relation and curve fit. The vertical axis corresponds to Displacement (Meters) and the horizontal axis corresponds to Force (Newtons). The slope of displacement versus force line is the compliance of the electroactive polymer generator Cₘ(f). By curve fitting this line (using a third order polynomial), an expression for the relationship between displacement and force may be generated and the compliance may be written as:

x(f)=Cₘ(f)·f=a·f+b·f²+c·f³ (24)

Dividing x(f) by f gives the curve fit expression for Cₘ(f):

Cₘ(f)=a+b·f+c·f² (25)

Differentiating with respect to f, the first derivative of Cₘ(f) is given by:

Cₘ′(f)=b+2·c·f (26)

Substituting these expressions into equation (23), the non-linear compliance model of a pure-shear electroactive polymer generator may be written as:

n(t)=f(t)·(b+2·c·f)·f′(t)+(a+b·f+c·f²)·f′(t) (27)

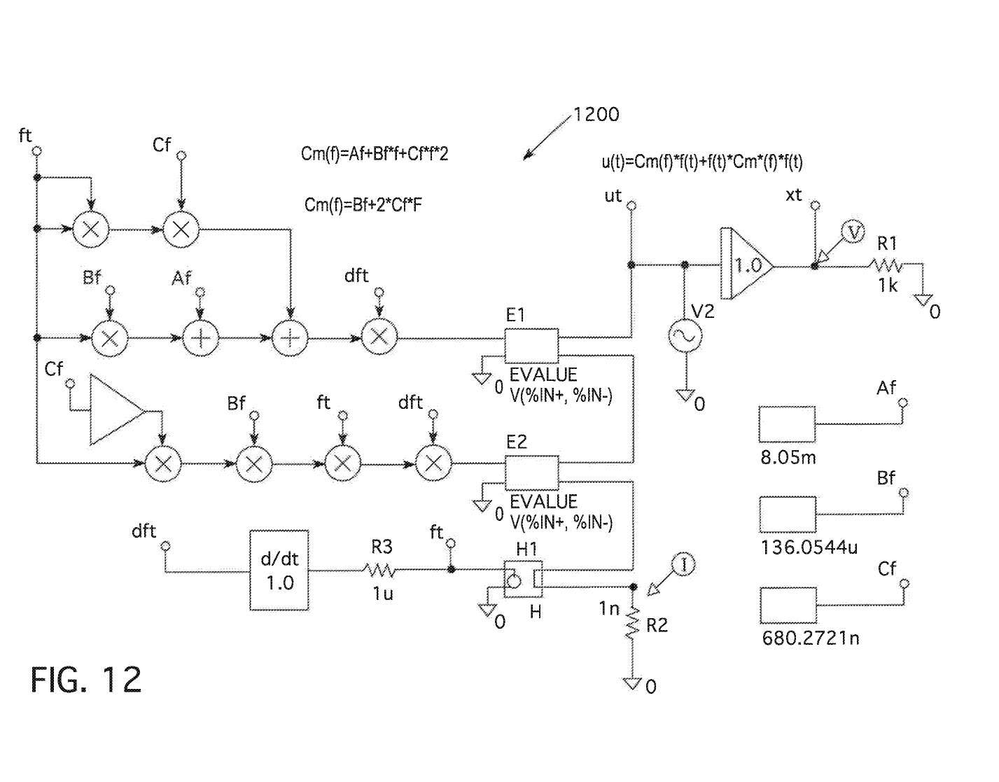

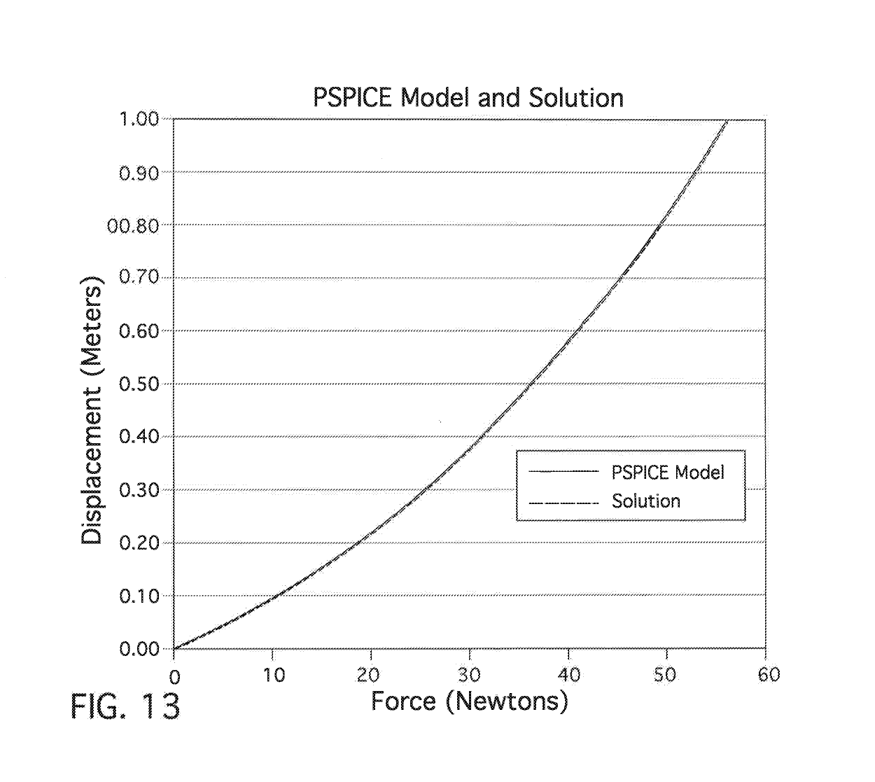

This relationship may be implemented into PSPICE by using a mobility analogy, where velocities are represented by voltages and forces are represented by currents. In the case of a linear spring (i.e., compliance is constant), compliance is represented by a linear inductor. The non-linear compliance is represented by a non-linear inductor and is implemented by a complete model based on equation (27). This model is shown in FIG. 12, which illustrates a PSPICE model 1200 for mechanical nonlinear pure-shear electroactive polymer generator. Using the parameters developed above in the section describing the conservation of charge energy conversion model, a simulation similar to that presented in FIG. 11 may be produced showing the model agrees as shown in FIG. 13, which is a graphical representation 1300 of the PSSPICE modeling results of displacement versus force, where the vertical axis corresponds to Displacement (Meters) and the horizontal axis corresponds to Force (Newtons).

The next element that needs to be developed is the nonlinear capacitor model. The relationship of capacitance to displacement has already been given in equation (14). Using this relationship, the nonlinear circuit model of a capacitor is given by:

$$\begin{matrix}i ( t ) = \frac{d }{d t} ( C ( t ) \cdot V ( t ) ) \\ = C ( t ) \cdot \frac{d }{d t} ( V ( t ) ) + V ( t ) \cdot \frac{d }{d t} ( C ( t ) )\end{matrix} \qquad ( 28 )$$

For the case of capacitance being time invariant and only a function of displacement, the above expression may be written as:

$$i ( x \cdot t ) = C ( x ) \cdot \frac{d v ( t )}{d t} + v ( t ) \cdot \frac{d C ( x )}{d x} \cdot \frac{d x ( t )}{d t} \qquad ( 29 )$$

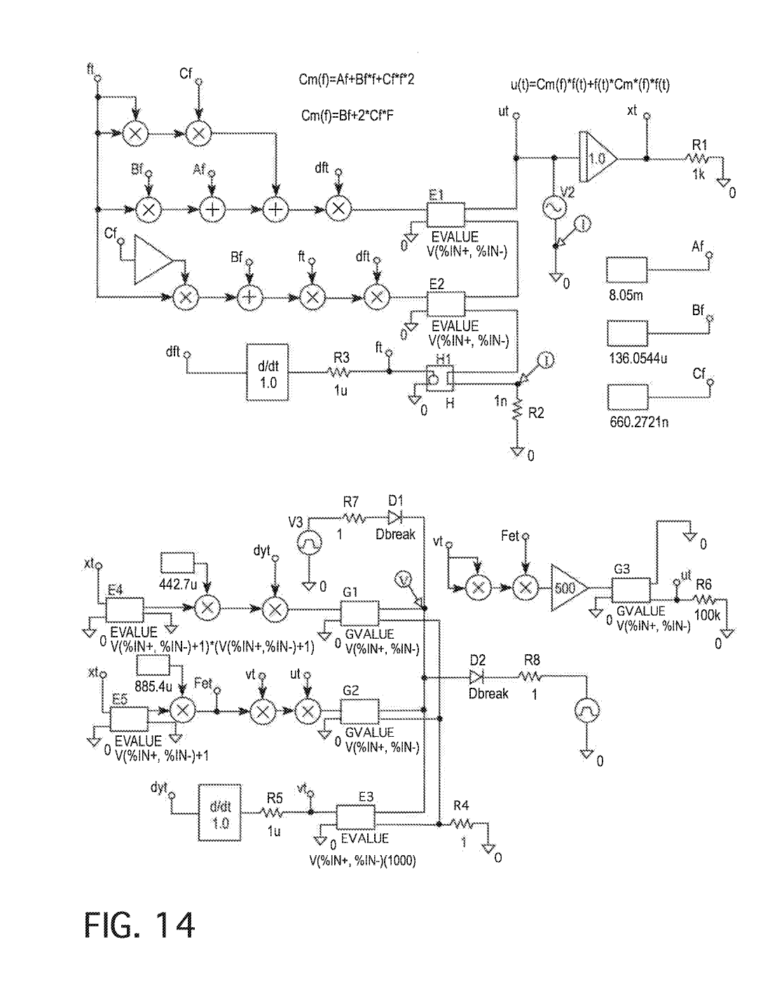

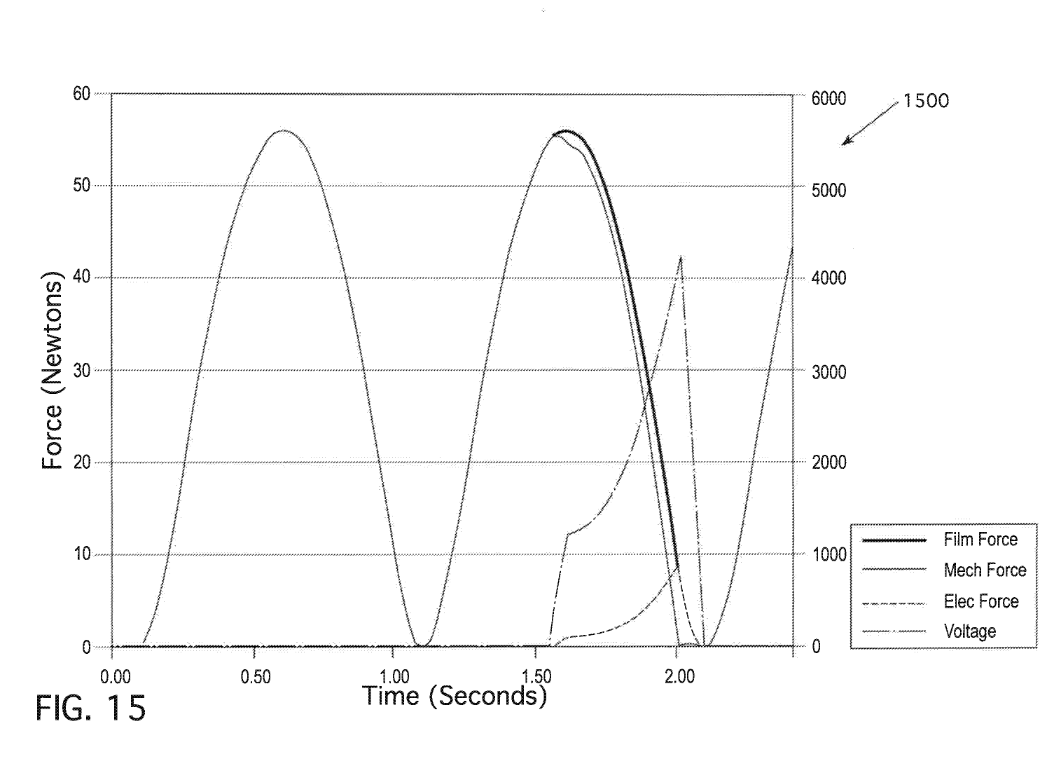

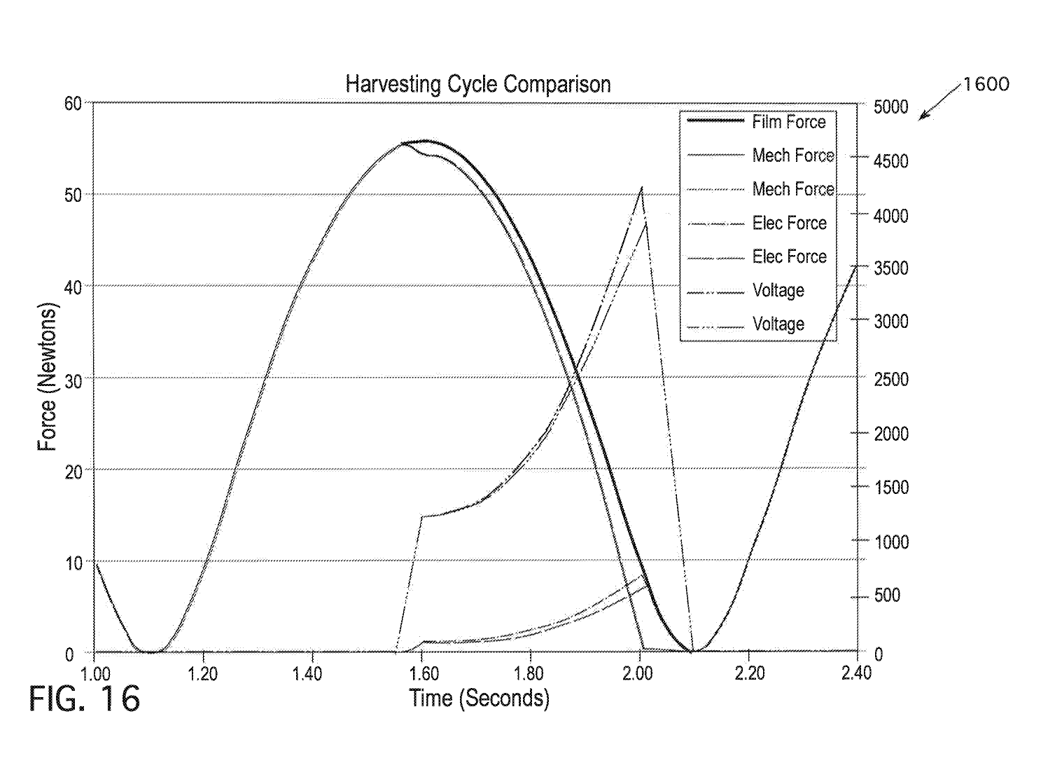

FIG. 14 is a coupled PSPICE model 1400 of a nonlinear capacitor coupled to a nonlinear spring model. To couple these two models, the mechanical model determines the instantaneous value of displacement x and the electrical model determines the instantaneous value of electrical force (due to the electrostatic pressure). To simulate the energy harvesting cycle analyzed in the calculating equilibrium position section above, an electrical charge is added at the maximum stroke and then is removed just before the minimum stroke (to prevent loss-of tension of the generator). FIG. 15 is a graphical representation 1500 of energy harvesting simulation. The vertical axis corresponds to Force (Newtons) and the horizontal axis corresponds to Time (Seconds). In the harvest cycle shown in FIG. 15, there is no harvesting during the first cycle, and harvesting in the second cycle.

Accordingly, nonlinear damping terms and leakage current terms may now be added in the PSPICE model. As an example, if the leakage current of the dielectric is determined by the following equation:

I_{Leakage}=I₀−V_{Actuator}² (30)

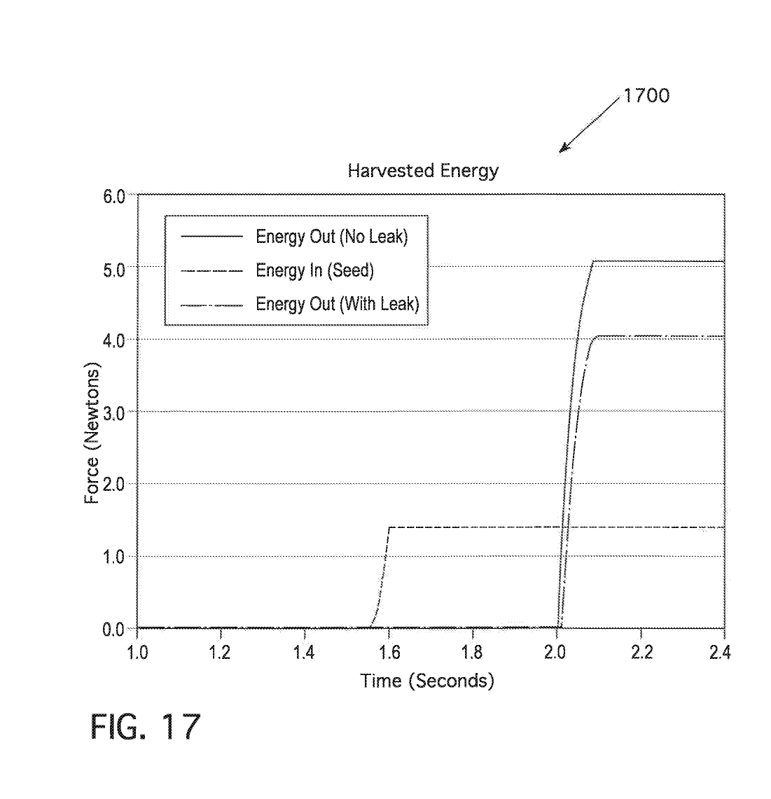

Adding this to the model allows an energy harvesting cycle to be calculated including nonlinear leakage current. A comparison of results is shown in FIGS. 16 and 17, where FIG. 16 is a graphical representation of an energy harvesting cycle ideal versus non-ideal (leakage current) and FIG. 17 is a graphical representation of recovered electrical energy for ideal and non-ideal cycle. In FIG. 16, the vertical axis corresponds to Force (Newtons) and the horizontal axis corresponds to Time (Seconds). In FIG. 17, the vertical axis corresponds to Energy (Joules) and the horizontal axis corresponds to Time (Seconds). The ideal case shows a harvested energy of 5 joules per cycle and this is reduced to 4 joules per cycle when the leakage current is accounted for (I₀=100 pA/V²).

An example of a bidirectional model of a shear-mode DE generator has been developed. The techniques and methods used should apply to most types of DE generators. By implementing models in PSPICE, the important effects of voltage dependent leakage current and non-ideal electrode resistance can be easily included. More importantly, adding high voltage power electronics now becomes feasible.

### An Energy Harvester Example

The following model represents one embodiment of an electroactive polymer generator referred to as a 60 watt rotator that is based on a 60 RPM wind turbine. The generator provides 10 joule/cycle.

100% linear strain (10% equibiaxial prestrain)

1 MPa elastic material obeying Neohookean hyper elastic behavior

Eᵣ=3 and electrode at 1 ohm per square

E_{bd}=100 V/μm Eₒₚ=60 V/μm max

100 um initial film thickness

Cycle capacitance (constant charge cycle)

Start 1 m²=>100 cm³

4 cycle 1.1 m×1.1 m×82.64 μm Vₘₐₓ=4959 V

1 cycle 1.1 m×2.0 m×45.45 μm

4 cycle capacitance=389 nF

1 cycle capacitance=1.286 μF XC=3.306

V_{seed}=4959 V/3.306=1500 V E_{seed}=1.447 J

V_{final}=4959 V E_{final}=4.783 J delta=3.336 J

Need 3 m²=>300 cm³

Energy per cm³=0.0333 J/cm³˜0.03 μg

### High Efficiency Energy Transfer Circuits for Electroactive Polymer Generators

Electroactive polymer generators (e.g., EAP generators or dielectric elastomer [DP] generators) may have a variety of operational configurations. In one embodiment, the control electronics account for these configurations. From the mechanical input power perspective, the input can range from fixed-stroke, fixed-frequency (example hydro river flow) to variable-stroke, variable-frequency (wave energy). There are also different conversion cycles, constant-charge, constant-field and constant-voltage (and subsets of these by not operating at maximum energy per cycle). Each application will have an optimum set of control requirements. Some example applications are:

1. River Source with No Seasonal Changes and Tied to the Grid.

Here the goal is to produce the most power continuously and have the utility company pay you for the power produced. The flow to mechanical power may be a Pelton wheel or other similar efficient converter (assuming the river head is sufficient; low river head sources require a different type of converter). In one embodiment, the electroactive polymer generator would be designed to handle the continuous power of the source and constantly drive power into the grid (considered an infinite load for this case). Here, the system design would be fixed-frequency and fixed-stroke giving the simplest control needed. The control system would operate at maximum power and only shut down in the event of a fault (either internal generator fault or external system fault, i.e. water source became clogged with debris, utility grid was not functioning due to a lightning strike, etc.).

### 2. Wave Source Tied to an Energy Storage Device

(possibly combined with solar and wind and backup diesel generator), for example for powering a remote fishing vacation resort. Here, the input mechanical power varies both in frequency and stroke. The load varies from minimum to maximum. In this case, the control system must adapt to the complex set of source and load requirements and optimize accordingly. In addition, fault conditions and excessive conditions must be considered and controlled, for example, if a storm produces waves in excess of the design maximums, the system would need to shut down in the safest configuration.

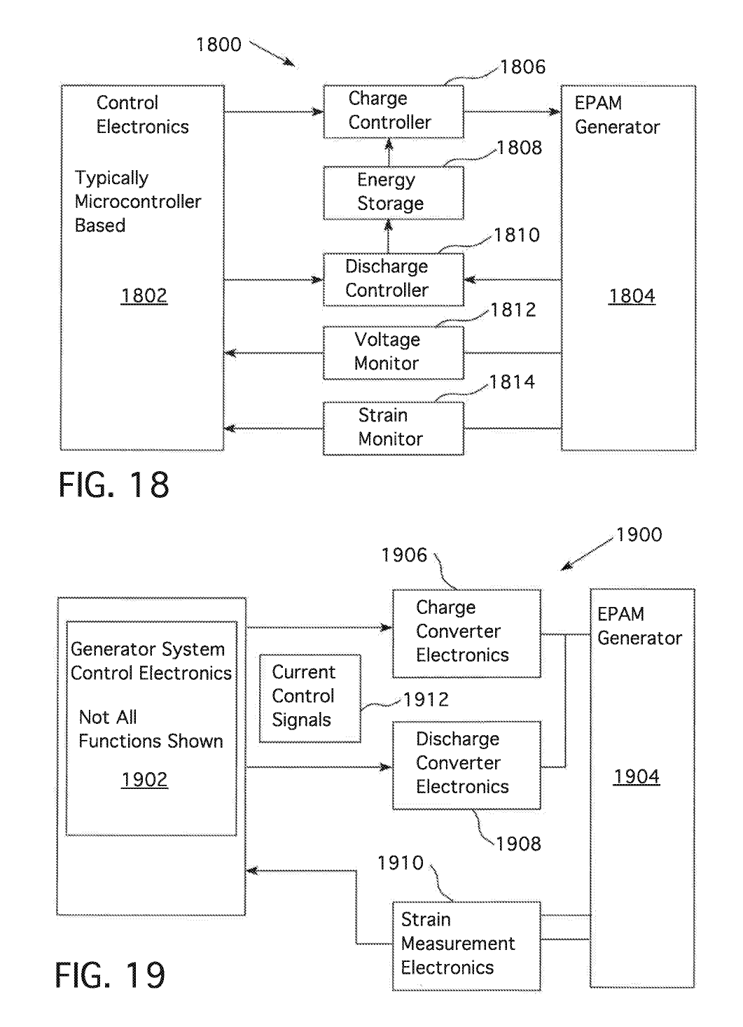

FIG. 18 is a block diagram of one embodiment of electroactive polymer generator energy harvesting control system 1800 utilizing microcontroller electronics 1802. In one embodiment, the control system 1800 optimizes and maximizes the performance of the electroactive polymer generators 1804 over a wide variety of operating conditions. The control system 1800 also may be employed to control electroactive polymer type damper systems, for example. In one embodiment, the control system 1800 maximizes the energy density of the electroactive polymer generator 1804. Complex control can improve the energy density of the electroactive polymer generator 1804 over an order of magnitude. The high efficiency energy transfer circuit controls a complex process of input output control variables to maximize the performance of the electroactive polymer generator 1804.

In one embodiment, an electroactive polymer generator 1804 uses mechanical input power and converts it into electrical output power. In one general embodiment, a basic electroactive polymer generator cycle comprises straining the electroactive polymer element of the generator 1804 thereby converting mechanical input into elastic strain energy, adding a small amount of electrical charge to “seed” the generator, relaxing the elastic strain converting the mechanical energy into electrical energy, and finally completing the cycle by removing the electrical energy. The mechanical input power to an electroactive polymer generator 1804 may range from fixed stroke, fixed frequency (water turbine, for example) to variable stroke, variable frequency (wave power, for example). The optimum cycle in each of the cases may be consistent (as in the water turbine case) or continuously changing (as in the wave power case). To adapt to these changes, the electroactive polymer generator control system evaluates input variables and modifies output control to optimize performance. The minimum input variables for the control system are generator strain and generator voltage. The minimum output control variables are generator charge rate and generator discharge rate. The control system uses these control variables and a predefined set of rules to optimize the performance of the electroactive polymer generator.

In the embodiment illustrated in FIG. 18, the control system 1800 comprises a controller 1802, which may comprise a microprocessor or microcontroller circuit. The controller 1802 is coupled to a charge controller 1806, a discharge controller 1801, and an energy storage element 1808 to control the charge rate and the discharge rate of the generator 1804. Generator feedback variables from a voltage monitor 1812 and a strain monitor 1814 are provided to the controller 1802.

In one embodiment, the charge controller 1806 is a high-voltage, high-power circuit suitable for charging a capacitance with a defined amount of charge (and hence energy). Two suitable topologies are the energy regulated charge circuit (as described in U.S. Pat. No. 6,359,420, which is incorporated herein by reference) or a constant current converter (flyback, forward, etc.). Because most electroactive polymer generators will have to trade off electrode resistance for cost and performance, it is expected that the equivalent series resistance of electroactive polymer generator 1804 will be relatively high. To minimize ohmic heating losses during charge (and discharge) the lowest amount of current for the longest time should be used (for a given amount of charge). The charge controller 1806 removes energy from the energy storage element 1808 and transfers it to the dielectric elastomer film of the electroactive polymer generator 1804 at the maximum strain of a cycle. Depending on the type of overall system, the charge, the energy or the voltage is controlled (possibly combinations in complex systems).

In one embodiment, the configuration of the energy storage element 1808 will depend on the requirements of the control system 1800. It can be a capacitor bank (utility grid tie cases, for example) or a battery bank (off grid remote sites) or some combination. The main purpose of the energy storage element 1808 is to provide the initial seed electrical energy to charge the electroactive polymer generator 1804 at the start of each mechanical cycle.

Similar to the charge controller 1806, in one embodiment, the discharge controller 1810 is responsible for removing electrical energy from the electroactive polymer generator 1804 when the mechanical cycle has reached the minimum strain. In one embodiment, a flyback converter may be the most versatile because it can be controlled for all three types of conversion cycles (constant charge, constant voltage, and constant field). Other converter topologies may also be used. In most cases, it is desirable to have zero voltage (and zero charge) on the electroactive polymer generator 1804 during the stretching phase of the mechanical cycle to maximize the amount of mechanical energy put into the elastomer. The control system 1800 electronics determine when the discharge controller 1810 removes the energy from the electroactive polymer generator 1804.

In one embodiment, the voltage monitor 1812 is a very high impedance voltage divider used to determine the voltage on the electroactive polymer generator 1804. Bandwidth should be at least DC to 1 kHz and impedance should be high to keep losses below 1% of the typical conversion cycle, preferably less than 0.1%.

In one embodiment, the strain monitor 1814, whether fixed stroke or variable stroke, provides the strain condition of the electroactive polymer generator 1804 to the controller 1802. For fixed stroke systems, this can easily be a shaft encoder but for variable stroke systems this may need to be a small section within the electroactive polymer generator 1804 used to monitor capacitance with the assumption that the small section represents the entire electroactive polymer generator 1804 strain. In simple systems, the maximum strain would initiate the electrical charge cycle of the system and the minimum strain would initiate the electrical discharge cycle of the system. For variable stroke systems, the strain monitor 1814 can be used to determine when to start conversion cycles and when not to. For example, if the waves are not large enough and the electroactive polymer generator 1804 may is only straining 10-20%, the control system 1800 would decide not to do anything, later, once a 50% strain might be occurring, the controller 1802 starts up the conversion process.

As discussed above, electroactive polymer based energy harvesting generators may have high electrode resistance unlike conventional generators that employ highly conductive electrodes (or conductors) to minimize loss. For example, rotary electromagnetic generators use copper or aluminum wire for conductors because there is no need for a compliant conductor. The high electrode resistance of electroactive polymer generators is typically due to the additional electrode requirement of mechanical compliance. The electrode must be electrically conductive while simultaneously being compliant, and therefore, establishes an electrode design tradeoff between electrical conductivity and mechanical compliance. A highly conductive electrode (silver, for example) is very stiff and does not allow much mechanical movement. Less conductive electrodes (printed conductive inks, for example), on the other hand, are compliant and allow mechanical movement but are resistive and result in electrical losses when trying to charge or discharge an electroactive polymer generator.

The simplified electronic circuit described in connection with FIG. 8, minimizes electrode losses by operating at low electrode currents. Such simplified electroactive polymer generator electronics, though configured for high electrode resistance, do not optimize the full mechanical-to-electrical conversion capabilities and result in much lower specific energy densities compared to optimize converter electronics, which are typically 0.04-0.06 joules per gram for simple electronics versus 0.4-0.6 joules per gram for complex electronics.

FIG. 19 is a block diagram of one embodiment of a high efficiency energy transfer circuit 1900 for an electroactive polymer generator 1904. In FIG. 19, the high efficiency energy transfer circuit 1900 comprises control electronics 1902 coupled to an electroactive polymer generator 1904 via charge converter electronics 1906 and discharge converter electronics 1908. Current control signals 1912 are used to control the charge converter electronics 1906 and the discharge converter electronics 1908. Strain measurement electronics 1910 are coupled to the electroactive polymer generator 1904 and provide signals to the control electronics 1902. One advantage of such configuration is that electrical losses in the electroactive polymer generator 1904 are controlled and thus maximizing the overall conversion efficiency and performance.

In one embodiment, the electroactive polymer generator 1904 described herein employs controlled charge transfer to minimize electrode losses when either charging or discharging the generator 1904. In various embodiments, several methods of controlling charge transfer may be implemented. For example, synchronous parallel converters may be employed for charging in the charge converter electronics 1906 and continuous buck converters may be employed for discharging in the discharge converter electronics 1908. In one embodiment, the electronics and logic in the charge and discharge converter electronics 1906, 1908 are employed to limit the charge or discharge current to a level that reduces electrode losses to acceptable levels. This method provides for an unexpected change of electrode resistance and limits its impact on the operating conditions of the electrical system. Both the capacitance of the generator 1904 and the equivalent electrode resistance of the generator 1904 vary with mechanical strain. To control the electrical losses during charging and discharging of the electroactive polymer generator 1904 the current is limited according to the following criteria:

$${I}_{MAX} = \frac{Δ V \times \% LOSS}{2 \times {R}_{ELECTRODE} ( strain )} \qquad ( 31 )$$

In accordance with one embodiment, electroactive polymer generators with high electrode resistance charge and discharge currents are controlled dependent on electrode resistances or excessive losses will result in poor overall generator efficiencies.

### Multi-Phase Balanced Electroactive Polymer Generator

Having described several embodiments of electroactive polymer generators and components thereof in a general manner, the present disclosure now turns to one embodiment of an electroactive polymer generator with a mechanical-to-electrical conversion efficiency that is greater than approximately 30%. In some embodiments, efficiencies greater than approximately 80% can be achieved using the techniques according to the various embodiments. For example, in one embodiment, mechanical-to-electrical reactive power efficiency can exceed 80% by configuring single elements of electroactive generators in multiple arrays. Such configurations of electroactive polymer generators may be referred to as, for example, multi-phase generators. Although the basic concept of multi-phase (poly-phase) power conversion is the basis for modern three-phase electrical power distribution systems, the concept has not been applied to electroactive polymer generators as described hereinbelow. Although electroactive polymer generators have been described, there has been no disclosure of poly-phase electroactive polymer generators. In particular, electroactive polymer generators have a minimum requirement of six phases because electrical power is generated only on one half cycle, but not in both directions like electromagnetic generators. Hence, the optimum number of phases for electromagnetic generators is three and the optimum number of phases for electroactive polymer generators is six. The embodiments, however, are not limited in this context and generators with two or more phases are contemplated to be within the scope of this disclosure.

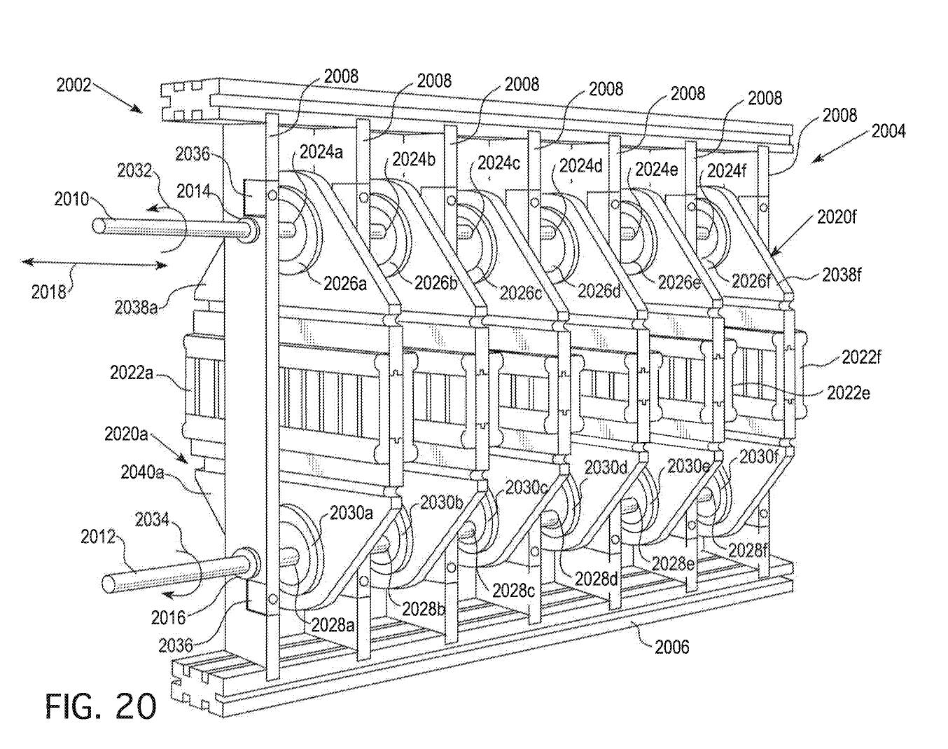

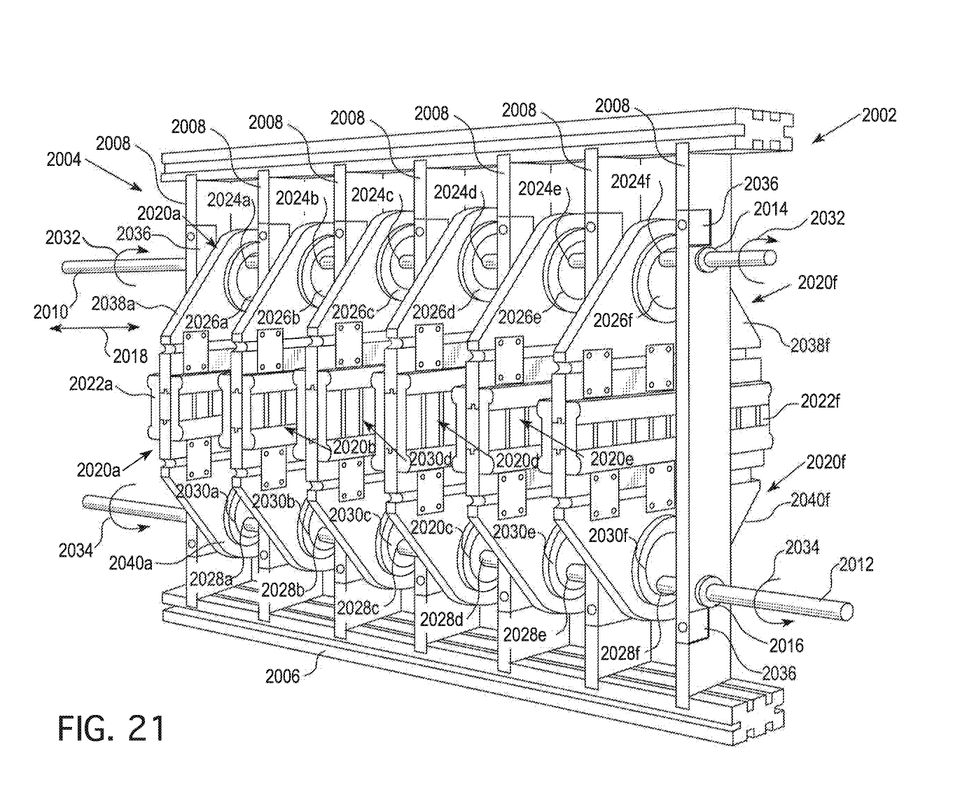

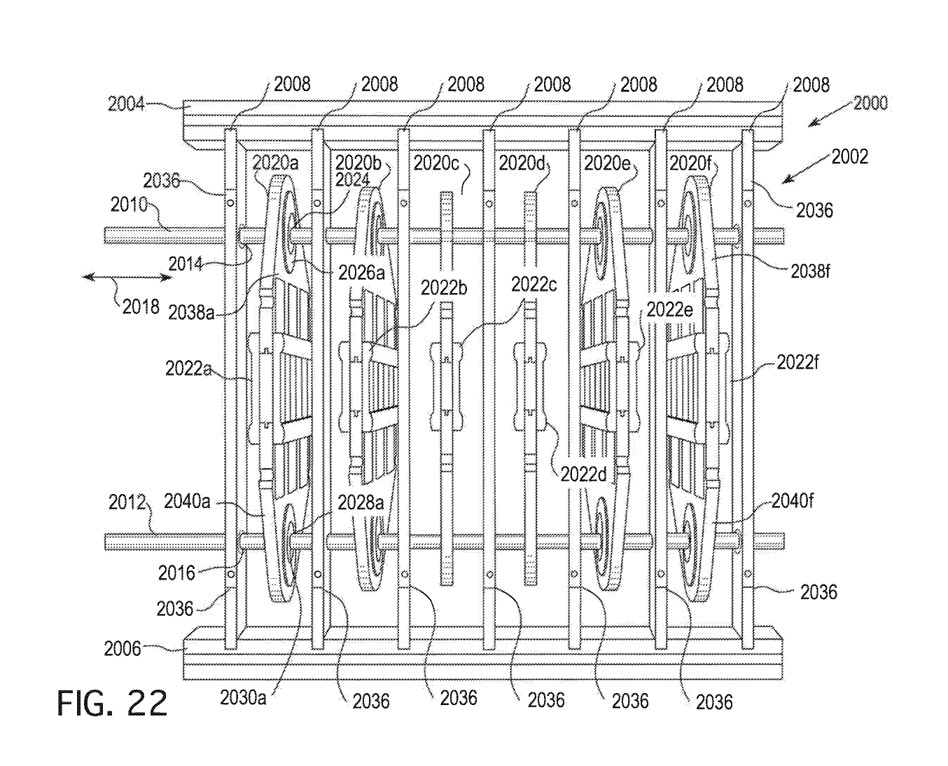

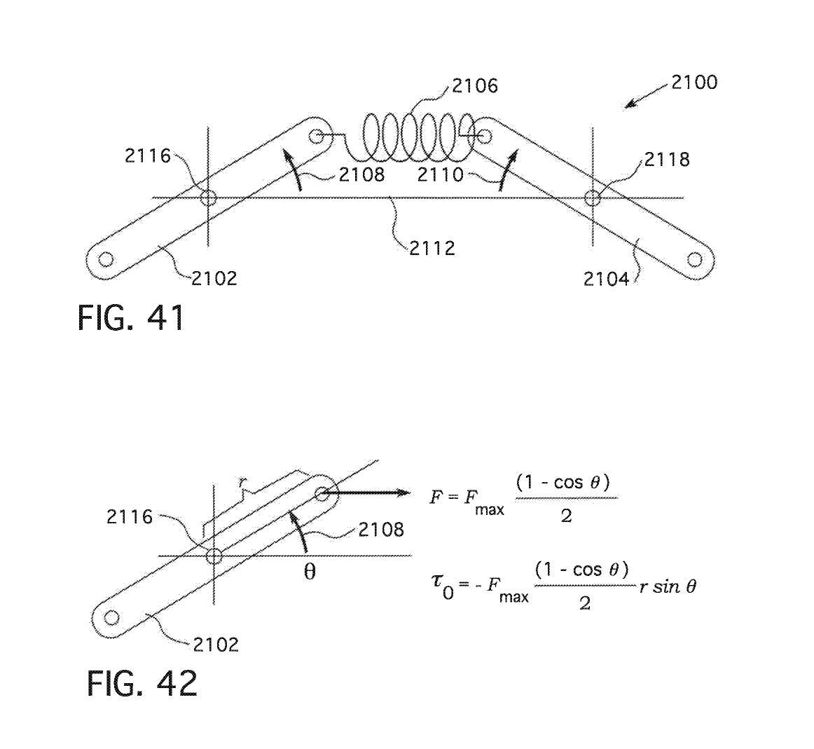

FIGS. 20 and 21 are perspective views of one embodiment of a six-phase electroactive polymer generator 2000 and FIG. 22 is a side view of the generator 2000. With reference to FIGS. 20-22, the six-phase electroactive polymer generator 2000 comprises a frame 2002 that includes a top keel 2004 and a bottom keel 2006 and a plurality of struts 2008 disposed vertically therebetween, where the struts 2008 are connected to the top and bottom keels 2004, 2006. The vertical struts 2008 including tensioning features 2036 and top and bottom bearings 2014, 2016 to receive respective top and bottom shafts 2010, 2012. The shafts 2010, 2012 extend longitudinally 2018 through each strut 2008. The shafts 2010, 2012 support and are rotatably coupled to six generator elements 2020a-f where each of the generator elements 2020a-f include at least one linear electroactive polymer transducer such as the dielectric elastomer generator (DEG) module 2022a-f. The module 2022a-f is made of stretchable electroactive polymer material, and specifically is made of dielectric elastomer, and converts mechanical work into electrical charge when it is stretched, seeded with a bias voltage, relaxed, and discharged, as discussed above. Each of the shafts 2010, 2012 comprises six cams 2024a-f, 2026a-f that are received through corresponding bearings 2026a-f, 2030a-f. The six cams 2024a-f, 2028a-f are disposed along the longitudinal axis of the shafts 2010, 2012 and are offset at a predetermined angle relative to each other depending on the number phases of the generator 2000. For example, in the illustrated six phase system, the angle between the first and second generator elements 2020a, 2020b is 180°, thus forming a first opposed counter-rotating pair. The angle between the third and fourth generator elements 2020c, 2020d is also 180°, thus forming a second opposed counter-rotating pair. Similarly, the angle between the fifth and sixth generator elements 2020e, 2020f is 180°, thus forming a third opposed counter-rotating pair. As discussed in more detail hereinbelow in connection with FIGS. 41-48, the opposed counter-rotating pairs provide a balanced reactive torque in the multi-phase generator 2000 that minimizes ripple torque. In a 12-phase system, the additional generator elements would be similarly spaced relative to each other to form balanced counter-rotating pairs of elastic elements to further minimize ripple torque, and so on. The top and bottom cams 2024a-f, 2028a-f corresponding to a particular generator element 2020a-f are disposed at 180° relative to each other. The top and bottom shafts 2010, 2012 are configured to couple to a mechanical energy source that applies counter rotational motion 2032, 2034 to the respective shafts 2010, 2012. In other words, in one embodiment, the top shaft 2012 rotates in a counterclockwise direction 2032 while the bottom shaft 2012 rotates in a clockwise direction 2034. The direction of rotation of the top and bottom shafts 2010, 2012 can be reversed provided that they maintain the opposed counter-rotation relative to each other.

As the mechanical work source applies counter rotational motion 2032, 2034 to the respective top and bottom shafts 2010, 2012, the generator elements 2020a-f are stretched and relaxed over each cycle by the forces applied by the corresponding cams 2024a-f, 2028a-f. Because the top and bottom cams 2024a-f, 2026a-f of a particular generator element 2020a-f are disposed at 180° relative to each other, over a single cycle the top and bottom portions of the generator element 2020a-f are stretched and relaxed. Because the cams 2024a-f, 2028a-f are disposed at 60° relative to each other along the longitudinal length of the shafts 2010, 2012, over a single cycle, the generator elements 2020a-f are stretched and relaxed out of synchronicity. This is better illustrated in FIG. 22, which captures an arbitrary state in time during one cycle. As shown in FIG. 22, each of the generator elements 2020a-f are at a different state of stretch and relaxation due to the spacing of the cams 2024a-f, 2028a-f. For example, the generator element 2022f appears to be at a fully stretched state and the generator element 2022c appears to be at a fully relaxed state and the remaining generator elements 2020a, b, d, e appear to be stretched at intermediate states.

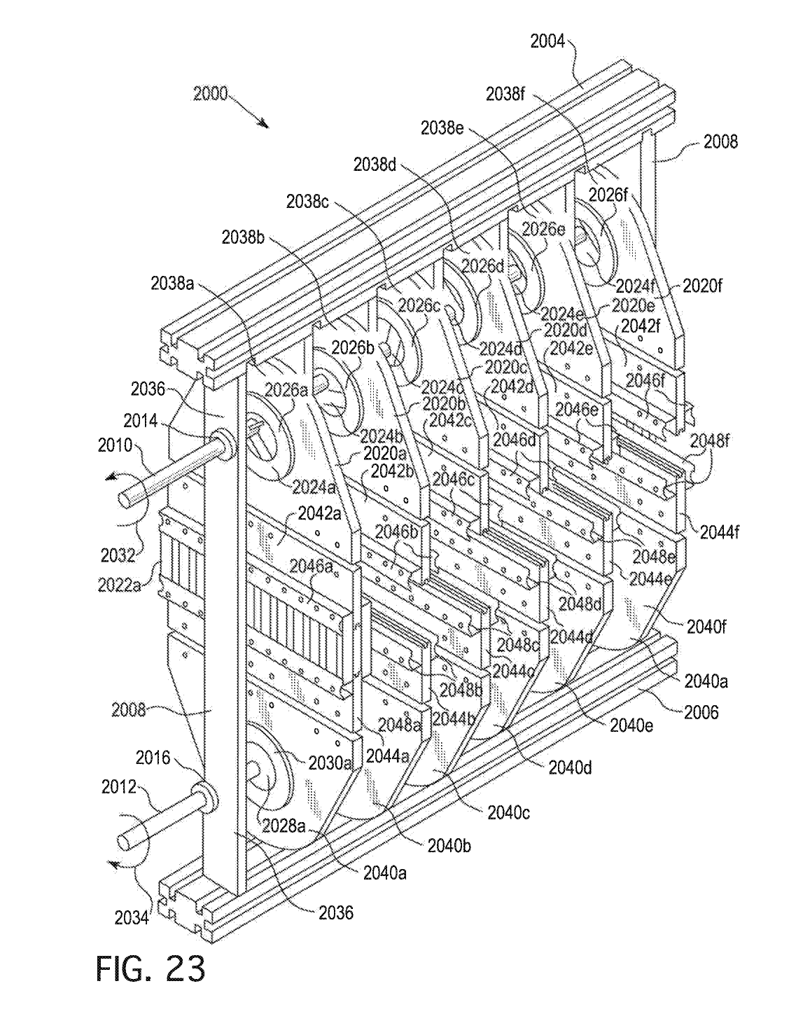

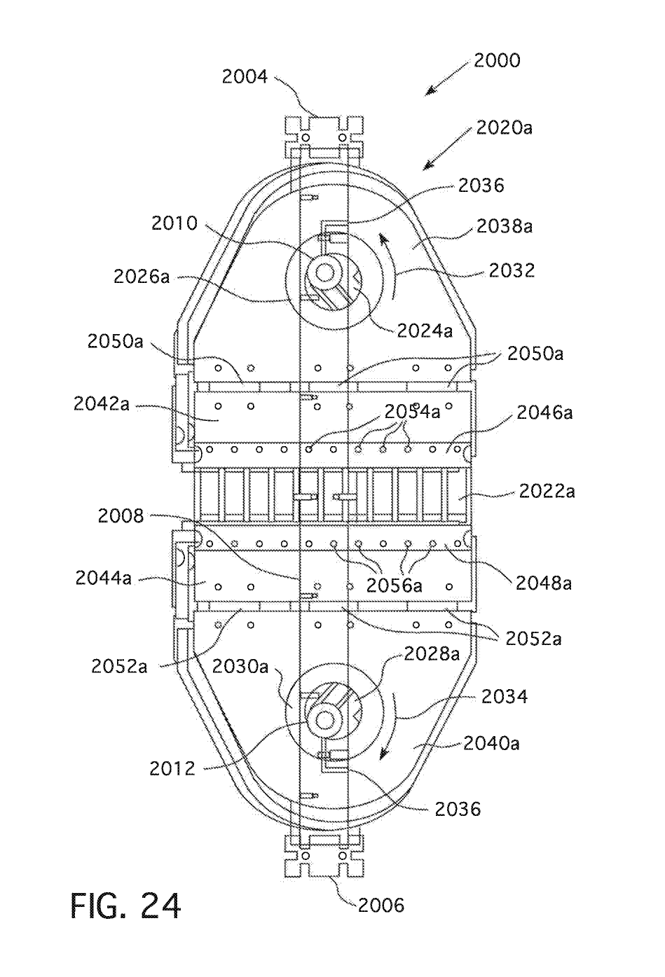

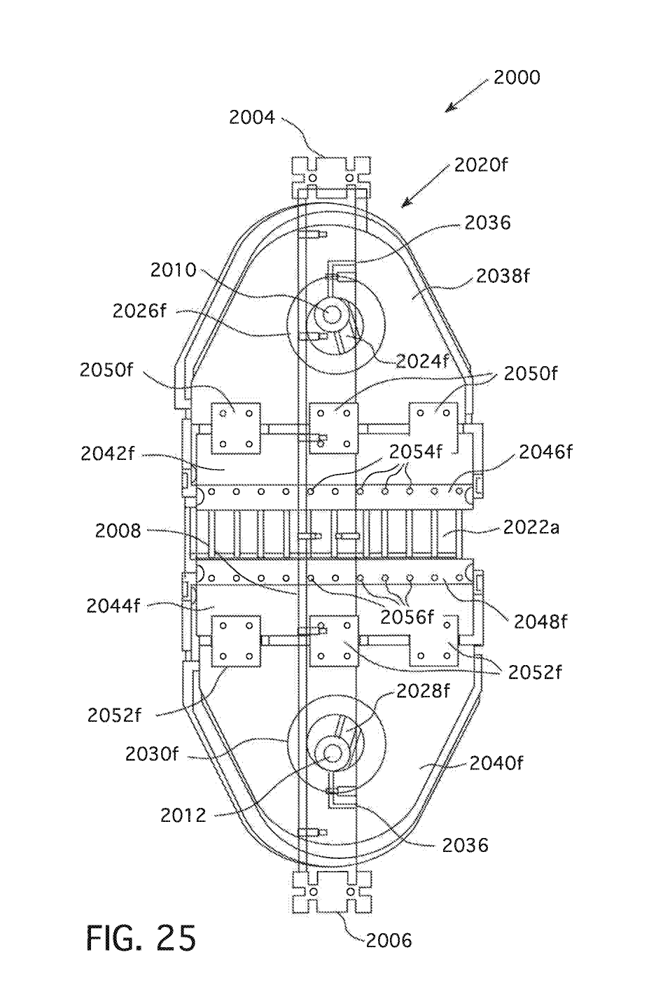

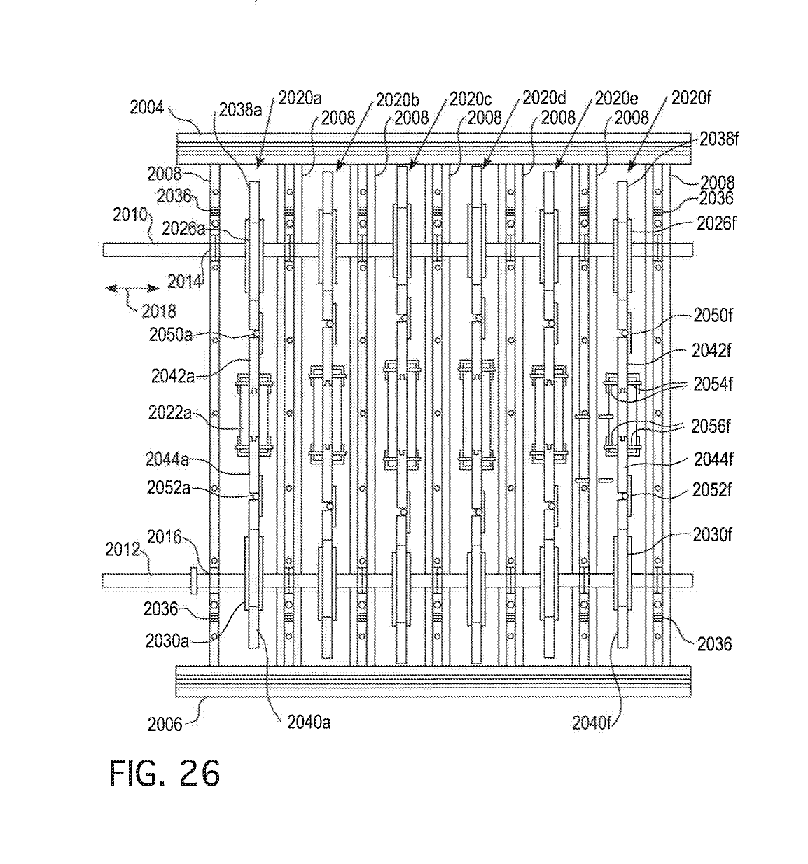

FIG. 23 is a perspective view of the six-phase electroactive polymer generator 2000 shown in FIGS. 20-22 with most of the dielectric elastomer generator modules 2022b-f removed, FIGS. 24 and 25 are end views of the six-phase electroactive polymer generator 2000 shown in FIG. 23 and FIG. 26 is a side view of the six-phase electroactive polymer generator 2000 shown in FIG. 23. As shown in FIGS. 23-26, each generator element 2020a-f comprises respective top and bottom hanger plates 2038a-f, 2040a-f. The hanger plates 2038a-f, 2040a-f include the corresponding bearings 2026a-f, 2030a-f for the each of the cams 2024a-f, 2028a-f. Hinge connectors 2042a-f, 2044a-f and angle clamps 2046a-f, 2048a-f couple each of the dielectric elastomer generator modules 2022a-f to the top and bottom hanger plates 2038a-f, 2040a-f. Hinges 2050a-f connect the top hinge connectors 2042a-f to the top hanger plates 2038a-f and hinges 2052a-f connect the bottom hinge connectors 2044a-f to the bottom hanger plates 2040a-f. A plurality of support tubes 2054a-f couple the top angle clamps 2046a-f and the dielectric elastomer generator modules 2022a-f to the top hinge connectors 2042a-f. Likewise, a plurality of support tubes 2056a-f couple the bottom angle clamps 2048a-f and the dielectric elastomer generator modules 2022a-f to the bottom hinge connectors 2044a-f.

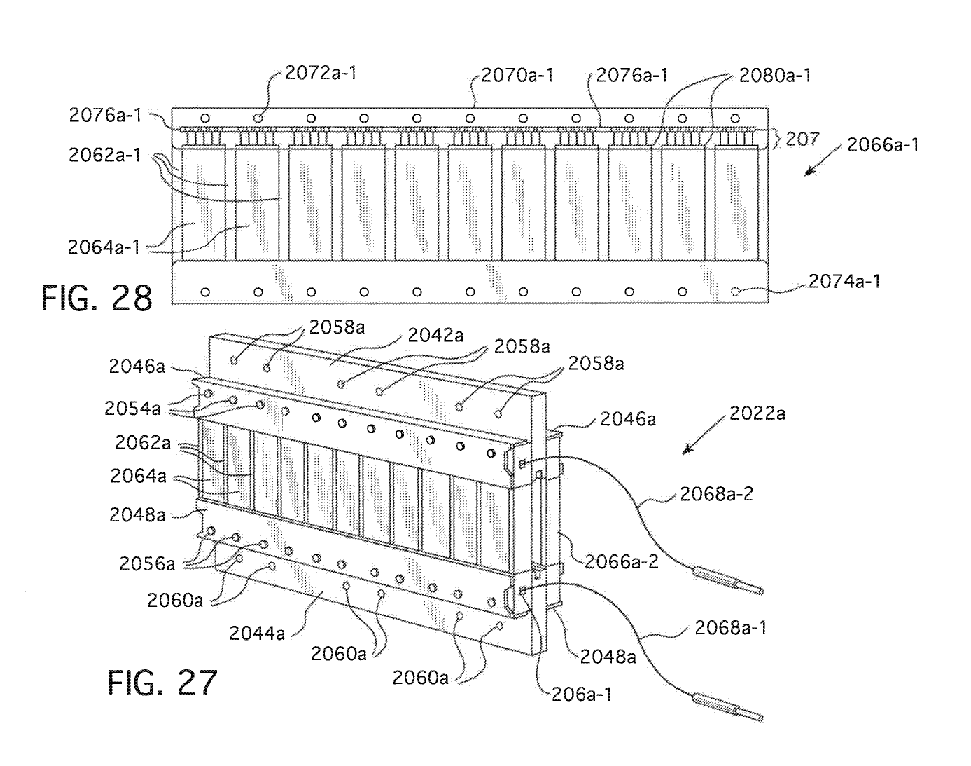

FIG. 27 illustrates one embodiment of the dielectric elastomer generator module 2022a shown in FIGS. 20-26. The dielectric elastomer generator module 2022a is one embodiment of an electroactive polymer transducer. As shown in FIG. 27, the dielectric elastomer generator module 2022a comprises first and second dielectric stacked elastomer film components 2066a-1 and 2066a-2. The stacked elastomer film components 2066a-1, 2066a-2 are attached to the hinge connectors 2042a, 2044a and angle clamps 2046a, 2048a by the support tubes 2054a, 2056a. Mounting apertures 2058a, 2060a are employed to connect the hinge connectors 2042a, 2044a to corresponding top and bottom hanger plates 2038a, 2040a, as described in connection with FIGS. 20-26. Each of the stacked elastomer film components 2066a-1, 2066a-2 comprise electrodes 2068a-1, 2068a-2, which couple the dielectric elastomer generator module 2022a to the conditioning electronics. This enables the conditioning electronics to apply the seed (bias) voltage to the dielectric elastomer film when it is in the stretched (strained) state and harvests the built up charge from the dielectric elastomer film when it is in the relaxed state. As shown in FIG. 27, the stacked elastomer film components 2066a-1 comprises a dielectric film layer 2062a and electrodes 2064a. In one embodiment, each of the stacked elastomer film components 2066a-1, 2066a-2 comprises a plurality of electrodes 2064a and dielectric film layers 2062a. In the illustrated embodiment, for example, the stacked elastomer film components 2066a-1, 2066a-2 comprises about 100 layers of dielectric film 2062a where each layer comprises eleven electrodes 2064a to form a 100×11 stacked elastomer film component. In one embodiment, each dielectric elastomer film layer 2062a is approximately 0.1 mm thick polyurethane, with a working energy density of 0.1, 0.2, or 0.4 J/cc, for example. Other suitable materials include acrylate, silicone, thermoplastic elastomer, hydrocarbon rubber, fluoroelastomer, styrenic copolymer, or the like. In one embodiment, the dielectric elastomer generator module 2022a comprises approximately 0.1 kg of active dielectric material and as a trench configuration T(280×100 mm)×(100 layers@100 μm). Such a module has a capacitance of approximately C=280 nF and requires a force F=1680 N (3781b) to strain the module (Y=0.6 MPa) 100%.

FIG. 28 illustrates one embodiment of the stacked elastomer film component 2066a-1 portion of the dielectric elastomer generator module 2022a shown in FIG. 27. As shown in FIG. 28, in one embodiment, the stacked elastomer film component 2066a-1 comprises a printed circuit board with solder mask 2070a-1 and a plurality of mounting apertures 2072a-1, 2074a-1 to connect the stacked elastomer film component to the angle clamps 2046a, 2048a via the support tubes 2054a, 2056a (shown in FIGS. 24-27). Each of the stacked elastomer film components 2066a-1 comprises polymer fuses 2078a-1 coupled between a bus electrode 2076a-1 and each electrode 2064a-1 formed over the dielectric elastomer film 2062a-1. When the stacked elastomer film components 2066a-1, 2066a-2 comprise fuses, they may be referred to as fused segments. The bus electrode 2076a-1 may be a copper bus end-to-end and plated like a standard landing. Metallic terminals 2080a-1 electrically couple the bus electrode 2076a-1 to the individual electrodes 2064a-1 via the polymer fuses 2078a-1. In one embodiment, silver ink is printed over the polymer fuses 2078a-1 and the terminals to 2080a-1. As shown, the stacked elastomer film component 2066a-1 comprises eleven electrodes, without limitation, as any suitable number of electrodes 2064a-1 may be included based on specific implementations of the dielectric elastomer generator module 2022a. Similarly, although only the top film layer is shown, in one embodiment, the stacked elastomer film component 2066a-1 comprises 100 layers, without limitation, as any suitable number of film layers may be included based on specific implementations of the dielectric elastomer generator module 2022a.

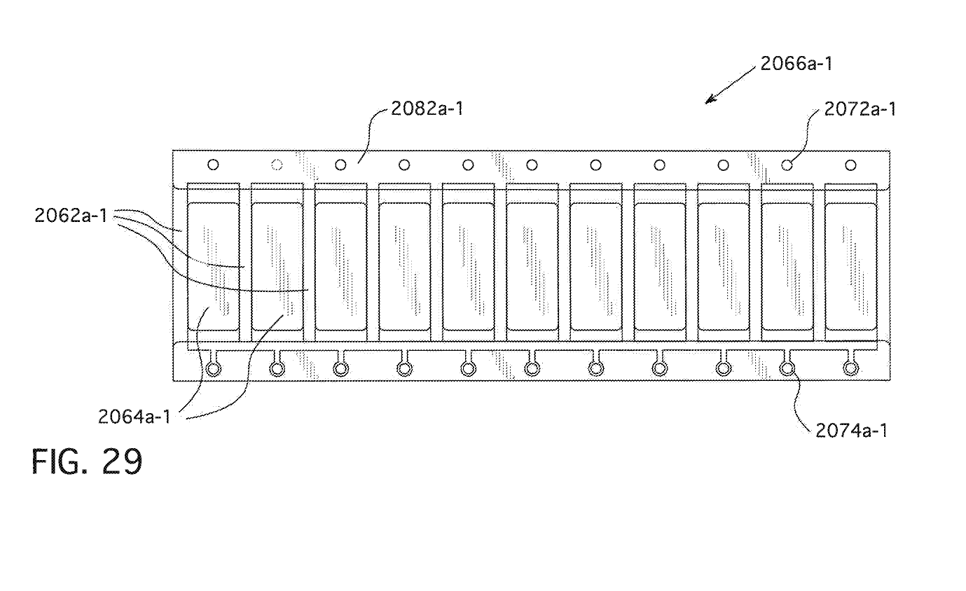

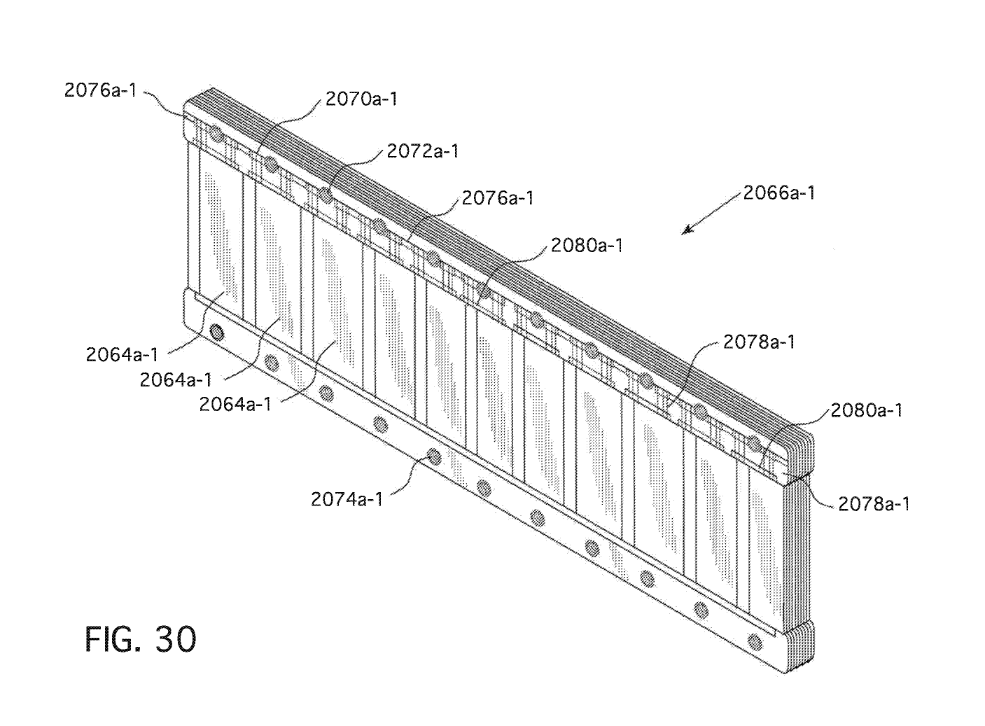

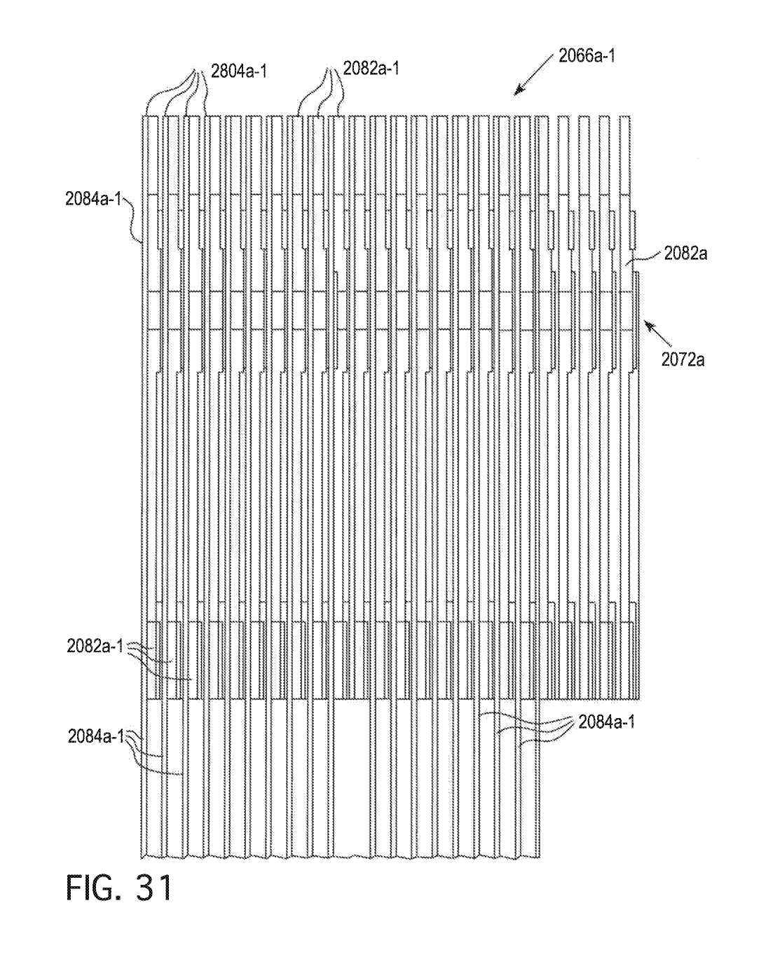

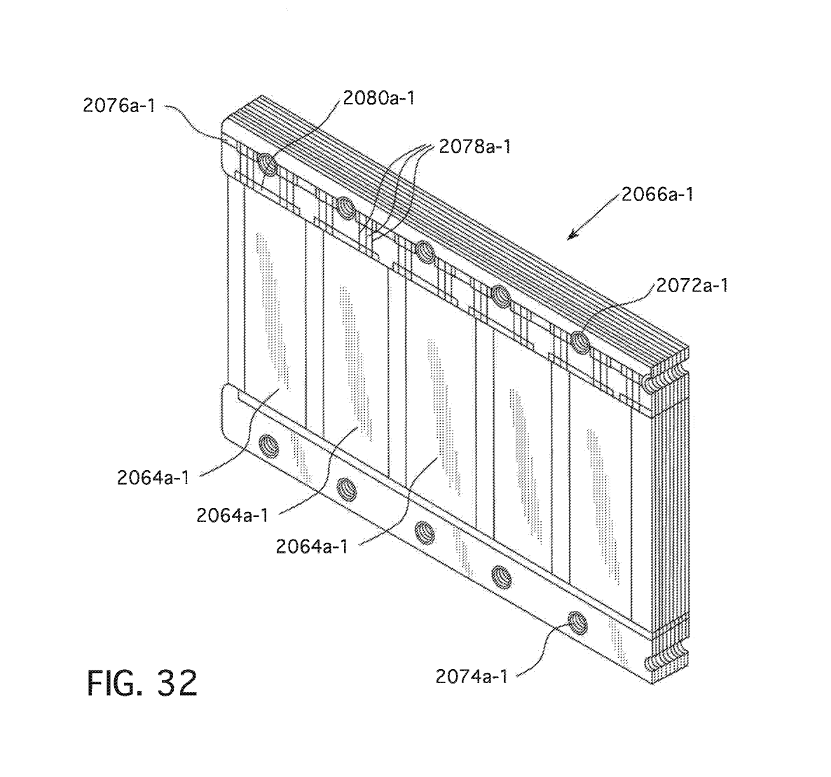

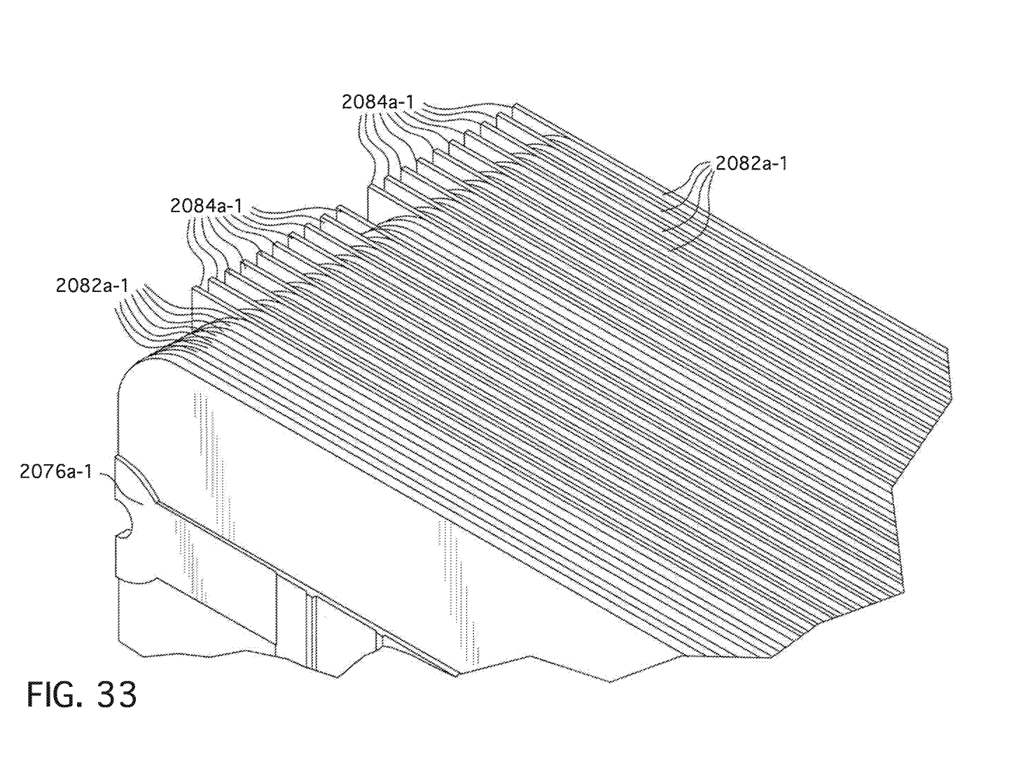

FIGS. 29-33 show additional detailed views of the fused segment 2066a-1 shown in FIGS. 27-28. FIG. 29 is a front view of the stacked elastomer film component 2066a-1. FIG. 30 is a perspective view of the stacked elastomer film component 2066a-1 with a front plate removed. FIG. 31 is a detailed end view of the stacked elastomer film component 2066a-1 shown in FIG. 30, FIG. 32 is a sectional perspective view of the stacked elastomer film component 2066a-1. And, FIG. 33 is a detailed view of the sectional perspective view of the stacked elastomer film component 2066a-1 shown in FIG. 32.

Turning first to FIGS. 29-31, the stacked elastomer film component 2066a-1 comprises multiple layers of frame elements 2082a-1 and dielectric elastomer film elements 2084a-1. The electrodes 2064a-1 are formed, by printing with conductive inks, for example, on each of the dielectric elastomer film layers 2084a-1. As previously discussed, in one embodiment, the fused segment 2066a-1 may comprise up to 100 layers of the dielectric elastomer film elements 2084a-1. The frame elements 2082a-1 provide support for the dielectric elastomer film elements 2084a-1 layers and also include the electrical connections to the individual electrodes 2064a-1 via the printed circuit board 2070a-1, bus electrode 2076a-1, polymer fuses 2078a-1, and metallic terminals 2080a-1, which can be silver coated in one embodiment. FIGS. 32-33 show the delineation between the frame elements 2082a-1 and the dielectric elastomer film elements 2084a-1 layers.

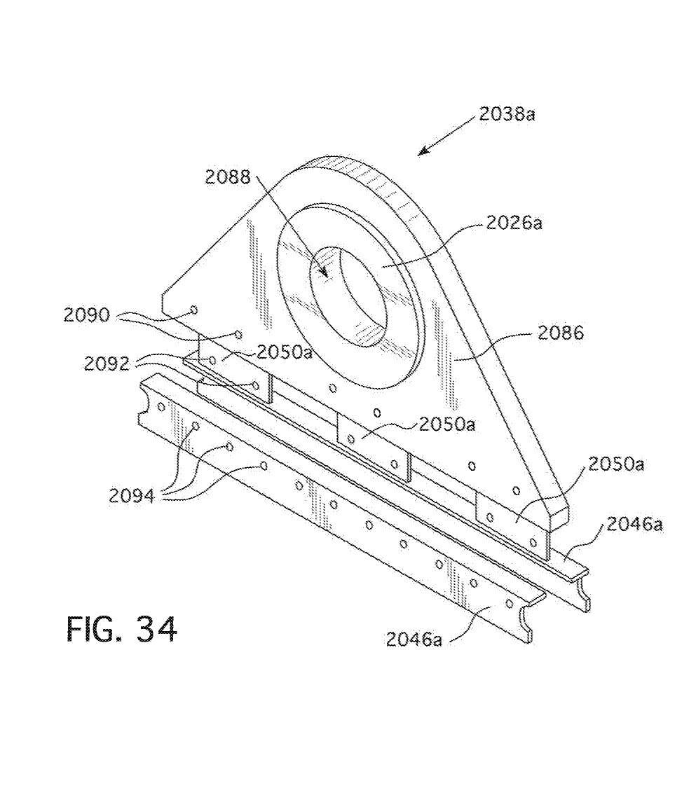

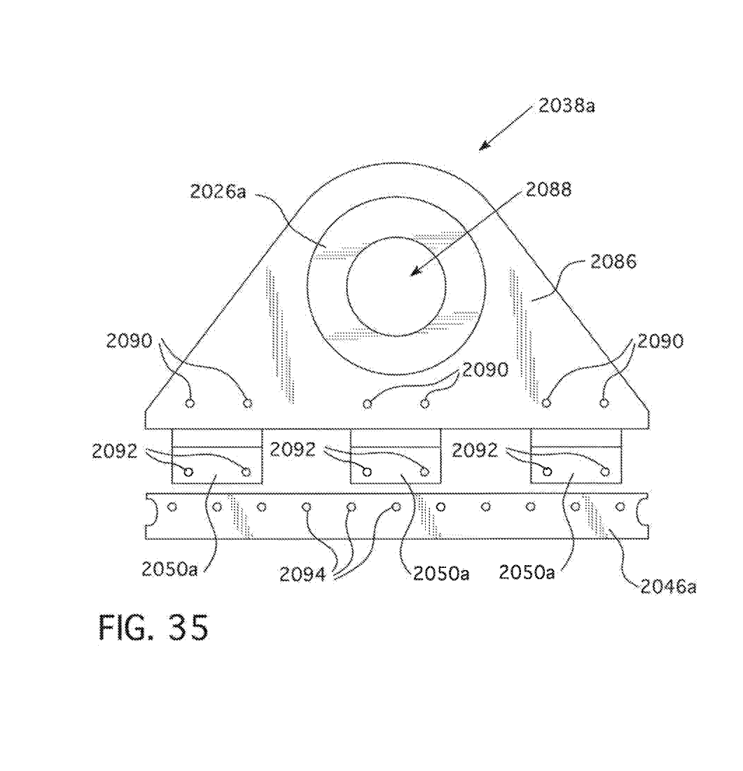

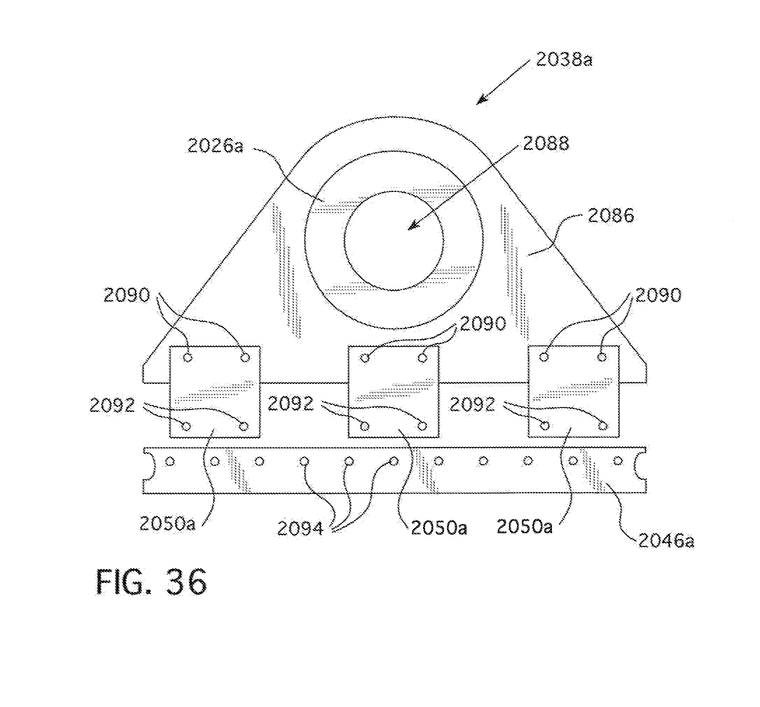

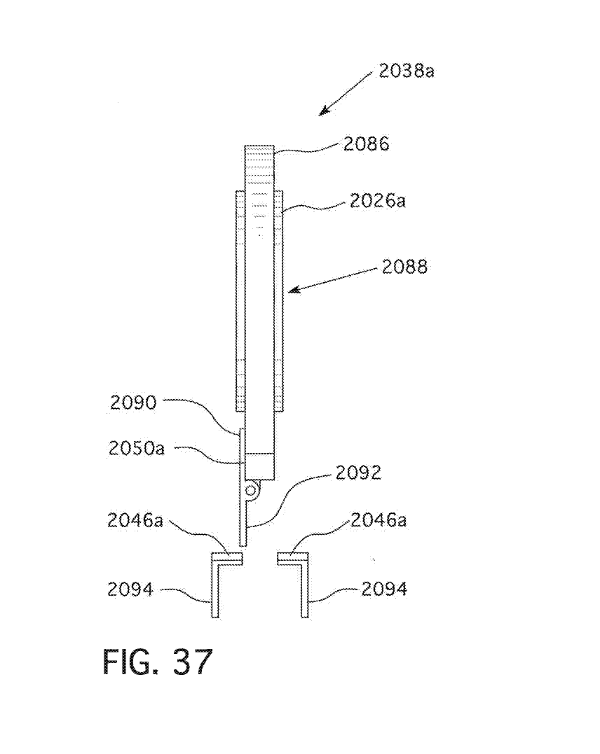

FIGS. 34-37 illustrate detail views of the top hanger plate 2038a shown in FIGS. 20-24 and 26, according to one embodiment. The bottom hanger plate 2040a is substantially similar to the top hanger plate 2038a and will not be described in detail herein. As shown in FIGS. 34-37, in one embodiment, the top hanger plate 2038a comprises a body portion 2086 that defines an aperture suitable for receiving the bearing 2026a therein. As previously discussed in reference to FIGS. 20-26, the bearing 2026a defines an aperture 2088 having a diameter suitable to locate the top shaft 2010 within the aperture 2088. The hinges 2050a connect to the body 2086 of the top hanger plate 2038a through mounting apertures 2090 and connect to the dielectric elastomer generator module 2022a through mounting apertures 2092, which correspond with mounting apertures 2058a formed in the hinge connector 2042a of the dielectric elastomer generator module 2022a (FIG. 27). Also shown are the top angle clamps 2046a that couple to hinge connector 2042a through mounting apertures 2094, which correspond to mounting apertures 2072a-1 formed in the stacked elastomer film component 2066a-1 (FIGS. 28-30). It will be appreciated that the plurality of support tubes 2054a couple the angle clamps 2046a to the stacked elastomer film components 2066a-1, 2066a-2 (FIG. 27).

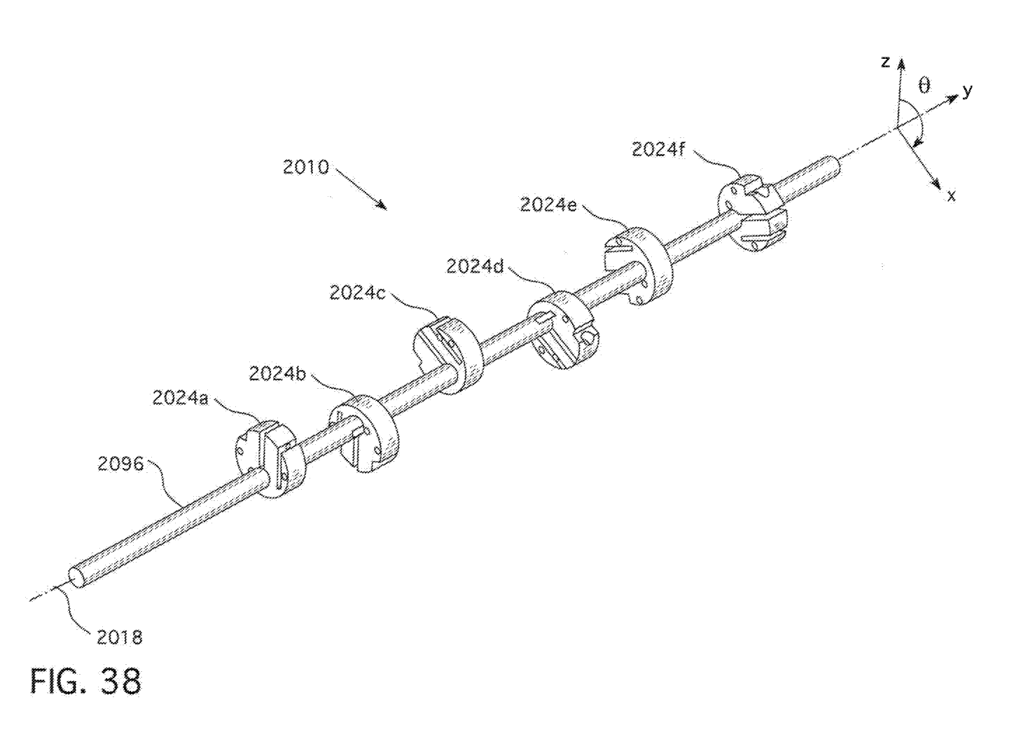

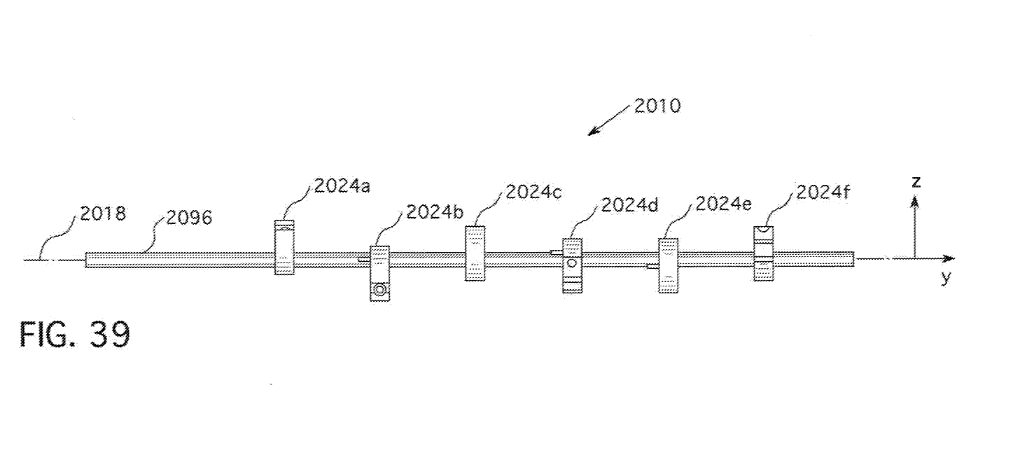

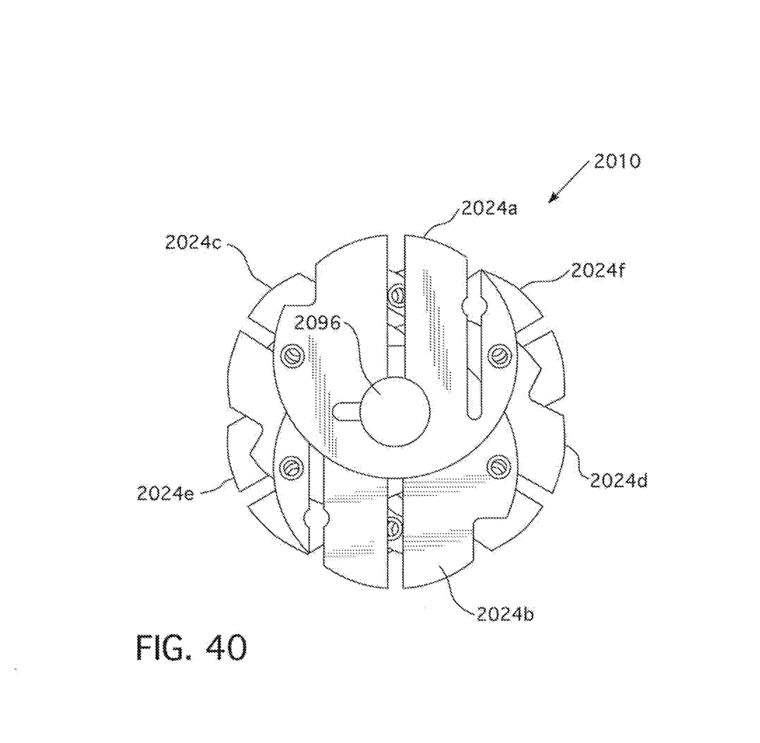

FIGS. 38-40 illustrate one embodiment of the shaft for use with the six-phase electroactive polymer generator 2000 described in connection with FIGS. 20-26. FIG. 38 is a perspective of the top shaft 2010. FIG. 39 is a side view of the top shaft 2010. FIG. 40 is an end view of the top shaft 2010. A detailed description of the top shaft 2010 is provided in connection with the embodiment shown in FIGS. 38-40. Because the bottom shaft 2012 is substantially similar to the top shaft 2010, a detailed description of the bottom shaft 2012 will be omitted for conciseness and clarity of disclosure. As shown, the top shaft 2010 comprises a longitudinally 2018 extending arm 2096 with six cams 2024a-f disposed and fixedly attached along the longitudinal length 2018 of the arm 2096. As previously discussed, the cams 2024a-f are operatively coupled to the six generator elements 2020a-f to stretch and relax the DEG module 2022a-f as the top and bottom shafts 2010, 2012 rotate under the influence of mechanical work applied to the shafts 2010, 2012.

The cams 2024a-f are rotationally disposed about the arm 2096 at an angle θ between the X-Z axes. As shown, the cams 2024a and 2024b are rotationally disposed by an angle θ=180° relative to each other, where for the purposes of this discussion the Z axis corresponds to 0°. The next cam 2024c is disposed by an angle θ=300° relative to first cam 2024a. The next cam 2024d is disposed by an angle θ=120° relative to first cam 2024a. The next cam 2024e is disposed by an angle θ=240° relative to first cam 2024a. The last cam 2024f is disposed by an angle θ=60° relative to first cam 2024a. The cams 2028a-f of the bottom shaft 2012 are located at 180° relative to cams 2024a-f located on the top shaft 2010. Accordingly, as the arms 2096 of the top and bottom shafts 2010, 2012 rotate, the cams 2024a-f, 2028a-f operatively engage the top and bottom hanger plates 2038a-f, 2040a-f to stretch and relax the dielectric elastomer generator module 2022a-f over each rotation cycle of the top and bottom shafts 2010, 2012.

As previously discussed, the cams 2024a-f are rotationally disposed about the arm 2096 at relative angles between the cams 2024a-f to form balanced counter-rotating elastic pairs. Stated differently, each pair comprising the first and second cams 2024a, 2024b, the third and fourth cams 2024c, 2024d, and the fifth and sixth cams 2024e, 2024f are disposed at an angle θ of 180° relative to each other in order to form balanced counter-rotating elastic pairs to minimize ripple torque.

### Balanced Reactive Torque Analysis of Multi-Phase Elastic Elements

FIGS. 41-48 illustrate the principle of balanced reactive torque in a multi-phase dielectric elastomer generator. FIG. 41 is a diagram 2100 illustrating torque from one elastic element. Consider the two counter rotating bars 2102, 2104 coupled by a linear elastic spring 2106 to form one pair of elastic elements that are free to rotate about respective pivot points 2116, 2118. The first bar 2102 rotates in a counterclockwise direction 2108 and the second bar rotates counter to the first bar 2102 in a clockwise direction 2110. Suppose that the separation distance 2112 of the bars 2102, 2104 is chosen so that the spring 2106 force varies between F=0 and F=Fₘₐₓ. The length of the spring 2106, and therefore the force, can be described with a (1−cos θ) term, and the moment arm is seen to vary with r sin θ, as shown in FIG. 42.

FIG. 42 illustrates the force and torque on one of the bars 2102 due to the elastic spring 2106. As shown in FIG. 42, the force experienced by the bar 2102 is:

F=Fₘₐₓ(1−cos θ)/2 (32)

The torque can be expressed as the difference of two sine waves with different frequencies using the trigonometric substitution:

sin θ cos θ=(½)sin 2θ (33)

Starting from the torque expression in FIG. 42 gives:

$${τ}_{0} = - {F}_{max} ( \frac{1 - cos θ}{2} ) r sin θ \\ {τ}_{0} = - {F}_{max} r ( \frac{sin θ - sin θcosθ}{2} ) \qquad ( 34 , 35 )$$

Such that the torque from one elastic spring 2106 is

$${τ}_{0} = - \frac{{F}_{max} r}{2} ( sin θ - \frac{sin θ}{2} ) \qquad ( 36 )$$

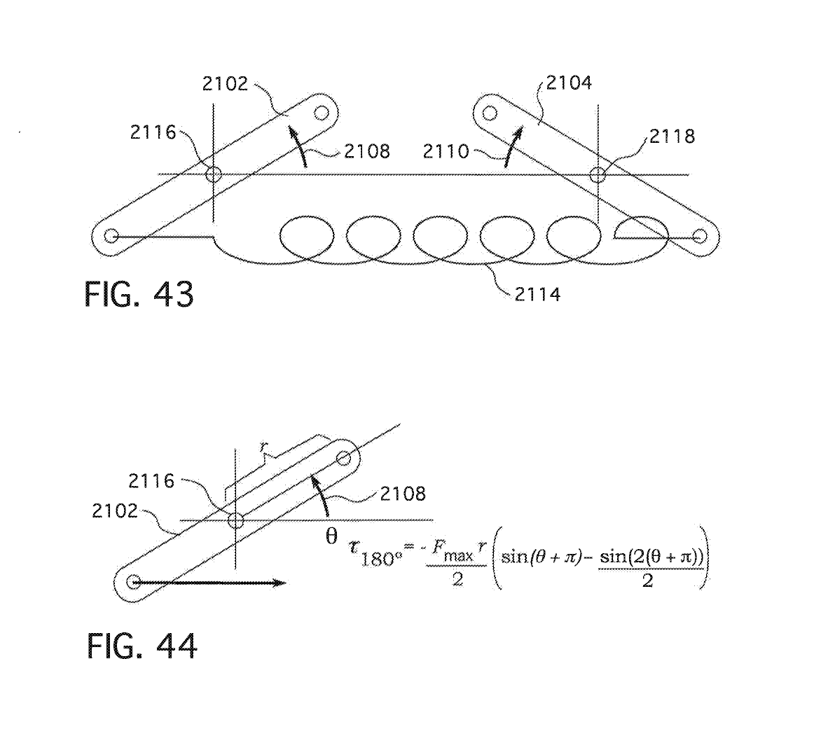

FIG. 43 (inset of FIG. 44) is a diagram illustrating the torque from a second elastic element 180° out of phase from the first elastic element. In FIG. 43 as second elastic spring 2114 is coupled to opposite ends of the two-counter rotating bars 2102, 2104 relative to the configuration of FIG. 41. The torque expression is derived as shown in FIG. 44. The torque expression for the second elastic element can be placed into a more convenient form using two additional trigonometric substitutions. Starting with the expression in FIG. 44 provides:

$${τ}_{180 °} = - \frac{{F}_{max} r}{2} ( sin ( θ + π ) - \frac{sin ( 2 ( θ + π ) )}{2} ) \qquad ( 37 )$$

Using a first trigonometric identity:

sin(2θ+2π)=sin 2θ (38)

Substituting gives:

$${τ}_{180 °} = - \frac{{F}_{max} r}{2} ( sin ( θ + π ) - \frac{sin ( 2 ( θ + π ) )}{2} ) \qquad ( 39 )$$

Now using a second trigonometric identity:

sin(θ+π)=−sin θ (40)

Accordingly, the torque from the second elastic spring 2114 that is 180° out of phase from the first is:

$${τ}_{180 °} = - \frac{{F}_{max} r}{2} ( - sin ( θ ) - \frac{sin ( 2 θ )}{2} ) \qquad ( 41 )$$

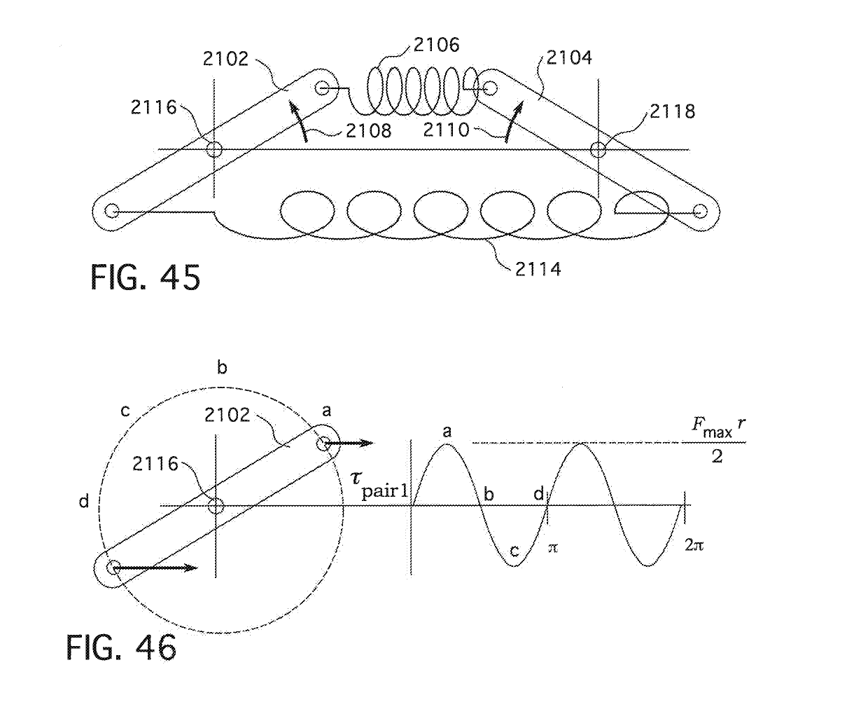

FIG. 45 is a diagram illustrating the torque for a pair of opposed elastic elements that are 180° out of phase. As shown in FIG. 45 the counter-rotating bars 2102, 2104 are now coupled by the first elastic spring 2106 at first ends and the second elastic spring 2114 at second ends to form a pair of opposed elastic elements. Summing the torque equations (36) and (41) gives the torque for a pair of opposed elastic elements:

$${τ}_{0 °} + {τ}_{180 °} = - \frac{{F}_{max} r}{2} ( sin θ - \frac{sin ( 2 θ )}{2 } - sin ( θ ) - \frac{sin ( 2 θ )}{2} ) \qquad ( 42 )$$

which simplifies to:

$${τ}_{pair 1} = \frac{{F}_{max} r}{2} sin ( 2 θ ) \qquad ( 43 )$$

The term 2θ in equation (43) means that the passive torque changes twice as fast as the angle of the bar 2102, which is illustrated in FIG. 46.

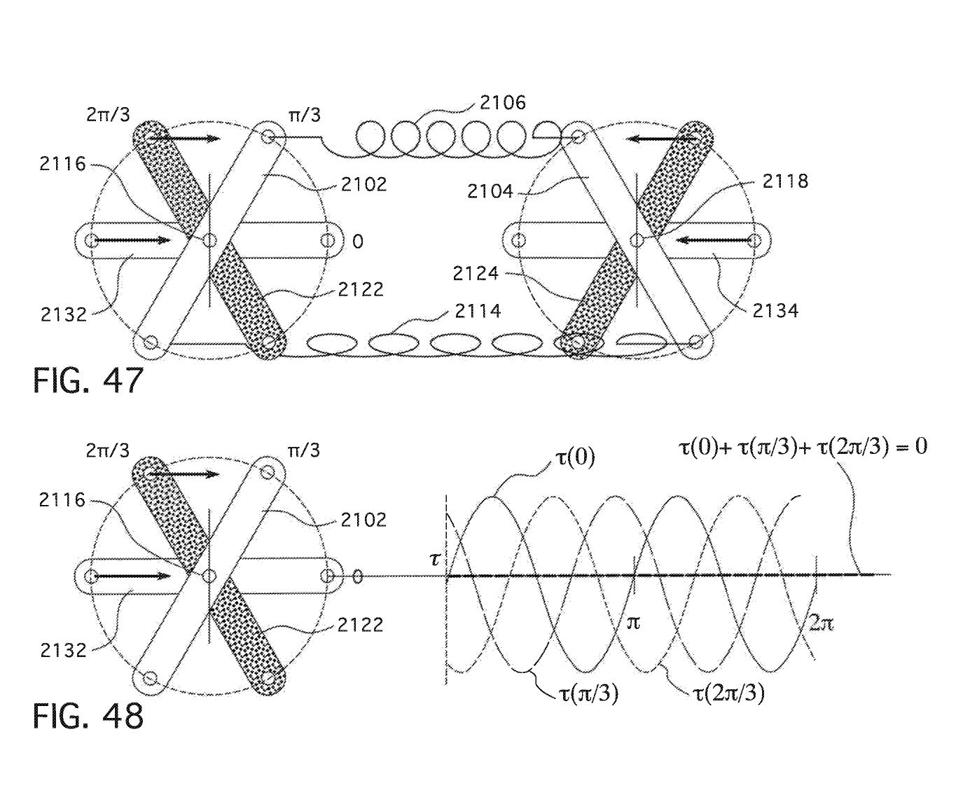

FIG. 47 is a diagram illustrating the torque for three pairs of elastic elements evenly distributed. For clarity, only two opposing elastic elements comprised of the counter-rotating bars 2102, 2104 coupled to corresponding elastic springs 2106, 2114 are shown at π/3. It will be appreciated, that the other two pairs of elastic elements are also coupled to corresponding pairs of elastic springs at 0 and 2π/3. The expression for passive torque derived in equation (43) holds for one pair of elastic elements. To balance the machine, three pairs of elastic elements are distributed around the half-cycle. As shown in FIG. 47, three pairs of elastic elements are distributed around the half-circle at 0, π/3, 2π/3. As shown in FIG. 48, the arrangement shown in FIG. 47 makes the passive torques sum to zero for the three pairs of elastic elements 2102-2104, 2122-2122, and 2132-2134 situated at 0, π/3, 2π/3.

In algebra, rather than illustrations, it can be seen that accounting for the shifts in the timing of the torques of the these three pairs gives:

$$\begin{matrix}\sum τ = {τ}_{0} + {τ}_{π / 3} + {τ}_{2 π / 3} & ( 44 , 45 ) \\ \sum τ = \frac{{F}_{max} r}{2} ( sin ( 2 θ ) + sin ( 2 ( θ - \frac{π}{3} ) + sin ( 2 ( θ - \frac{2 π}{3} ) ) & \end{matrix}$$

In general, the periodicity of the sine function causes three terms to sum to zero when they are each shifted by 2π/3. That is, for any value x:

$$sin x + sin ( x - \frac{2 π}{3} ) + sin ( x - \frac{4 π}{3} ) = 0 \qquad ( 46 )$$

Since this identity holds for any x, including x=2θ, the passive torques sum to zero:

$$\sum τ = \frac{{F}_{max} r}{2} ( sin ( 2 θ ) + sin ( ( 2 θ - \frac{2 π}{3} ) + sin ( ( 2 θ - \frac{4 π}{3} ) ) \\ \sum τ = 0 \qquad ( 47 )$$

Accordingly, three opposed pairs of elastic elements balance and have zero ripple torque. Likewise, multiples of three pairs (six pairs, nine pairs, etc.) also balance. Three pairs, however, is the minimum number of elastic elements that balance.

### Radial Dielectric Elastomer Generator

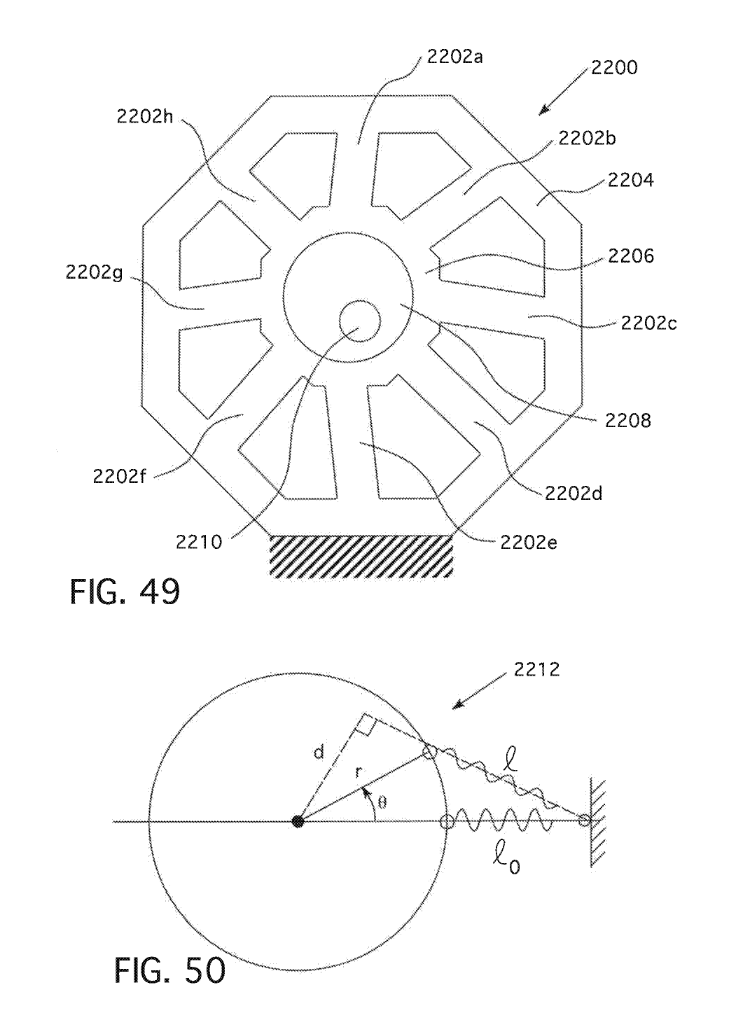

More than three pairs (or six phases) of elastic elements may be used advantageously. FIG. 49 illustrates a radial dielectric elastomer generator 2200 with eight phases attached to a central cam. As shown in FIG. 49, the radial dielectric elastomer generator 2200 comprises eight electroactive polymer radial legs 2202a-h defining the eight phases. The radial legs 2202a-h are attached to an outer rigid frame 2204 and a central bearing 2206 for a cam 2208. The cam 2208 is rotatably coupled to a rotating shaft 2210. As the shaft 2210 rotates, the cam 2208 actuates each of the radial legs 2202a-h during each cycle of the generator 2200.

FIG. 50 is a diagram 2212 an approximation of each phase as a linear spring attached to a point orbiting the central axis. Stretching and rotating the spring creates a torque about the central axis. The passive torque due to a single phase can be calculated as follows:

$$\begin{matrix}τ = F \times d & ( 47 , 48 , 49 , 50 , 51 ) \\ F = k ( \frac{𝓁 - {𝓁}_{0}}{{𝓁}_{0}} ) & \\ d = \frac{r sin θ ( {𝓁}_{0} + r )}{𝓁} & \\ 𝓁 = {[ 2 r [ r + {𝓁}_{0} - ( r + {𝓁}_{0} ) cos θ ] + {𝓁}_{0}^{2} ]}^{\frac{1}{2}} & \\ τ = rk sin θ ( {𝓁}_{0} + r ) [ \frac{1}{{𝓁}_{0}} - \frac{1}{𝓁} ] & \end{matrix}$$

where;

r=radius of orbit [m];

l₀=rest length of spring [m]; and

k=spring rate [N/m].

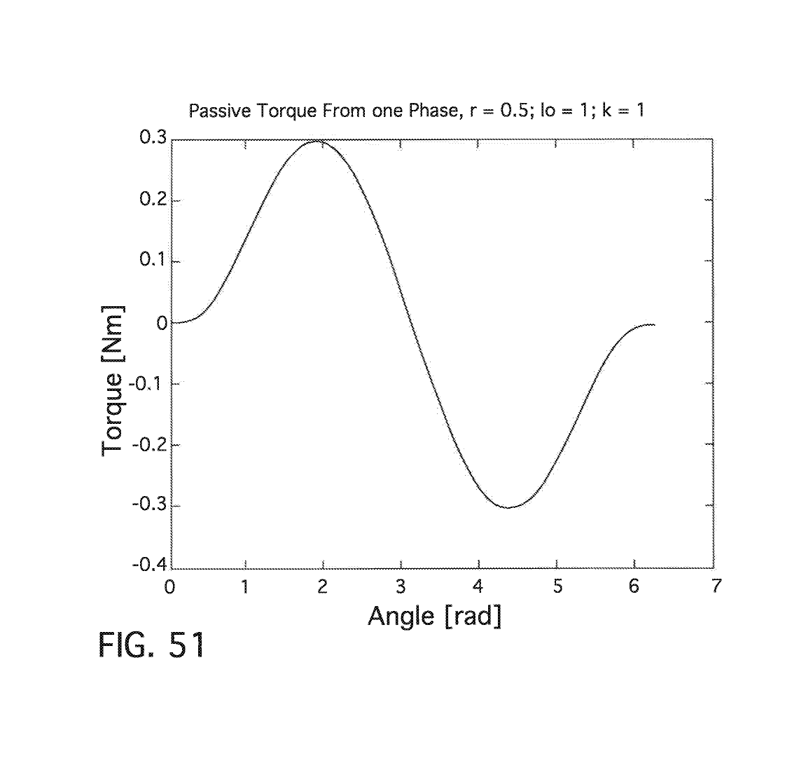

FIG. 51 is a graphical representation of the passive torque calculated using equation (51) where r=0.5; lₒ=1; and k=1. The vertical axis corresponds to Passive Torque (Nm) and the horizontal axis corresponds to angle (radians).

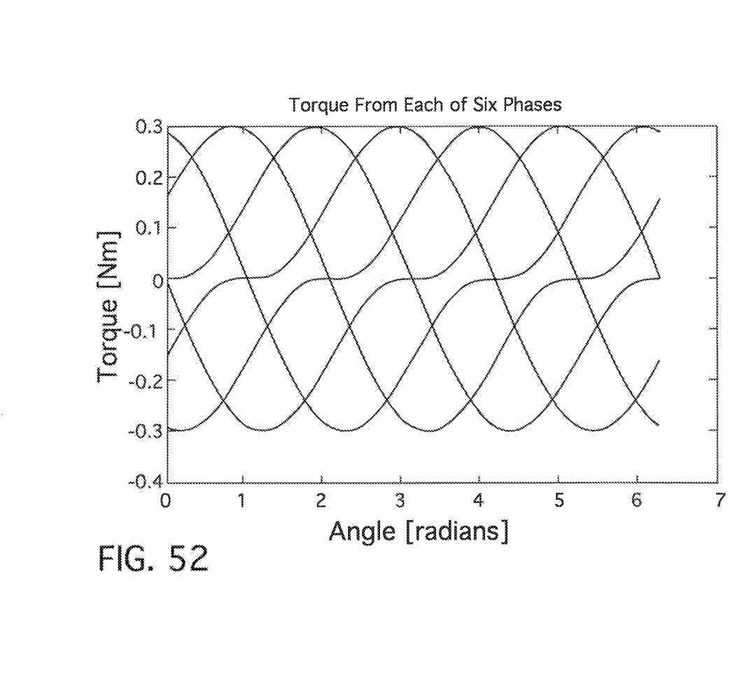

FIG. 52 is a graphical representation of torque from each of six phases. The vertical axis corresponds to Torque Force (Nm) and the horizontal axis corresponds to angle (radians).

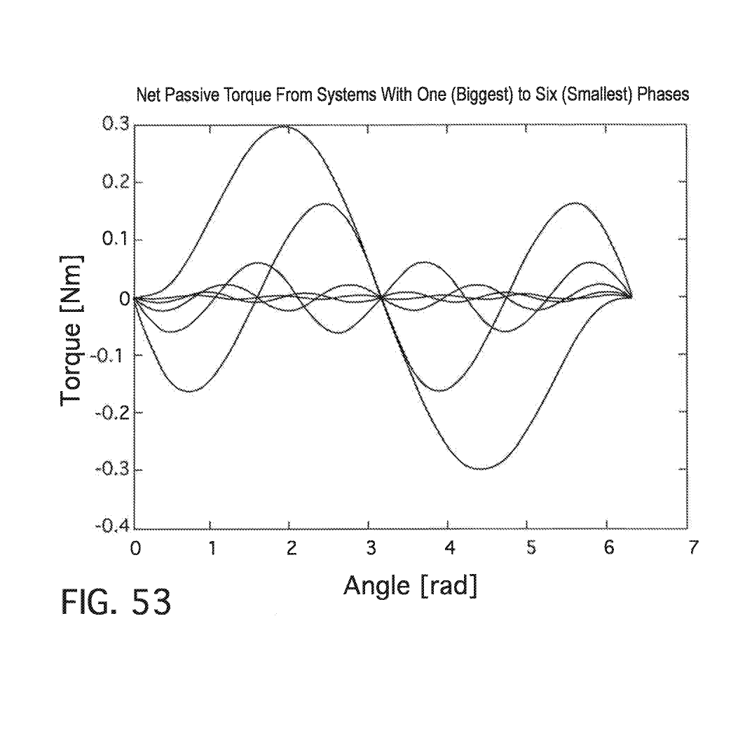

FIG. 53 is a graphical representation of net passive torque from systems with one (biggest) to six (smallest) phases. The vertical axis corresponds to Passive Torque (Nm) and the horizontal axis corresponds to angle (radians). As shown, the systems with a greater number of phases have the smallest net passive torque.

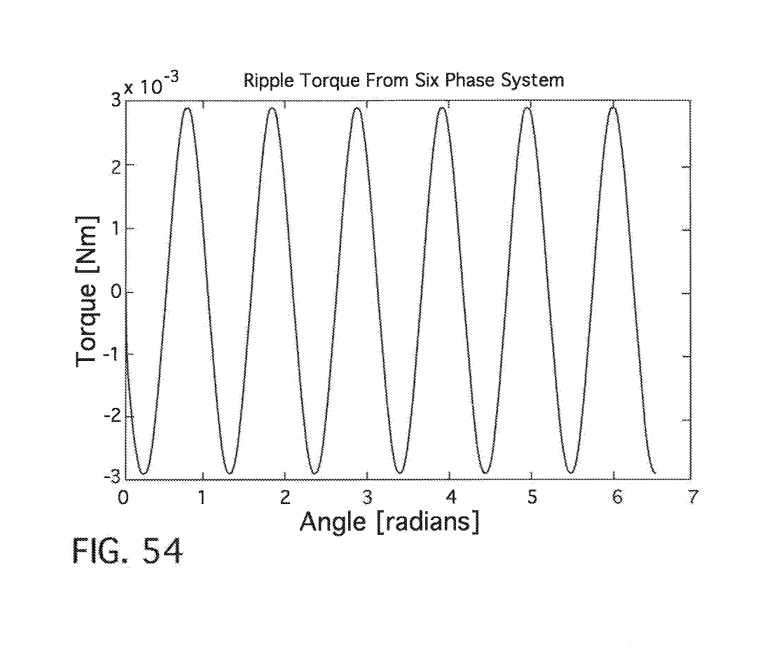

FIG. 54 is a graphical representation of ripple torque from a six phase system. The vertical axis corresponds to torque [Nm] and the horizontal axis corresponds to angle [radians].

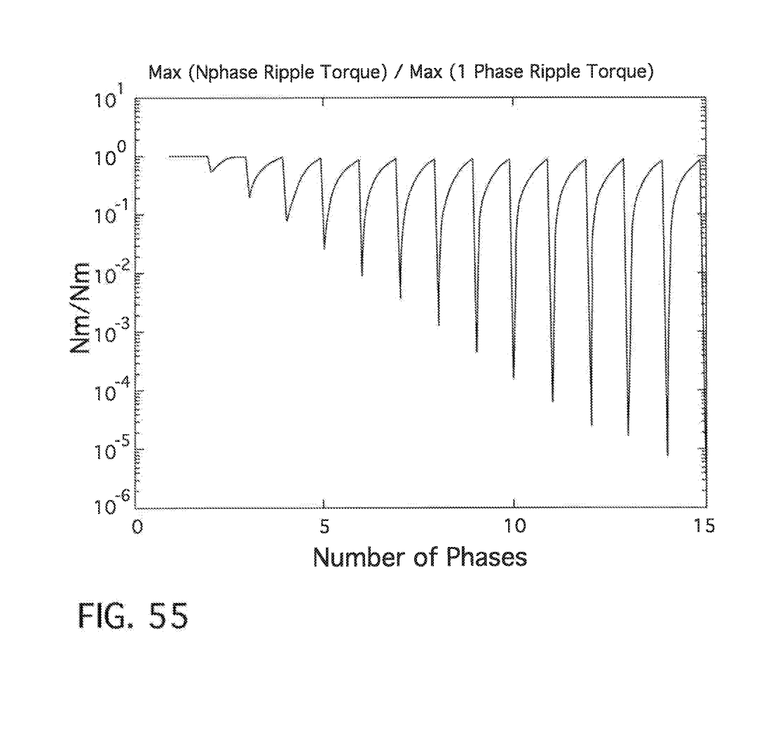

FIG. 55 is a graphical representation of the ratio of maximum ripple torque of systems with n-phases to systems with one-phase. The vertical axis corresponds to the torque ratio and the horizontal axis corresponds to the number of phases. Accordingly, it can be seen that by adding phases, ripple torque (equivalent to cogging) can be driven down to a desired level, such as, for example 2E−5 (20 ppm) with twelve-phases.

It is worthy to note that any reference to “one embodiment” or “an embodiment” means that a particular feature, structure, or characteristic described in connection with the embodiment is included in at least one embodiment. The appearances of the phrase “in one embodiment” or “in one aspect” in the specification are not necessarily all referring to the same embodiment.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It will be appreciated that those skilled in the art will be able to devise various arrangements which, although not explicitly described or shown herein, embody the principles of the present disclosure and are included within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, embodiments, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary embodiments and embodiments shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the invention and does not pose a limitation on the scope of the invention otherwise claimed. No language in the specification should be construed as indicating any non-claimed element essential to the practice of the invention. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments and appended claims.

What is claimed is:

1. An energy conversion apparatus configured to convert energy from a mechanical energy source into electrical energy, the energy conversion apparatus comprising:
a transducer comprising a dielectric elastomer module comprising stretchable electroactive polymer material, the dielectric elastomer module comprising at least one dielectric elastomer film layer having at least a portion disposed between at least first and second electrodes;
a transmission coupling mechanism configured to couple the mechanical energy source and operatively attached to the transducer to cyclically strain and relax the transducer in response to the mechanical energy acting on the transmission coupling mechanism; and
a conditioning circuit coupled to the at least first and second electrodes and configured to apply an electric charge to the dielectric elastomer film when the dielectric elastomer film is in a strained state, to disconnect from the dielectric elastomer film when the dielectric elastomer film transitions from the strained state to a relaxed state, and to remove electrical charge from the dielectric elastomer film when the dielectric elastomer film reaches a relaxed state.

2. The energy conversion apparatus according to claim 1, wherein the dielectric elastomer module comprises a plurality of dielectric elastomer film elements layered between a plurality of frame elements and a plurality of electrodes formed on each layer.

3. The energy conversion apparatus according to claim 2, further comprising a bus electrode located on at least one of the frame elements to couple the conditioning circuit to the plurality of electrodes.

4. The energy conversion apparatus according to claim 3, further comprising a polymer fuse electrically connected between the bus electrode and at least one electrode.

5. The energy conversion apparatus according to any one of claims 1 to 4, wherein the dielectric elastomer film has a modulus of less than about 100 MPa and a dielectric constant greater than about 2 and comprises one or more materials selected from the group consisting of acrylates, silicones, urethanes, hydrocarbon rubbers, fluoroelastomers, styrenic copolymers, and combinations thereof.

6. The energy conversion apparatus according to any one of claims 1 to 5, wherein at least one of the first and second electrodes comprises at least one selected from the group consisting of a scalloped reinforcing bead, a serpentine reinforcing bead, a calendered composite material, and a textile.

7. The energy conversion apparatus according to any one of claims 1 to 6, wherein the transmission coupling mechanism comprises a first shaft having a first portion configured to couple to the mechanical energy source and a second portion comprising a first cam operatively coupled to the transducer.

8. The energy conversion apparatus according to claim 7, wherein the first shaft comprises a second cam disposed about the shaft at an angle of 180° relative to the first cam on the first shaft.

9. The energy conversion apparatus according to claim 8, wherein the transmission coupling mechanism comprises a second shaft having a first portion configured to couple to the mechanical energy source and a second portion comprising a second cam operatively coupled to the transducer and disposed about the shaft at an angle of 180° relative to the first cam on the second shaft.

10. The energy conversion apparatus according to claim 9, wherein the first shaft is configured to rotate in a clockwise direction and the second shaft is configured to rotate in a counter clockwise direction when the mechanical energy source is coupled to the first portions of the first and second shafts, and wherein the first and second cams on the first and second shafts form a pair of opposed counter-rotating elastic elements.

11. The energy conversion apparatus according to claim 10, further comprising:
a first hanger plate defining an aperture to receive therein the first cam of the first shaft, the first hanger plate having a first end operatively coupled to the first cam of the first shaft and a second end connected to a first end of the transducer; and
a second hanger plate defining an aperture to receive therein the first cam of the second shaft, the second hanger plate having a first end operatively coupled to the first cam of the second shaft and a second end connected to a second end of the transducer;
wherein the first and second hanger plates coupled to the transducer and operatively coupled to the first cams located on the respective first and second shafts define a first generator element.

12. The energy conversion apparatus according to claim 11, further comprising:
a third hanger plate defining an aperture to receive therein the second cam of the first shaft, the third hanger plate having a first end operatively coupled to the second cam of the first shaft and a second end connected to a first end of a second transducer; and
a fourth hanger plate defining an aperture to receive therein the second cam of the second shaft, the fourth hanger plate having a first end operatively coupled to the second cam of the second shaft and a second end connected to a second end of the second transducer;
wherein the third and fourth hanger plates coupled to the second transducer and operatively coupled to the second cams located on the respective first and second shafts define a second generator element; and
wherein the first and second generator elements define a first pair of balanced counter-rotating elastic elements.

13. The energy conversion apparatus according to claim 12, further comprising at least a third and a fourth generator element, wherein the at least third and fourth generator elements define at least a second pair of balanced counter-rotating elastic elements.

14. The energy conversion apparatus according to any one of claims 1 to 13, wherein the conditioning circuit comprises:
a controller;
a charge controller;
an energy storage element; and
wherein the charge controller removes electrical energy from the energy storage element and transfers it to the dielectric elastomer film when the mechanical cycle has reached maximum strain of a cycle.

15. The energy conversion apparatus according to claim 14, wherein the conditioning circuit further comprises:
a discharge controller;
wherein the discharge controller removes electrical energy from the dielectric elastomer film when the mechanical cycle has reached a minimum strain of a cycle.

16. The energy conversion apparatus according to one of claims 14 and 15, further comprising at least one of a voltage monitor or a strain monitor to determine at least one of the voltage or the strain condition on the dielectric elastomer film and provide at least one of the voltage or the strain measurement to the controller.

17. An electroactive polymer energy conversion device, comprising at least:
a first pair of opposed counter-rotating generator elements;
a second pair of opposed counter-rotating generator elements; and
a third pair of opposed counter-rotating generator elements;
wherein the at least three pairs of opposed counter-rotating generator elements define a balanced counter-rotating electroactive polymer energy conversion device.

18. A method of generating electrical energy from a mechanical energy source, the method comprising:
straining a dielectric elastomer film to a predetermined maximum strain of a cycle using the mechanical energy source;
monitoring, by a strain controller, when the dielectric elastomer film reaches the predetermined maximum strain of the cycle;
transferring, by a charge controller, an electrical charge to the dielectric elastomer film when the mechanical cycle has reached maximum strain of a cycle;
relaxing the dielectric elastomer film to a predetermined minimum strain of the cycle; and
removing by the discharge controller the electrical charge on the dielectric elastomer when the mechanical cycle reaches a minimum strain of the cycle.

19. The method according to claim 18, further comprising:
removing, by the charge controller, electrical charge from an energy storage element; and
transferring the electrical charge removed from the energy storage element to the dielectric elastomer film when the mechanical cycle has reached a maximum strain of the cycle.

20. The method according to one of claims 18 and 19 further comprising:
determining at least one of a voltage or a strain condition of the dielectric elastomer film by at least one of a voltage monitor or a strain monitor; and
providing at least one of the voltage or the strain measurement to the controller.
